(19) United States
(12) Patent Application Publication
(10) Pub. No.: US 2025/0274810 A1
(43) Pub. Date: Aug. 28, 2025

(54) Configuration of User Plane Congestion Notification

(71) Applicant: Ofinno, LLC, Reston, VA (US)

(72) Inventors: Peyman Talebi Fard, Vienna, VA (US); Kyungmin Park, Vienna, VA (US); Esmael Hejazi Dinan, McLean, VA (US); SungDuck Chun, Fairfax, VA (US); Jian Xu, McLean, VA (US); Weihua Qiao, Herndon, VA (US); Stanislav Filin, Chantilly, VA (US)

(73) Assignee: Ofinno, LLC, Reston, VA (US)

(21) Appl. No.: 19/090,582

(22) Filed: Mar. 26, 2025

Related U.S. Application Data
(63) Continuation of application No. PCT/US2023/033847, filed on Sep. 27, 2023.
(60) Provisional application No. 63/410,525, filed on Sep. 27, 2022.

(51) Int. Cl. H04W 28/02; H04W 48/16; H04W 84/04

(52) U.S. Cl. CPC H04W 28/0284; H04W 48/16; H04W 84/042

(57) ABSTRACT

A first network node receives, from a second network node, a first message comprising a configuration parameter for reporting of user plane congestion associated with a network slice to a target node, wherein the configuration parameter comprises an identifier of the network slice. The first network node sends, to a user plane function (UPF), a second message comprising the configuration parameter.

### CROSS-REFERENCE TO RELATED APPLICATIONS

This application is a continuation of International Application No. PCT/US2023/033847, filed Sep. 27, 2023, which claims the benefit of U.S. Provisional Application No. 63/410,525, filed Sep. 27, 2022, all of which are hereby incorporated by reference in their entireties.

### BRIEF DESCRIPTION OF THE DRAWINGS

Examples of several of the various embodiments of the present disclosure are described herein with reference to the drawings.

FIG. 1A and FIG. 1B illustrate example communication networks including an access network and a core network.

FIG. 2A, FIG. 2B, FIG. 2C, and FIG. 2D illustrate various examples of a framework for a service-based architecture within a core network.

FIG. 3 illustrates an example communication network including core network functions.

FIG. 4A and FIG. 4B illustrate example of core network architecture with multiple user plane functions and untrusted access.

FIG. 5 illustrates an example of a core network architecture for a roaming scenario.

FIG. 6 illustrates an example of network slicing.

FIG. 7A, FIG. 7B, and FIG. 7C illustrate a user plane protocol stack, a control plane protocol stack, and services provided between protocol layers of the user plane protocol stack.

FIG. 8 illustrates an example of a quality of service model for data exchange.

FIG. 9A, FIG. 9B, FIG. 9C, and FIG. 9D illustrate example states and state transitions of a wireless device.

FIG. 10 illustrates an example of a registration procedure for a wireless device.

FIG. 11 illustrates an example of a service request procedure for a wireless device.

FIG. 12 illustrates an example of a protocol data unit session establishment procedure for a wireless device.

FIG. 13 illustrates examples of components of the elements in a communications network.

FIG. 14A, FIG. 14B, FIG. 14C, and FIG. 14D illustrate various examples of physical core network deployments, each having one or more network functions or portions thereof.

FIG. 15A illustrates an example embodiment of a present disclosure.

FIG. 15B illustrates an example embodiment of a present disclosure.

FIG. 15C illustrates an example embodiment of a present disclosure.

FIG. 16 illustrates an example embodiment of a present disclosure.

FIG. 17 illustrates an example embodiment of a present disclosure.

FIG. 18 illustrates an example embodiment of a present disclosure.

FIG. 19 illustrates an example embodiment of a present disclosure.

FIG. 20 illustrates an example embodiment of a present disclosure.

FIG. 21 illustrates an example embodiment of a present disclosure.

FIG. 22 illustrates an example embodiment of a present disclosure.

FIG. 23 illustrates an example embodiment of a present disclosure.

FIG. 24 illustrates an example embodiment of a present disclosure.

FIG. 25 illustrates an example embodiment of a present disclosure.

FIG. 26 illustrates an example embodiment of a present disclosure.

FIG. 27 illustrates an example embodiment of a present disclosure.

FIG. 28 illustrates an example embodiment of a present disclosure.

FIG. 29 illustrates an example embodiment of a present disclosure.

FIG. 30 illustrates an example embodiment of a present disclosure.

FIG. 31 illustrates an example embodiment of a present disclosure.

FIG. 32 illustrates an example embodiment of a present disclosure.

FIG. 33 illustrates an example embodiment of a present disclosure.

FIG. 34 illustrates an example embodiment of a present disclosure.

FIG. 35 illustrates an example embodiment of a present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have one or more specific capabilities. When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases refer to a single instance of a particular element, but should not be interpreted to exclude other instances of that element. For example, a bicycle with two wheels may be described as having “a wheel”. Any term that ends with the suffix “(s)” is to be interpreted as “at least one” and/or “one or m ore.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described.

The phrases “based on”, “in response to”, “depending on”, “employing”, “using”, and similar phrases indicate the presence and/or influence of a particular factor and/or condition on an event and/or action, but do not exclude unenumerated factors and/or conditions from also being present and/or influencing the event and/or action. For example, if action X is performed “based on” condition Y, this is to be interpreted as the action being performed “based at least on” condition Y. For example, if the performance of action X is performed when conditions Y and Z are both satisfied, then the performing of action X may be described as being “based on Y”.

The term “configured” may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, a parameter may comprise one or more information objects, and an information object may comprise one or more other objects. For example, if parameter J comprises parameter K, and parameter K comprises parameter L, and parameter L comprises parameter M, then J comprises L, and J comprises M. A parameter may be referred to as a field or information element. In an example embodiment, when one or more messages comprise a plurality of parameters, it implies that a parameter in the plurality of parameters is in at least one of the one or more messages, but does not have to be in each of the one or more messages.

This disclosure may refer to possible combinations of enumerated elements. For the sake of brevity and legibility, the present disclosure does not explicitly recite each and every permutation that may be obtained by choosing from a set of optional features. The present disclosure is to be interpreted as explicitly disclosing all such permutations. For example, the seven possible combinations of enumerated elements A, B, C consist of: (1) “A”; (2) “B”; (3) “C”; (4) “A and B”; (5) “A and C”; (6) “B and C”; and (7) “A, B, and C”. For the sake of brevity and legibility, these seven possible combinations may be described using any of the following interchangeable formulations: “at least one of A, B, and C”; “at least one of A, B, or C”; “one or more of A, B, and C”; “one or more of A, B, or C”; “A, B, and/or C”. It will be understood that impossible combinations are excluded. For example, “X and/or not-X” should be interpreted as “X or not-X”. It will be further understood that these formulations may describe alternative phrasings of overlapping and/or synonymous concepts, for example, “identifier, identification, and/or ID number”.

This disclosure may refer to sets and/or subsets. As an example, set X may be a set of elements comprising one or more elements. If every element of X is also an element of Y, then X may be referred to as a subset of Y. In this disclosure, only non-empty sets and subsets are considered. For example, if Y consists of the elements Y1, Y2, and Y3, then the possible subsets of Y are {Y1, Y2, Y3}, {Y1, Y2}, {Y1, Y3}, {Y2, Y3}, {Y1}, {Y2}, and {Y3}.

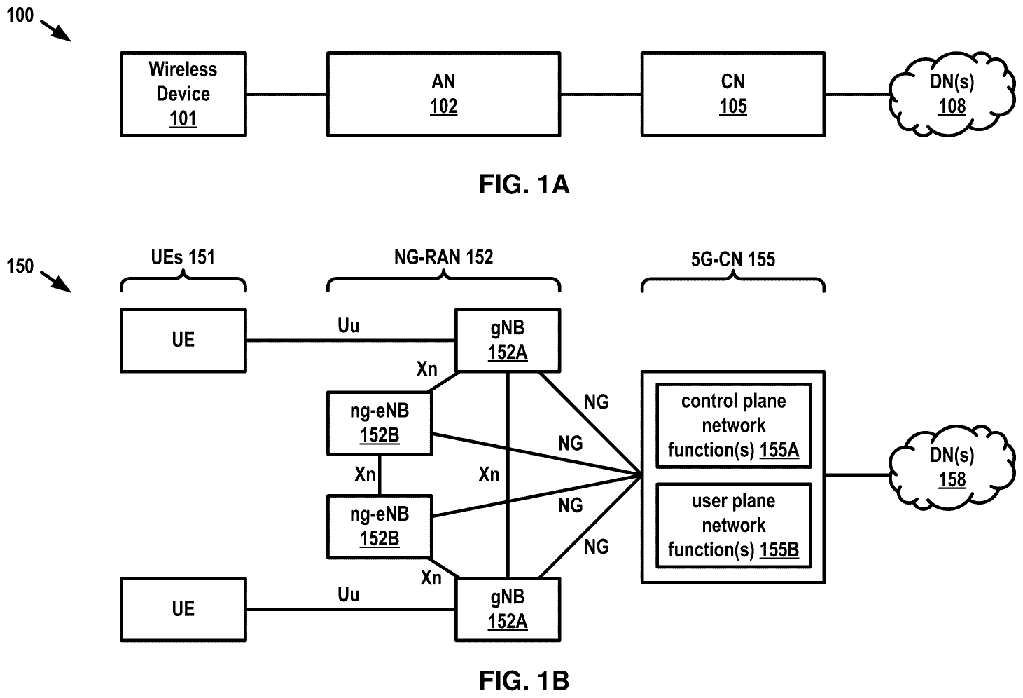

FIG. 1A illustrates an example of a communication network 100 in which embodiments of the present disclosure may be implemented. The communication network 100 may comprise, for example, a public land mobile network (PLMN) run by a network operator. As illustrated in FIG. 1A, the communication network 100 includes a wireless device 101, an access network (AN) 102, a core network (CN) 105, and one or more data network (DNs) 108.

The wireless device 101 may communicate with DNs 108 via AN 102 and CN 105. In the present disclosure, the term wireless device may refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle road side unit (RSU), relay node, automobile, unmanned aerial vehicle, urban air mobility, and/or any combination thereof. The term wireless device encompasses other terminology, including user equipment (UE), user terminal (UT), access terminal (AT), mobile station, handset, wireless transmit and receive unit (WTRU), and/or wireless communication device.

The AN 102 may connect wireless device 101 to CN 105 in any suitable manner. The communication direction from the AN 102 to the wireless device 101 is known as the downlink and the communication direction from the wireless device 101 to AN 102 is known as the uplink. Downlink transmissions may be separated from uplink transmissions using frequency division duplexing (FDD), time-division duplexing (TDD), and/or some combination of the two duplexing techniques. The AN 102 may connect to wireless device 101 through radio communications over an air interface. An access network that at least partially operates over the air interface may be referred to as a radio access network (RAN). The CN 105 may set up one or more end-to-end connection between wireless device 101 and the one or more DNs 108. The CN 105 may authenticate wireless device 101 and provide charging functionality.

In the present disclosure, the term base station may refer to and encompass any element of AN 102 that facilitates communication between wireless device 101 and AN 102. Access networks and base stations have many different names and implementations. The base station may be a terrestrial base station fixed to the earth. The base station may be a mobile base station with a moving coverage area. The base station may be in space, for example, on board a satellite. For example, WiFi and other standards may use the term access point. As another example, the Third-Generation Partnership Project (3GPP) has produced specifications for three generations of mobile networks, each of which uses different terminology. Third Generation (3G) and/or Universal Mobile Telecommunications System (UMTS) standards may use the term Node B. 4G, Long Term Evolution (LTE), and/or Evolved Universal Terrestrial Radio Access (E-UTRA) standards may use the term Evolved Node B (eNB). 5G and/or New Radio (NR) standards may describe AN 102 as a next-generation radio access network (NG-RAN) and may refer to base stations as Next Generation eNB (ng-eNB) and/or Generation Node B (gNB). Future standards (for example, 6G, 7G, 8G) may use new terminology to refer to the elements which implement the methods described in the present disclosure (e.g., wireless devices, base stations, ANs, CNs, and/or components thereof). A base station may be implemented as a repeater or relay node used to extend the coverage area of a donor node. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The AN 102 may include one or more base stations, each having one or more coverage areas. The geographical size and/or extent of a coverage area may be defined in terms of a range at which a receiver of AN 102 can successfully receive transmissions from a transmitter (e.g., wireless device 101) operating within the coverage area (and/or vice-versa). The coverage areas may be referred to as sectors or cells (although in some contexts, the term cell refers to the carrier frequency used in a particular coverage area, rather than the coverage area itself). Base stations with large coverage areas may be referred to as macrocell base stations. Other base stations cover smaller areas, for example, to provide coverage in areas with weak macrocell coverage, or to provide additional coverage in areas with high traffic (sometimes referred to as hotspots). Examples of small cell base stations include, in order of decreasing coverage area, microcell base stations, picocell base stations, and femtocell base stations or home base stations. Together, the coverage areas of the base stations may provide radio coverage to wireless device 101 over a wide geographic area to support wireless device mobility.

A base station may include one or more sets of antennas for communicating with the wireless device 101 over the air interface. Each set of antennas may be separately controlled by the base station. Each set of antennas may have a corresponding coverage area. As an example, a base station may include three sets of antennas to respectively control three coverage areas on three different sides of the base station. The entirety of the base station (and its corresponding antennas) may be deployed at a single location. Alternatively, a controller at a central location may control one or more sets of antennas at one or more distributed locations. The controller may be, for example, a baseband processing unit that is part of a centralized or cloud RAN architecture. The baseband processing unit may be either centralized in a pool of baseband processing units or virtualized. A set of antennas at a distributed location may be referred to as a remote radio head (RRH).

FIG. 1B illustrates another example communication network 150 in which embodiments of the present disclosure may be implemented. The communication network 150 may comprise, for example, a PLMN run by a network operator. As illustrated in FIG. 1B, communication network 150 includes UEs 151, a next generation radio access network (NG-RAN) 152, a 5G core network (5G-CN) 155, and one or more DNs 158. The NG-RAN 152 includes one or more base stations, illustrated as generation node Bs (gNBs) 152A and next generation evolved Node Bs (ng eNBs) 152B. The 5G-CN 155 includes one or more network functions (NFs), including control plane functions 155A and user plane functions 155B. The one or more DNs 158 may comprise public DNs (e.g., the Internet), private DNs, and/or intra-operator DNs. Relative to corresponding components illustrated in FIG. 1A, these components may represent specific implementations and/or terminology.

The base stations of the NG-RAN 152 may be connected to the UEs 151 via Uu interfaces. The base stations of the NG-RAN 152 may be connected to each other via Xn interfaces. The base stations of the NG-RAN 152 may be connected to 5G CN 155 via NG interfaces. The Uu interface may include an air interface. The NG and Xn interfaces may include an air interface, or may consist of direct physical connections and/or indirect connections over an underlying transport network (e.g., an internet protocol (IP) transport network).

Each of the Uu, Xn, and NG interfaces may be associated with a protocol stack. The protocol stacks may include a user plane (UP) and a control plane (CP). Generally, user plane data may include data pertaining to users of the UEs 151, for example, internet content downloaded via a web browser application, sensor data uploaded via a tracking application, or email data communicated to or from an email server. Control plane data, by contrast, may comprise signalling and messages that facilitate packaging and routing of user plane data so that it can be exchanged with the DN(s). The NG interface, for example, may be divided into an NG user plane interface (NG-U) and an NG control plane interface (NG-C). The NG-U interface may provide delivery of user plane data between the base stations and the one or more user plane network functions 155B. The NG-C interface may be used for control signalling between the base stations and the one or more control plane network functions 155A. The NG-C interface may provide, for example, NG interface management, UE context management, UE mobility management, transport of NAS messages, paging, PDU session management, and configuration transfer and/or warning message transmission. In some cases, the NG-C interface may support transmission of user data (for example, a small data transmission for an IoT device).

One or more of the base stations of the NG-RAN 152 may be split into a central unit (CU) and one or more distributed units (DUs). A CU may be coupled to one or more DUs via an F1 interface. The CU may handle one or more upper layers in the protocol stack and the DU may handle one or more lower layers in the protocol stack. For example, the CU may handle RRC, PDCP, and SDAP, and the DU may handle RLC, MAC, and PHY. The one or more DUs may be in geographically diverse locations relative to the CU and/or each other. Accordingly, the CU/DU split architecture may permit increased coverage and/or better coordination.

The gNBs 152A and ng-eNBs 152B may provide different user plane and control plane protocol termination towards the UEs 151. For example, the gNB 154A may provide new radio (NR) protocol terminations over a Uu interface associated with a first protocol stack. The ng-eNBs 152B may provide Evolved UMTS Terrestrial Radio Access (E-UTRA) protocol terminations over a Uu interface associated with a second protocol stack.

The 5G-CN 155 may authenticate UEs 151, set up end-to-end connections between UEs 151 and the one or more DNs 158, and provide charging functionality. The 5G-CN 155 may be based on a service-based architecture, in which the NFs making up the 5G-CN 155 offer services to each other and to other elements of the communication network 150 via interfaces. The 5G-CN 155 may include any number of other NFs and any number of instances of each NF.

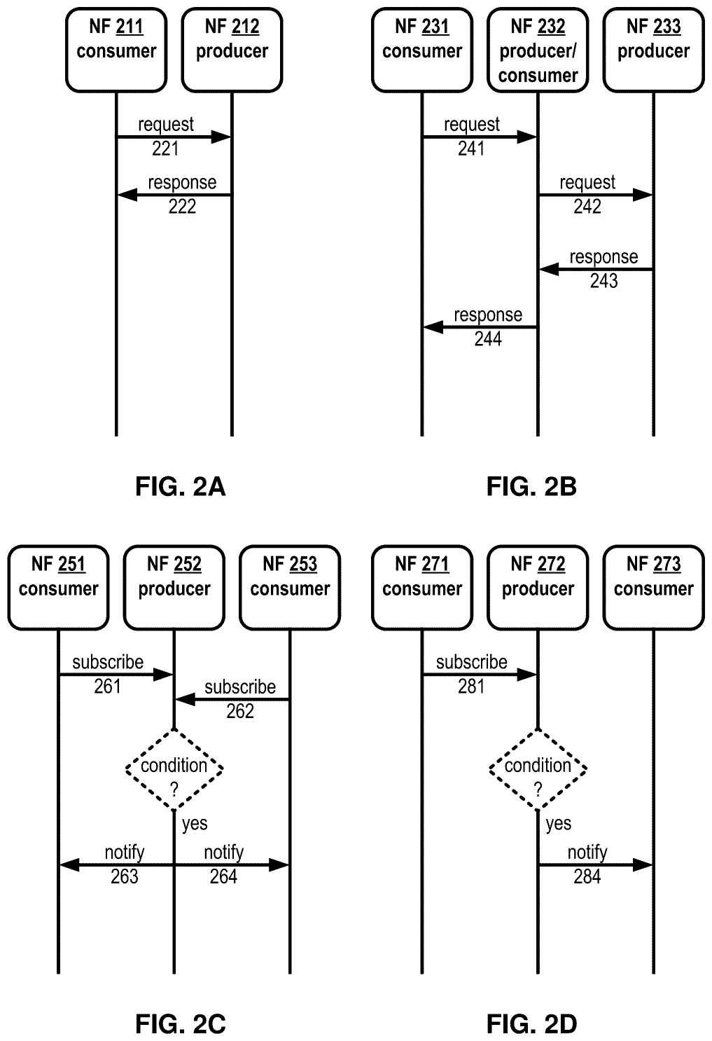

FIG. 2A, FIG. 2B, FIG. 2C, and FIG. 2D illustrate various examples of a framework for a service-based architecture within a core network. In a service-based architecture, a service may be sought by a service consumer and provided by a service producer. Prior to obtaining a particular service, an NF may determine where such as service can be obtained. To discover a service, the NF may communicate with a network repository function (NRF). As an example, an NF that provides one or more services may register with a network repository function (NRF). The NRF may store data relating to the one or more services that the NF is prepared to provide to other NFs in the service-based architecture. A consumer NF may query the NRF to discover a producer NF (for example, by obtaining from the NRF a list of NF instances that provide a particular service).

In the example of FIG. 2A, an NF 211 (a consumer NF in this example) may send a request 221 to an NF 212 (a producer NF). The request 221 may be a request for a particular service and may be sent based on a discovery that NF 212 is a producer of that service. The request 221 may comprise data relating to NF 211 and/or the requested service. The NF 212 may receive request 221, perform one or more actions associated with the requested service (e.g., retrieving data), and provide a response 221. The one or more actions performed by the NF 212 may be based on request data included in the request 221, data stored by NF 212, and/or data retrieved by NF 212. The response 222 may notify NF 211 that the one or more actions have been completed. The response 222 may comprise response data relating to NF 212, the one or more actions, and/or the requested service.

In the example of FIG. 2B, an NF 231 sends a request 241 to an NF 232. In this example, part of the service produced by NF 232 is to send a request 242 to an NF 233. The NF 233 may perform one or more actions and provide a response 243 to NF 232. Based on response 243, NF 232 may send a response 244 to NF 231. It will be understood from FIG. 2B that a single NF may perform the role of producer of services, consumer of services, or both. A particular NF service may include any number of nested NF services produced by one or more other NFs.

FIG. 2C illustrates examples of subscribe-notify interactions between a consumer NF and a producer NF. In FIG. 2C, an NF 251 sends a subscription 261 to an NF 252. An NF 253 sends a subscription 262 to the NF 252. Two NFs are shown in FIG. 2C for illustrative purposes (to demonstrate that the NF 252 may provide multiple subscription services to different NFs), but it will be understood that a subscribe-notify interaction only requires one subscriber. The NFs 251, 253 may be independent from one another. For example, the NFs 251, 253 may independently discover NF 252 and/or independently determine to subscribe to the service offered by NF 252. In response to receipt of a subscription, the NF 252 may provide a notification to the subscribing NF. For example, NF 252 may send a notification 263 to NF 251 based on subscription 261 and may send a notification 264 to NF 253 based on subscription 262.

As shown in the example illustration of FIG. 2C, the sending of the notifications 263, 264 may be based on a determination that a condition has occurred. For example, the notifications 263, 264 may be based on a determination that a particular event has occurred, a determination that a particular condition is outstanding, and/or a determination that a duration of time associated with the subscription has elapsed (for example, a period associated with a subscription for periodic notifications). As shown in the example illustration of FIG. 2C, NF 252 may send notifications 263, 264 to NFs 251, 253 simultaneously and/or in response to the same condition. However, it will be understood that the NF 252 may provide notifications at different times and/or in response to different notification conditions. In an example, the NF 251 may request a notification when a certain parameter, as measured by the NF 252, exceeds a first threshold, and the NF 252 may request a notification when the parameter exceeds a second threshold different from the first threshold. In an example, a parameter of interest and/or a corresponding threshold may be indicated in the subscriptions 261, 262.

FIG. 2D illustrates another example of a subscribe-notify interaction. In FIG. 2D, an NF 271 sends a subscription 281 to an NF 272. In response to receipt of subscription 281 and/or a determination that a notification condition has occurred, NF 272 may send a notification 284. The notification 284 may be sent to an NF 273. Unlike the example in FIG. 2C (in which a notification is sent to the subscribing NF), FIG. 2D demonstrates that a subscription and its corresponding notification may be associated with different NFs. For example, NF 271 may subscribe to the service provided by NF 272 on behalf of NF 273.

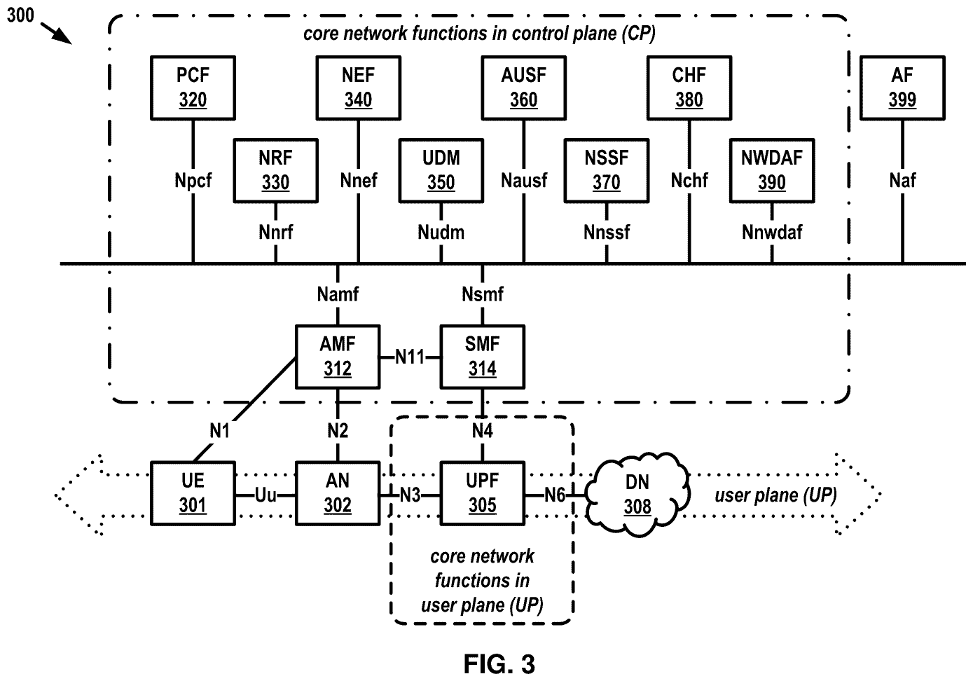

FIG. 3 illustrates another example communication network 300 in which embodiments of the present disclosure may be implemented. Communication network 300 includes a user equipment (UE) 301, an access network (AN) 302, and a data network (DN) 308. The remaining elements depicted in FIG. 3 may be included in and/or associated with a core network. Each element of the core network may be referred to as a network function (NF).

The NFs depicted in FIG. 3 include a user plane function (UPF) 305, an access and mobility management function (AMF) 312, a session management function (SMF) 314, a policy control function (PCF) 320, a network repository function (NRF) 330, a network exposure function (NEF) 340, a unified data management (UDM) 350, an authentication server function (AUSF) 360, a network slice selection function (NSSF) 370, a charging function (CHF) 380, a network data analytics function (NWDAF) 390, and an application function (AF) 399. The UPF 305 may be a user-plane core network function, whereas the NFs 312, 314, and 320-390 may be control-plane core network functions. Although not shown in the example of FIG. 3, the core network may include additional instances of any of the NFs depicted and/or one or more different NF types that provide different services. Other examples of NF type include a gateway mobile location center (GMLC), a location management function (LMF), an operations, administration, and maintenance function (OAM), a public warning system (PWS), a short message service function (SMSF), a unified data repository (UDR), and an unstructured data storage function (UDSF).

Each element depicted in FIG. 3 has an interface with at least one other element. The interface may be a logical connection rather than, for example, a direct physical connection. Any interface may be identified using a reference point representation and/or a service-based representation. In a reference point representation, the letter ‘N’ is followed by a numeral, indicating an interface between two specific elements. For example, as shown in FIG. 3, AN 302 and UPF 305 interface via N3′, whereas UPF 305 and DN 308 interface via N6′. By contrast, in a service-based representation, the letter ‘N’ is followed by letters. The letters identify an NF that provides services to the core network. For example, PCF 320 may provide services via interface ‘Npcf’. The PCF 320 may provide services to any NF in the core network via ‘Npcf’. Accordingly, a service-based representation may correspond to a bundle of reference point representations. For example, the Npcf interface between PCF 320 and the core network generally may correspond to an N7 interface between PCF 320 and SMF 314, an N30 interface between PCF 320 and NEF 340, etc.

The UPF 305 may serve as a gateway for user plane traffic between AN 302 and DN 308. The UE 301 may connect to UPF 305 via a Uu interface and an N3 interface (also described as NG-U interface). The UPF 305 may connect to DN 308 via an N6 interface. The UPF 305 may connect to one or more other UPFs (not shown) via an N9 interface. The UE 301 may be configured to receive services through a protocol data unit (PDU) session, which is a logical connection between UE 301 and DN 308. The UPF 305 (or a plurality of UPFs if desired) may be selected by SMF 314 to handle a particular PDU session between UE 301 and DN 308. The SMF 314 may control the functions of UPF 305 with respect to the PDU session. The SMF 314 may connect to UPF 305 via an N4 interface. The UPF 305 may handle any number of PDU sessions associated with any number of UEs (via any number of ANs). For purposes of handling the one or more PDU sessions, UPF 305 may be controlled by any number of SMFs via any number of corresponding N4 interfaces.

The AMF 312 depicted in FIG. 3 may control UE access to the core network. The UE 301 may register with the network via AMF 312. It may be necessary for UE 301 to register prior to establishing a PDU session. The AMF 312 may manage a registration area of UE 301, enabling the network to track the physical location of UE 301 within the network. For a UE in connected mode, AMF 312 may manage UE mobility, for example, handovers from one AN or portion thereof to another. For a UE in idle mode, AMF 312 may perform registration updates and/or page the UE to transition the UE to connected mode.

The AMF 312 may receive, from UE 301, non-access stratum (NAS) messages transmitted in accordance with NAS protocol. NAS messages relate to communications between UE 301 and the core network. Although NAS messages may be relayed to AMF 312 via AN 302, they may be described as communications via the N1 interface. NAS messages may facilitate UE registration and mobility management, for example, by authenticating, identifying, configuring, and/or managing a connection of UE 301. NAS messages may support session management procedures for maintaining user plane connectivity and quality of service (QoS) of a session between UE 301 and DN 309. If the NAS message involves session management, AMF 312 may send the NAS message to SMF 314. NAS messages may be used to transport messages between UE 301 and other components of the core network (e.g., core network components other than AMF 312 and SMF 314). The AMF 312 may act on a particular NAS message itself, or alternatively, forward the NAS message to an appropriate core network function (e.g., SMF 314, etc.)

The SMF 314 depicted in FIG. 3 may establish, modify, and/or release a PDU session based on messaging received UE 301. The SMF 314 may allocate, manage, and/or assign an IP address to UE 301, for example, upon establishment of a PDU session. There may be multiple SMFs in the network, each of which may be associated with a respective group of wireless devices, base stations, and/or UPFs. A UE with multiple PDU sessions may be associated with a different SMF for each PDU session. As noted above, SMF 314 may select one or more UPFs to handle a PDU session and may control the handling of the PDU session by the selected UPF by providing rules for packet handling (PDR, FAR, QER, etc.). Rules relating to QoS and/or charging for a particular PDU session may be obtained from PCF 320 and provided to UPF 305.

The PCF 320 may provide, to other NFs, services relating to policy rules. The PCF 320 may use subscription data and information about network conditions to determine policy rules and then provide the policy rules to a particular NF which may be responsible for enforcement of those rules. Policy rules may relate to policy control for access and mobility, and may be enforced by the AMF. Policy rules may relate to session management, and may be enforced by the SMF 314. Policy rules may be, for example, network-specific, wireless device-specific, session-specific, or data flow-specific.

The NRF 330 may provide service discovery. The NRF 330 may belong to a particular PLMN. The NRF 330 may maintain NF profiles relating to other NFs in the communication network 300. The NF profile may include, for example, an address, PLMN, and/or type of the NF, a slice identifier, a list of the one or more services provided by the NF, and the authorization required to access the services.

The NEF 340 depicted in FIG. 3 may provide an interface to external domains, permitting external domains to selectively access the control plane of the communication network 300. The external domain may comprise, for example, third-party network functions, application functions, etc. The NEF 340 may act as a proxy between external elements and network functions such as AMF 312, SMF 314, PCF 320, UDM 350, etc. As an example, NEF 340 may determine a location or reachability status of UE 301 based on reports from AMF 312, and provide status information to an external element. As an example, an external element may provide, via NEF 340, information that facilitates the setting of parameters for establishment of a PDU session. The NEF 340 may determine which data and capabilities of the control plane are exposed to the external domain. The NEF 340 may provide secure exposure that authenticates and/or authorizes an external entity to which data or capabilities of the communication network 300 are exposed. The NEF 340 may selectively control the exposure such that the internal architecture of the core network is hidden from the external domain.

The UDM 350 may provide data storage for other NFs. The UDM 350 may permit a consolidated view of network information that may be used to ensure that the most relevant information can be made available to different NFs from a single resource. The UDM 350 may store and/or retrieve information from a unified data repository (UDR). For example, UDM 350 may obtain user subscription data relating to UE 301 from the UDR.

The AUSF 360 may support mutual authentication of UE 301 by the core network and authentication of the core network by UE 301. The AUSF 360 may perform key agreement procedures and provide keying material that can be used to improve security.

The NSSF 370 may select one or more network slices to be used by the UE 301. The NSSF 370 may select a slice based on slice selection information. For example, the NSSF 370 may receive Single Network Slice Selection Assistance Information (S-NSSAI) and map the S-NSSAI to a network slice instance identifier (NSI).

The CHF 380 may control billing-related tasks associated with UE 301. For example, UPF 305 may report traffic usage associated with UE 301 to SMF 314. The SMF 314 may collect usage data from UPF 305 and one or more other UPFs. The usage data may indicate how much data is exchanged, what DN the data is exchanged with, a network slice associated with the data, or any other information that may influence billing. The SMF 314 may share the collected usage data with the CHF. The CHF may use the collected usage data to perform billing-related tasks associated with UE 301. The CHF may, depending on the billing status of UE 301, instruct SMF 314 to limit or influence access of UE 301 and/or to provide billing-related notifications to UE 301.

The NWDAF 390 may collect and analyze data from other network functions and offer data analysis services to other network functions. As an example, NWDAF 390 may collect data relating to a load level for a particular network slice instance from UPF 305, AMF 312, and/or SMF 314. Based on the collected data, NWDAF 390 may provide load level data to the PCF 320 and/or NSSF 370, and/or notify the PC220 and/or NSSF 370 if load level for a slice reaches and/or exceeds a load level threshold.

The AF 399 may be outside the core network, but may interact with the core network to provide information relating to the QoS requirements or traffic routing preferences associated with a particular application. The AF 399 may access the core network based on the exposure constraints imposed by the NEF 340. However, an operator of the core network may consider the AF 399 to be a trusted domain that can access the network directly.

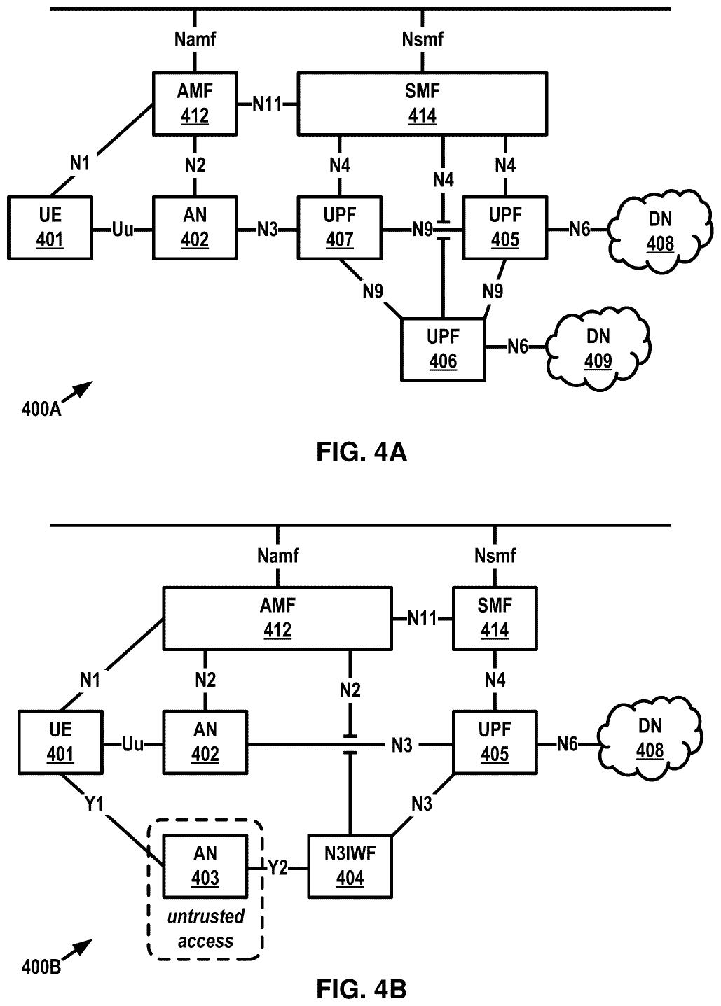

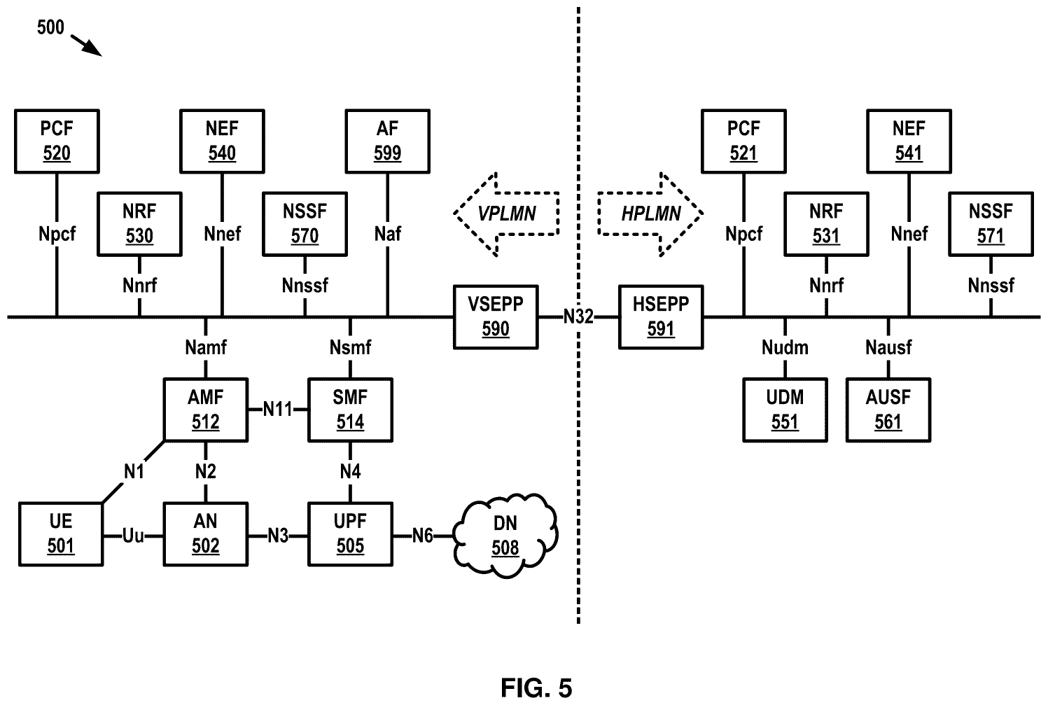

FIGS. 4A, 4B, and 5 illustrate other examples of core network architectures that are analogous in some respects to the core network architecture 300 depicted in FIG. 3. For conciseness, some of the core network elements depicted in FIG. 3 are omitted. Many of the elements depicted in FIGS. 4A, 4B, and 5 are analogous in some respects to elements depicted in FIG. 3. For conciseness, some of the details relating to their functions or operation are omitted.

FIG. 4A illustrates an example of a core network architecture 400A comprising an arrangement of multiple UPFs. Core network architecture 400A includes a UE 401, an AN 402, an AMF 412, and an SMF 414. Unlike previous examples of core network architectures described above, FIG. 4A depicts multiple UPFs, including a UPF 405, a UPF 406, and a UPF 407, and multiple DNs, including a DN 408 and a DN 409. Each of the multiple UPFs 405, 406, 407 may communicate with the SMF 414 via an N4 interface. The DNs 408, 409 communicate with the UPFs 405, 406, respectively, via N6 interfaces. As shown in FIG. 4A, the multiple UPFs 405, 406, 407 may communicate with one another via N9 interfaces.

The UPFs 405, 406, 407 may perform traffic detection, in which the UPFs identify and/or classify packets. Packet identification may be performed based on packet detection rules (PDR) provided by the SMF 414. A PDR may include packet detection information comprising one or more of: a source interface, a UE IP address, core network (CN) tunnel information (e.g., a CN address of an N3/N9 tunnel corresponding to a PDU session), a network instance identifier, a quality of service flow identifier (QFI), a filter set (for example, an IP packet filter set or an ethernet packet filter set), and/or an application identifier.

In addition to indicating how a particular packet is to be detected, a PDR may further indicate rules for handling the packet upon detection thereof. The rules may include, for example, forwarding action rules (FARs), multi-access rules (MARs), usage reporting rules (URRs), QoS enforcement rules (QERs), etc. For example, the PDR may comprise one or more FAR identifiers, MAR identifiers, URR identifiers, and/or QER identifiers. These identifiers may indicate the rules that are prescribed for the handling of a particular detected packet.

The UPF 405 may perform traffic forwarding in accordance with a FAR. For example, the FAR may indicate that a packet associated with a particular PDR is to be forwarded, duplicated, dropped, and/or buffered. The FAR may indicate a destination interface, for example, “access” for downlink or “core” for uplink. If a packet is to be buffered, the FAR may indicate a buffering action rule (BAR). As an example, UPF 405 may perform data buffering of a certain number downlink packets if a PDU session is deactivated.

The UPF 405 may perform QoS enforcement in accordance with a QER. For example, the QER may indicate a guaranteed bitrate that is authorized and/or a maximum bitrate to be enforced for a packet associated with a particular PDR. The QER may indicate that a particular guaranteed and/or maximum bitrate may be for uplink packets and/or downlink packets. The UPF 405 may mark packets belonging to a particular QoS flow with a corresponding QFI. The marking may enable a recipient of the packet to determine a QoS of the packet.

The UPF 405 may provide usage reports to the SMF 414 in accordance with a URR. The URR may indicate one or more triggering conditions for generation and reporting of the usage report, for example, immediate reporting, periodic reporting, a threshold for incoming uplink traffic, or any other suitable triggering condition. The URR may indicate a method for measuring usage of network resources, for example, data volume, duration, and/or event.

As noted above, the DNs 408, 409 may comprise public DNs (e.g., the Internet), private DNs (e.g., private, internal corporate-owned DNs), and/or intra-operator DNs. Each DN may provide an operator service and/or a third-party service. The service provided by a DN may be the Internet, an IP multimedia subsystem (IMS), an augmented or virtual reality network, an edge computing or mobile edge computing (MEC) network, etc. Each DN may be identified using a data network name (DNN). The UE 401 may be configured to establish a first logical connection with DN 408 (a first PDU session), a second logical connection with DN 409 (a second PDU session), or both simultaneously (first and second PDU sessions).

Each PDU session may be associated with at least one UPF configured to operate as a PDU session anchor (PSA, or “anchor”). The anchor may be a UPF that provides an N6 interface with a DN.

In the example of FIG. 4A, UPF 405 may be the anchor for the first PDU session between UE 401 and DN 408, whereas the UPF 406 may be the anchor for the second PDU session between UE 401 and DN 409. The core network may use the anchor to provide service continuity of a particular PDU session (for example, IP address continuity) as UE 401 moves from one access network to another. For example, suppose that UE 401 establishes a PDU session using a data path to the DN 408 using an access network other than AN 402. The data path may include UPF 405 acting as anchor. Suppose further that the UE 401 later moves into the coverage area of the AN 402. In such a scenario, SMF 414 may select a new UPF (UPF 407) to bridge the gap between the newly-entered access network (AN 402) and the anchor UPF (UPF 405). The continuity of the PDU session may be preserved as any number of UPFs are added or removed from the data path. When a UPF is added to a data path, as shown in FIG. 4A, it may be described as an intermediate UPF and/or a cascaded UPF.

As noted above, UPF 406 may be the anchor for the second PDU session between UE 401 and DN 409. Although the anchor for the first and second PDU sessions are associated with different UPFs in FIG. 4A, it will be understood that this is merely an example. It will also be understood that multiple PDU sessions with a single DN may correspond to any number of anchors. When there are multiple UPFs, a UPF at the branching point (UPF 407 in FIG. 4) may operate as an uplink classifier (UL-CL). The UL-CL may divert uplink user plane traffic to different UPFs.

The SMF 414 may allocate, manage, and/or assign an IP address to UE 401, for example, upon establishment of a PDU session. The SMF 414 may maintain an internal pool of IP addresses to be assigned. The SMF 414 may, if necessary, assign an IP address provided by a dynamic host configuration protocol (DHCP) server or an authentication, authorization, and accounting (AAA) server. IP address management may be performed in accordance with a session and service continuity (SSC) mode. In SSC mode 1, an IP address of UE 401 may be maintained (and the same anchor UPF may be used) as the wireless device moves within the network. In SSC mode 2, the IP address of UE 401 changes as UE 401 moves within the network (e.g., the old IP address and UPF may be abandoned and a new IP address and anchor UPF may be established). In SSC mode 3, it may be possible to maintain an old IP address (similar to SSC mode 1) temporarily while establishing a new IP address (similar to SSC mode 2), thus combining features of SSC modes 1 and 2. Applications that are sensitive to IP address changes may operate in accordance with SSC mode 1.

UPF selection may be controlled by SMF 414. For example, upon establishment and/or modification of a PDU session between UE 401 and DN 408, SMF 414 may select UPF 405 as the anchor for the PDU session and/or UPF 407 as an intermediate UPF. Criteria for UPF selection include path efficiency and/or speed between AN 402 and DN 408. The reliability, load status, location, slice support and/or other capabilities of candidate UPFs may also be considered.

FIG. 4B illustrates an example of a core network architecture 400B that accommodates untrusted access. Similar to FIG. 4A, UE 401 as depicted in FIG. 4B connects to DN 408 via AN 402 and UPF 405. The AN 402 and UPF 405 constitute trusted (e.g., 3GPP) access to the DN 408. By contrast, UE 401 may also access DN 408 using an untrusted access network, AN 403, and a non-3GPP interworking function (N3IWF) 404.

The AN 403 may be, for example, a wireless land area network (WLAN) operating in accordance with the IEEE 802.11 standard. The UE 401 may connect to AN 403, via an interface Y1, in whatever manner is prescribed for AN 403. The connection to AN 403 may or may not involve authentication. The UE 401 may obtain an IP address from AN 403. The UE 401 may determine to connect to core network 400B and select untrusted access for that purpose. The AN 403 may communicate with N3IWF 404 via a Y2 interface. After selecting untrusted access, the UE 401 may provide N3IWF 404 with sufficient information to select an AMF. The selected AMF may be, for example, the same AMF that is used by UE 401 for 3GPP access (AMF 412 in the present example). The N3IWF 404 may communicate with AMF 412 via an N2 interface. The UPF 405 may be selected and N3IWF 404 may communicate with UPF 405 via an N3 interface. The UPF 405 may be a PDU session anchor (PSA) and may remain the anchor for the PDU session even as UE 401 shifts between trusted access and untrusted access.

FIG. 5 illustrates an example of a core network architecture 500 in which a UE 501 is in a roaming scenario. In a roaming scenario, UE 501 is a subscriber of a first PLMN (a home PLMN, or HPLMN) but attaches to a second PLMN (a visited PLMN, or VPLMN). Core network architecture 500 includes UE 501, an AN 502, a UPF 505, and a DN 508. The AN 502 and UPF 505 may be associated with a VPLMN. The VPLMN may manage the AN 502 and UPF 505 using core network elements associated with the VPLMN, including an AMF 512, an SMF 514, a PCF 520, an NRF 530, an NEF 540, and an NSSF 570. An AF 599 may be adjacent the core network of the VPLMN.

The UE 501 may not be a subscriber of the VPLMN. The AMF 512 may authorize UE 501 to access the network based on, for example, roaming restrictions that apply to UE 501. In order to obtain network services provided by the VPLMN, it may be necessary for the core network of the VPLMN to interact with core network elements of a HPLMN of UE 501, in particular, a PCF 521, an NRF 531, an NEF 541, a UDM 551, and/or an AUSF 561. The VPLMN and HPLMN may communicate using an N32 interface connecting respective security edge protection proxies (SEPPs). In FIG. 5, the respective SEPPs are depicted as a VSEPP 590 and an HSEPP 591.

The VSEPP 590 and the HSEPP 591 communicate via an N32 interface for defined purposes while concealing information about each PLMN from the other. The SEPPs may apply roaming policies based on communications via the N32 interface. The PCF 520 and PCF 521 may communicate via the SEPPs to exchange policy-related signalling. The NRF 530 and NRF 531 may communicate via the SEPPs to enable service discovery of NFs in the respective PLMNs. The VPLMN and HPLMN may independently maintain NEF 540 and NEF 541. The NSSF 570 and NSSF 571 may communicate via the SEPPs to coordinate slice selection for UE 501. The HPLMN may handle all authentication and subscription related signalling. For example, when the UE 501 registers or requests service via the VPLMN, the VPLMN may authenticate UE 501 and/or obtain subscription data of UE 501 by accessing, via the SEPPs, the UDM 551 and AUSF 561 of the HPLMN.

The core network architecture 500 depicted in FIG. 5 may be referred to as a local breakout configuration, in which UE 501 accesses DN 508 using one or more UPFs of the VPLMN (i.e., UPF 505). However, other configurations are possible. For example, in a home-routed configuration (not shown in FIG. 5), UE 501 may access a DN using one or more UPFs of the HPLMN. In the home-routed configuration, an N9 interface may run parallel to the N32 interface, crossing the frontier between the VPLMN and the HPLMN to carry user plane data. One or more SMFs of the respective PLMNs may communicate via the N32 interface to coordinate session management for UE 501. The SMFs may control their respective UPFs on either side of the frontier.

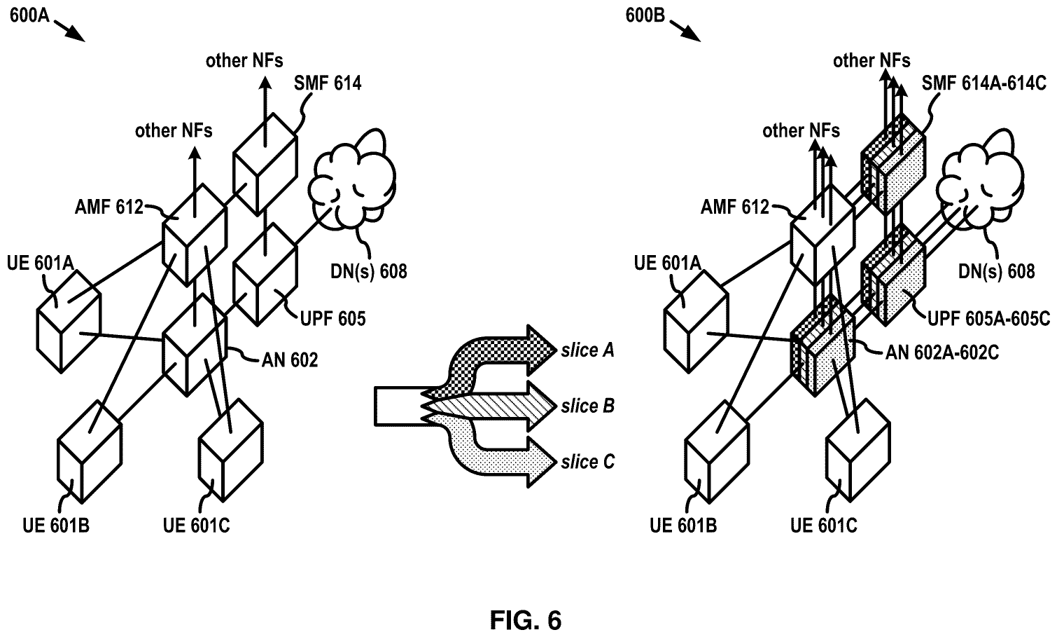

FIG. 6 illustrates an example of network slicing. Network slicing may refer to division of shared infrastructure (e.g., physical infrastructure) into distinct logical networks. These distinct logical networks may be independently controlled, isolated from one another, and/or associated with dedicated resources.

Network architecture 600A illustrates an un-sliced physical network corresponding to a single logical network. The network architecture 600A comprises a user plane wherein UEs 601A, 601B, 601C (collectively, UEs 601) have a physical and logical connection to a DN 608 via an AN 602 and a UPF 605. The network architecture 600A comprises a control plane wherein an AMF 612 and a SMF 614 control various aspects of the user plane.

The network architecture 600A may have a specific set of characteristics (e.g., relating to maximum bit rate, reliability, latency, bandwidth usage, power consumption, etc.). This set of characteristics may be affected by the nature of the network elements themselves (e.g., processing power, availability of free memory, proximity to other network elements, etc.) or the management thereof (e.g., optimized to maximize bit rate or reliability, reduce latency or power bandwidth usage, etc.). The characteristics of network architecture 600A may change over time, for example, by upgrading equipment or by modifying procedures to target a particular characteristic. However, at any given time, network architecture 600A will have a single set of characteristics that may or may not be optimized for a particular use case. For example, UEs 601A, 601B, 601C may have different requirements, but network architecture 600A can only be optimized for one of the three.

Network architecture 600B is an example of a sliced physical network divided into multiple logical networks. In FIG. 6, the physical network is divided into three logical networks, referred to as slice A, slice B, and slice C. For example, UE 601A may be served by AN 602A, UPF 605A, AMF 612, and SMF 614A. UE 601B may be served by AN 602B, UPF 605B, AMF 612, and SMF 614B. UE 601C may be served by AN 602C, UPF 605C, AMF 612, and SMF 614C. Although the respective UEs 601 communicate with different network elements from a logical perspective, these network elements may be deployed by a network operator using the same physical network elements.

Each network slice may be tailored to network services having different sets of characteristics. For example, slice A may correspond to enhanced mobile broadband (eMBB) service. Mobile broadband may refer to internet access by mobile users, commonly associated with smartphones. Slice B may correspond to ultra-reliable low-latency communication (URLLC), which focuses on reliability and speed. Relative to eMBB, URLLC may improve the feasibility of use cases such as autonomous driving and telesurgery. Slice C may correspond to massive machine type communication (mMTC), which focuses on low-power services delivered to a large number of users. For example, slice C may be optimized for a dense network of battery-powered sensors that provide small amounts of data at regular intervals. Many mMTC use cases would be prohibitively expensive if they operated using an eMBB or URLLC network.

If the service requirements for one of the UEs 601 changes, then the network slice serving that UE can be updated to provide better service. Moreover, the set of network characteristics corresponding to eMBB, URLLC, and mMTC may be varied, such that differentiated species of eMBB, URLLC, and mMTC are provided. Alternatively, network operators may provide entirely new services in response to, for example, customer demand.

In FIG. 6, each of the UEs 601 has its own network slice. However, it will be understood that a single slice may serve any number of UEs and a single UE may operate using any number of slices. Moreover, in the example network architecture 600B, the AN 602, UPF 605 and SMF 614 are separated into three separate slices, whereas the AMF 612 is unsliced. However, it will be understood that a network operator may deploy any architecture that selectively utilizes any mix of sliced and unsliced network elements, with different network elements divided into different numbers of slices. Although FIG. 6 only depicts three core network functions, it will be understood that other core network functions may be sliced as well. A PLMN that supports multiple network slices may maintain a separate network repository function (NFR) for each slice, enabling other NFs to discover network services associated with that slice.

Network slice selection may be controlled by an AMF, or alternatively, by a separate network slice selection function (NSSF). For example, a network operator may define and implement distinct network slice instances (NSIs). Each NSI may be associated with single network slice selection assistance information (S-NSSAI). The S-NSSAI may include a particular slice/service type (SST) indicator (indicating eMBB, URLLC, mMTC, etc.). as an example, a particular tracking area may be associated with one or more configured S-NSSAIs. UEs may identify one or more requested and/or subscribed S-NSSAIs (e.g., during registration). The network may indicate to the UE one or more allowed and/or rejected S-NSSAIs.

The S-NSSAI may further include a slice differentiator (SD) to distinguish between different tenants of a particular slice and/or service type. For example, a tenant may be a customer (e.g., vehicle manufacture, service provider, etc.) of a network operator that obtains (for example, purchases) guaranteed network resources and/or specific policies for handling its subscribers. The network operator may configure different slices and/or slice types, and use the SD to determine which tenant is associated with a particular slice.

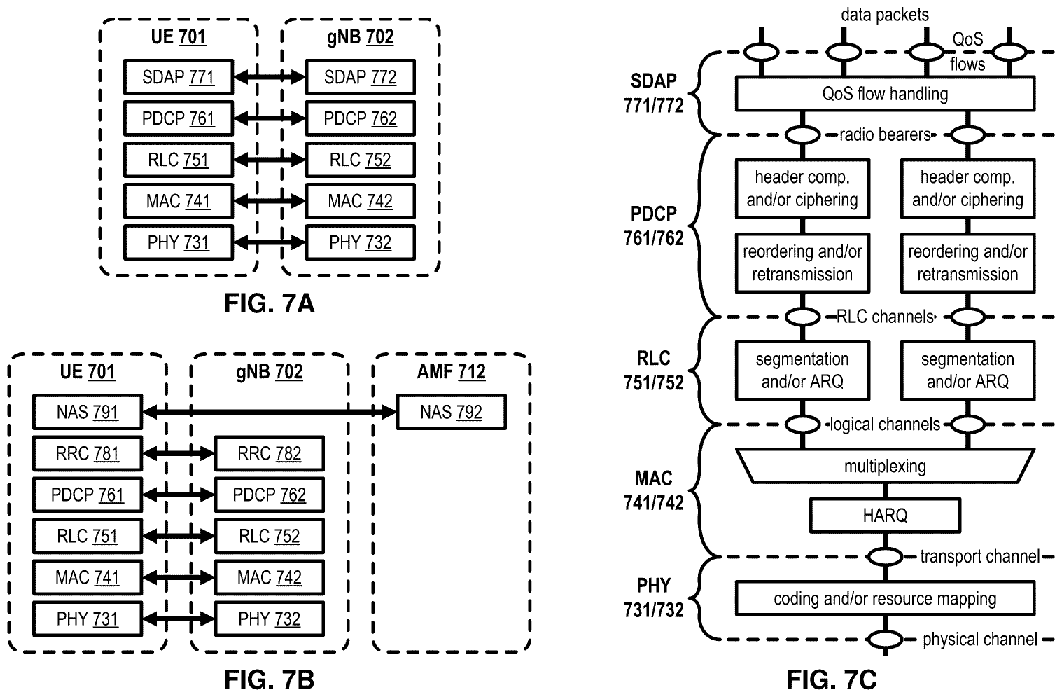

FIG. 7A, FIG. 7B, and FIG. 7C illustrate a user plane (UP) protocol stack, a control plane (CP) protocol stack, and services provided between protocol layers of the UP protocol stack.

The layers may be associated with an open system interconnection (OSI) model of computer networking functionality. In the OSI model, layer 1 may correspond to the bottom layer, with higher layers on top of the bottom layer. Layer 1 may correspond to a physical layer, which is concerned with the physical infrastructure used for transfer of signals (for example, cables, fiber optics, and/or radio frequency transceivers). In New Radio (NR), layer 1 may comprise a physical layer (PHY). Layer 2 may correspond to a data link layer. Layer 2 may be concerned with packaging of data (into, e.g., data frames) for transfer, between nodes of the network, using the physical infrastructure of layer 1. In NR, layer 2 may comprise a media access control layer (MAC), a radio link control layer (RLC), a packet data convergence layer (PDCP), and a service data application protocol layer (SDAP).

Layer 3 may correspond to a network layer. Layer 3 may be concerned with routing of the data which has been packaged in layer 2. Layer 3 may handle prioritization of data and traffic avoidance. In NR, layer 3 may comprise a radio resource control layer (RRC) and a non-access stratum layer (NAS). Layers 4 through 7 may correspond to a transport layer, a session layer, a presentation layer, and an application layer. The application layer interacts with an end user to provide data associated with an application. In an example, an end user implementing the application may generate data associated with the application and initiate sending of that information to a targeted data network (e.g., the Internet, an application server, etc.). Starting at the application layer, each layer in the OSI model may manipulate and/or repackage the information and deliver it to a lower layer. At the lowest layer, the manipulated and/or repackaged information may be exchanged via physical infrastructure (for example, electrically, optically, and/or electromagnetically). As it approaches the targeted data network, the information will be unpackaged and provided to higher and higher layers, until it once again reaches the application layer in a form that is usable by the targeted data network (e.g., the same form in which it was provided by the end user). To respond to the end user, the data network may perform this procedure in reverse.

FIG. 7A illustrates a user plane protocol stack. The user plane protocol stack may be a new radio (NR) protocol stack for a Uu interface between a UE 701 and a gNB 702. In layer 1 of the UP protocol stack, the UE 701 may implement PHY 731 and the gNB 702 may implement PHY 732. In layer 2 of the UP protocol stack, the UE 701 may implement MAC 741, RLC 751, PDCP 761, and SDAP 771. The gNB 702 may implement MAC 742, RLC 752, PDCP 762, and SDAP 772.

FIG. 7B illustrates a control plane protocol stack. The control plane protocol stack may be an NR protocol stack for the Uu interface between the UE 701 and the gNB 702 and/or an N1 interface between the UE 701 and an AMF 712. In layer 1 of the CP protocol stack, the UE 701 may implement PHY 731 and the gNB 702 may implement PHY 732. In layer 2 of the CP protocol stack, the UE 701 may implement MAC 741, RLC 751, PDCP 761, RRC 781, and NAS 791. The gNB 702 may implement MAC 742, RLC 752, PDCP 762, and RRC 782. The AMF 712 may implement NAS 792.

The NAS may be concerned with the non-access stratum, in particular, communication between the UE 701 and the core network (e.g., the AMF 712). Lower layers may be concerned with the access stratum, for example, communication between the UE 701 and the gNB 702. Messages sent between the UE 701 and the core network may be referred to as NAS messages. In an example, a NAS message may be relayed by the gNB 702, but the content of the NAS message (e.g., information elements of the NAS message) may not be visible to the gNB 702.

FIG. 7C illustrates an example of services provided between protocol layers of the NR user plane protocol stack illustrated in FIG. 7A. The UE 701 may receive services through a PDU session, which may be a logical connection between the UE 701 and a data network (DN). The UE 701 and the DN may exchange data packets associated with the PDU session. The PDU session may comprise one or more quality of service (QoS) flows. SDAP 771 and SDAP 772 may perform mapping and/or demapping between the one or more QoS flows of the PDU session and one or more radio bearers (e.g., data radio bearers). The mapping between the QoS flows and the data radio bearers may be determined in the SDAP 772 by the gNB 702, and the UE 701 may be notified of the mapping (e.g., based on control signalling and/or reflective mapping). For reflective mapping, the SDAP 772 of the gNB 220 may mark downlink packets with a QoS flow indicator (QFI) and deliver the downlink packets to the UE 701. The UE 701 may determine the mapping based on the QFI of the downlink packets.

PDCP 761 and PDCP 762 may perform header compression and/or decompression. Header compression may reduce the amount of data transmitted over the physical layer. The PDCP 761 and PDCP 762 may perform ciphering and/or deciphering. Ciphering may reduce unauthorized decoding of data transmitted over the physical layer (e.g., intercepted on an air interface), and protect data integrity (e.g., to ensure control messages originate from intended sources). The PDCP 761 and PDCP 762 may perform retransmissions of undelivered packets, in-sequence delivery and reordering of packets, duplication of packets, and/or identification and removal of duplicate packets. In a dual connectivity scenario, PDCP 761 and PDCP 762 may perform mapping between a split radio bearer and RLC channels.

RLC 751 and RLC 752 may perform segmentation, retransmission through Automatic Repeat Request (ARQ). The RLC 751 and RLC 752 may perform removal of duplicate data units received from MAC 741 and MAC 742, respectively. The RLCs 213 and 223 may provide RLC channels as a service to PDCPs 214 and 224, respectively.

MAC 741 and MAC 742 may perform multiplexing and/or demultiplexing of logical channels. MAC 741 and MAC 742 may map logical channels to transport channels. In an example, UE 701 may, in MAC 741, multiplex data units of one or more logical channels into a transport block. The UE 701 may transmit the transport block to the gNB 702 using PHY 731. The gNB 702 may receive the transport block using PHY 732 and demultiplex data units of the transport blocks back into logical channels. MAC 741 and MAC 742 may perform error correction through Hybrid Automatic Repeat Request (HARQ), logical channel prioritization, and/or padding.

PHY 731 and PHY 732 may perform mapping of transport channels to physical channels. PHY 731 and PHY 732 may perform digital and analog signal processing functions (e.g., coding/decoding and modulation/demodulation) for sending and receiving information (e.g., transmission via an air interface). PHY 731 and PHY 732 may perform multi-antenna mapping.

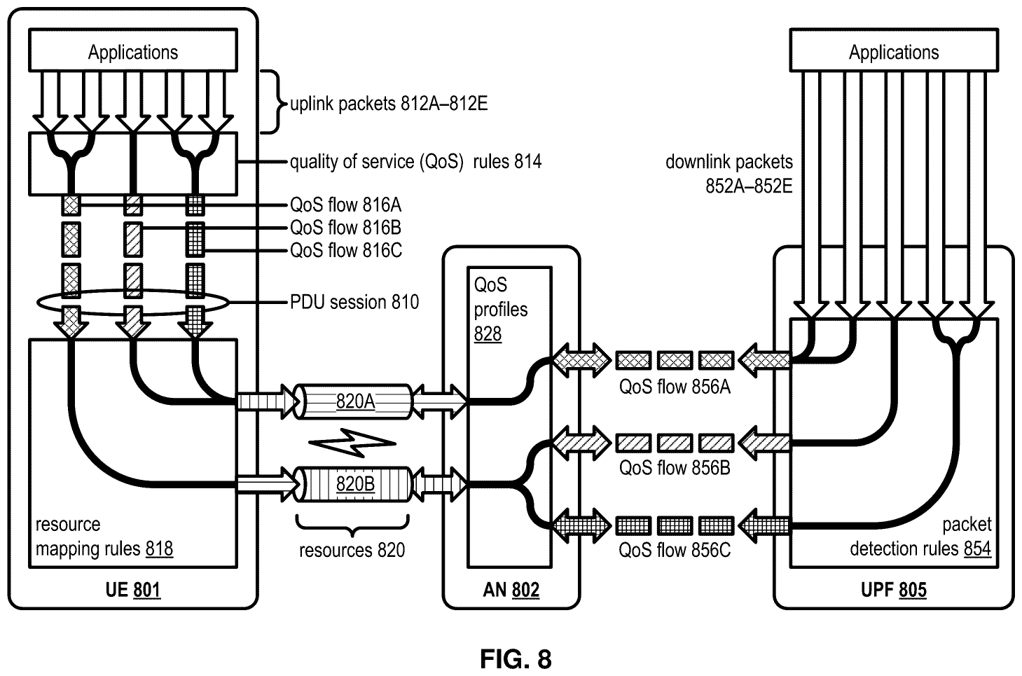

FIG. 8 illustrates an example of a quality of service (QoS) model for differentiated data exchange. In the QoS model of FIG. 8, there are a UE 801, a AN 802, and a UPF 805. The QoS model facilitates prioritization of certain packet or protocol data units (PDUs), also referred to as packets. For example, higher-priority packets may be exchanged faster and/or more reliably than lower-priority packets. The network may devote more resources to exchange of high-QoS packets.

In the example of FIG. 8, a PDU session 810 is established between UE 801 and UPF 805. The PDU session 810 may be a logical connection enabling the UE 801 to exchange data with a particular data network (for example, the Internet). The UE 801 may request establishment of the PDU session 810. At the time that the PDU session 810 is established, the UE 801 may, for example, identify the targeted data network based on its data network name (DNN). The PDU session 810 may be managed, for example, by a session management function (SMF, not shown). In order to facilitate exchange of data associated with the PDU session 810, between the UE 801 and the data network, the SMF may select the UPF 805 (and optionally, one or more other UPFs, not shown).

One or more applications associated with UE 801 may generate uplink packets 812A-812E associated with the PDU session 810. In order to work within the QoS model, UE 801 may apply QoS rules 814 to uplink packets 812A-812E. The QoS rules 814 may be associated with PDU session 810 and may be determined and/or provided to the UE 801 when PDU session 810 is established and/or modified. Based on QoS rules 814, UE 801 may classify uplink packets 812A-812E, map each of the uplink packets 812A-812E to a QoS flow, and/or mark uplink packets 812A-812E with a QoS flow indicator (QFI). As a packet travels through the network, and potentially mixes with other packets from other UEs having potentially different priorities, the QFI indicates how the packet should be handled in accordance with the QoS model. In the present illustration, uplink packets 812A, 812B are mapped to QoS flow 816A, uplink packet 812C is mapped to QoS flow 816B, and the remaining packets are mapped to QoS flow 816C.

The QoS flows may be the finest granularity of QoS differentiation in a PDU session. In the figure, three QoS flows 816A-816C are illustrated. However, it will be understood that there may be any number of QoS flows. Some QoS flows may be associated with a guaranteed bit rate (GBR QoS flows) and others may have bit rates that are not guaranteed (non-GBR QoS flows). QoS flows may also be subject to per-UE and per-session aggregate bit rates. One of the QoS flows may be a default QoS flow. The QoS flows may have different priorities. For example, QoS flow 816A may have a higher priority than QoS flow 816B, which may have a higher priority than QoS flow 816C. Different priorities may be reflected by different QoS flow characteristics. For example, QoS flows may be associated with flow bit rates. A particular QoS flow may be associated with a guaranteed flow bit rate (GFBR) and/or a maximum flow bit rate (MFBR). QoS flows may be associated with specific packet delay budgets (PDBs), packet error rates (PERs), and/or maximum packet loss rates. QoS flows may also be subject to per-UE and per-session aggregate bit rates.

In order to work within the QoS model, UE 801 may apply resource mapping rules 818 to the QoS flows 816A-816C. The air interface between UE 801 and AN 802 may be associated with resources 820. In the present illustration, QoS flow 816A is mapped to resource 820A, whereas QoS flows 816B, 816C are mapped to resource 820B. The resource mapping rules 818 may be provided by the AN 802. In order to meet QoS requirements, the resource mapping rules 818 may designate more resources for relatively high-priority QoS flows. With more resources, a high-priority QoS flow such as QoS flow 816A may be more likely to obtain the high flow bit rate, low packet delay budget, or other characteristic associated with QoS rules 814. The resources 820 may comprise, for example, radio bearers. The radio bearers (e.g., data radio bearers) may be established between the UE 801 and the AN 802. The radio bearers in 5G, between the UE 801 and the AN 802, may be distinct from bearers in LTE, for example, Evolved Packet System (EPS) bearers between a UE and a packet data network gateway (PGW), S1 bearers between an eNB and a serving gateway (SGW), and/or an S5/S8 bearer between an SGW and a PGW.

Once a packet associated with a particular QoS flow is received at AN 802 via resource 820A or resource 820B, AN 802 may separate packets into respective QoS flows 856A-856C based on QoS profiles 828. The QoS profiles 828 may be received from an SMF. Each QoS profile may correspond to a QFI, for example, the QFI marked on the uplink packets 812A-812E. Each QoS profile may include QoS parameters such as 5G QoS identifier (5QI) and an allocation and retention priority (ARP). The QoS profile for non-GBR QoS flows may further include additional QoS parameters such as a reflective QoS attribute (RQA). The QoS profile for GBR QoS flows may further include additional QoS parameters such as a guaranteed flow bit rate (GFBR), a maximum flow bit rate (MFBR), and/or a maximum packet loss rate. The 5QI may be a standardized 5QI which have one-to-one mapping to a standardized combination of 5G QoS characteristics per well-known services. The 5QI may be a dynamically assigned 5QI which the standardized 5QI values are not defined. The 5QI may represent 5G QoS characteristics. The 5QI may comprise a resource type, a default priority level, a packet delay budget (PDB), a packet error rate (PER), a maximum data burst volume, and/or an averaging window. The resource type may indicate a non-GBR QoS flow, a GBR QoS flow or a delay-critical GBR QoS flow. The averaging window may represent a duration over which the GFBR and/or MFBR is calculated. ARP may be a priority level comprising pre-emption capability and a pre-emption vulnerability. Based on the ARP, the AN 802 may apply admission control for the QoS flows in a case of resource limitations.

The AN 802 may select one or more N3 tunnels 850 for transmission of the QoS flows 856A-856C. After the packets are divided into QoS flows 856A-856C, the packet may be sent to UPF 805 (e.g., towards a DN) via the selected one or more N3 tunnels 850. The UPF 805 may verify that the QFIs of the uplink packets 812A-812E are aligned with the QoS rules 814 provided to the UE 801. The UPF 805 may measure and/or count packets and/or provide packet metrics to, for example, a PCF.

The figure also illustrates a process for downlink. In particular, one or more applications may generate downlink packets 852A-852E. The UPF 805 may receive downlink packets 852A-852E from one or more DNs and/or one or more other UPFs. As per the QoS model, UPF 805 may apply packet detection rules (PDRs) 854 to downlink packets 852A-852E. Based on PDRs 854, UPF 805 may map packets 852A-852E into QoS flows. In the present illustration, downlink packets 852A, 852B are mapped to QoS flow 856A, downlink packet 852C is mapped to QoS flow 856B, and the remaining packets are mapped to QoS flow 856C.

The QoS flows 856A-856C may be sent to AN 802. The AN 802 may apply resource mapping rules to the QoS flows 856A-856C. In the present illustration, QoS flow 856A is mapped to resource 820A, whereas QoS flows 856B, 856C are mapped to resource 820B. In order to meet QoS requirements, the resource mapping rules may designate more resources to high-priority QoS flows.

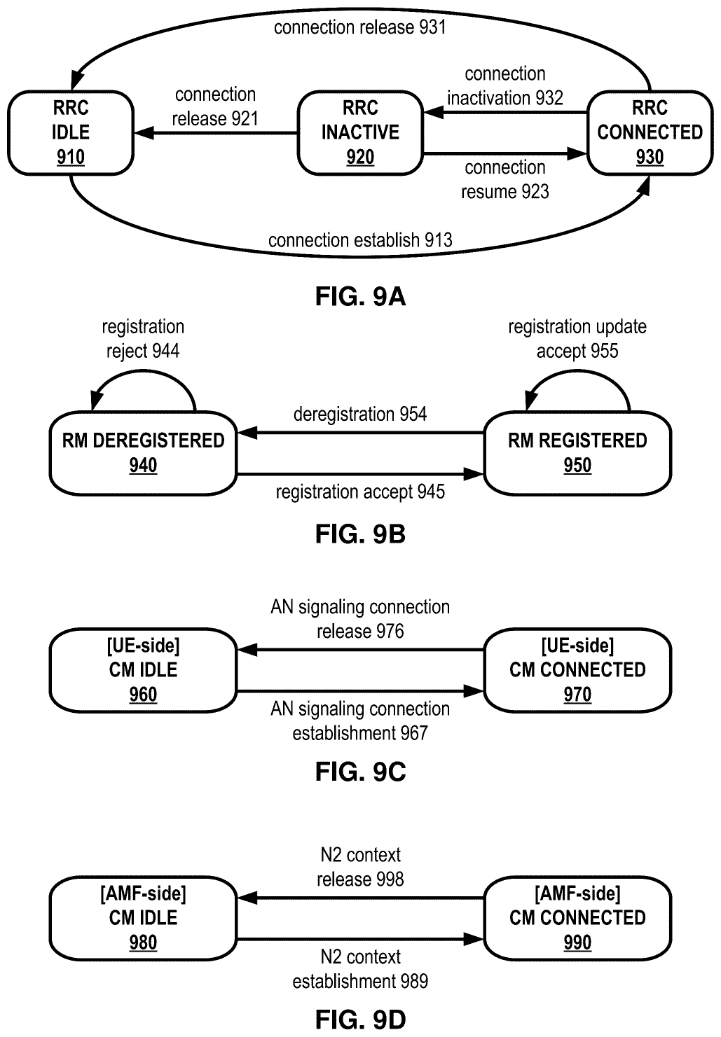

FIGS. 9A-9D illustrate example states and state transitions of a wireless device (e.g., a UE). At any given time, the wireless device may have a radio resource control (RRC) state, a registration management (RM) state, and a connection management (CM) state.

FIG. 9A is an example diagram showing RRC state transitions of a wireless device (e.g., a UE). The UE may be in one of three RRC states: RRC idle 910, (e.g., RRC_IDLE), RRC inactive 920 (e.g., RRC_INACTIVE), or RRC connected 930 (e.g., RRC_CONNECTED). The UE may implement different RAN-related control-plane procedures depending on its RRC state. Other elements of the network, for example, a base station, may track the RRC state of one or more UEs and implement RAN-related control-plane procedures appropriate to the RRC state of each.

In RRC connected 930, it may be possible for the UE to exchange data with the network (for example, the base station). The parameters necessary for exchange of data may be established and known to both the UE and the network. The parameters may be referred to and/or included in an RRC context of the UE (sometimes referred to as a UE context). These parameters may include, for example: one or more AS contexts; one or more radio link configuration parameters; bearer configuration information (e.g., relating to a data radio bearer, signalling radio bearer, logical channel, QoS flow, and/or PDU session); security information; and/or PHY, MAC, RLC, PDCP, and/or SDAP layer configuration information. The base station with which the UE is connected may store the RRC context of the UE.

While in RRC connected 930, mobility of the UE may be managed by the access network, whereas the UE itself may manage mobility while in RRC idle 910 and/or RRC inactive 920. While in RRC connected 930, the UE may manage mobility by measuring signal levels (e.g., reference signal levels) from a serving cell and neighboring cells and reporting these measurements to the base station currently serving the UE. The network may initiate handover based on the reported measurements. The RRC state may transition from RRC connected 930 to RRC idle 910 through a connection release procedure 930 or to RRC inactive 920 through a connection inactivation procedure 932.

In RRC idle 910, an RRC context may not be established for the UE. In RRC idle 910, the UE may not have an RRC connection with a base station. While in RRC idle 910, the UE may be in a sleep state for a majority of the time (e.g., to conserve battery power). The UE may wake up periodically (e.g., once in every discontinuous reception cycle) to monitor for paging messages from the access network. Mobility of the UE may be managed by the UE through a procedure known as cell reselection. The RRC state may transition from RRC idle 910 to RRC connected 930 through a connection establishment procedure 913, which may involve a random access procedure, as discussed in greater detail below.

In RRC inactive 920, the RRC context previously established is maintained in the UE and the base station. This may allow for a fast transition to RRC connected 930 with reduced signalling overhead as compared to the transition from RRC idle 910 to RRC connected 930. The RRC state may transition to RRC connected 930 through a connection resume procedure 923. The RRC state may transition to RRC idle 910 though a connection release procedure 921 that may be the same as or similar to connection release procedure 931.

An RRC state may be associated with a mobility management mechanism. In RRC idle 910 and RRC inactive 920, mobility may be managed by the UE through cell reselection. The purpose of mobility management in RRC idle 910 and/or RRC inactive 920 is to allow the network to be able to notify the UE of an event via a paging message without having to broadcast the paging message over the entire mobile communications network. The mobility management mechanism used in RRC idle 910 and/or RRC inactive 920 may allow the network to track the UE on a cell-group level so that the paging message may be broadcast over the cells of the cell group that the UE currently resides within instead of the entire communication network. Tracking may be based on different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 920 state, the UE may be assigned a RAN notification area. A RAN notification area may comprise one or more cell identities, a list of RAIs, and/or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 920.

FIG. 9B is an example diagram showing registration management (RM) state transitions of a wireless device (e.g., a UE). The states are RM deregistered 940, (e.g., RM-DEREGISTERED) and RM registered 950 (e.g., RM-REGISTERED).

In RM deregistered 940, the UE is not registered with the network, and the UE is not reachable by the network. In order to be reachable by the network, the UE must perform an initial registration. As an example, the UE may register with an AMF of the network. If registration is rejected (registration reject 944), then the UE remains in RM deregistered 940. If registration is accepted (registration accept 945), then the UE transitions to RM registered 950. While the UE is RM registered 950, the network may store, keep, and/or maintain a UE context for the UE. The UE context may be referred to as wireless device context. The UE context corresponding to network registration (maintained by the core network) may be different from the RRC context corresponding to RRC state (maintained by an access network, e.g., a base station). The UE context may comprise a UE identifier and a record of various information relating to the UE, for example, UE capability information, policy information for access and mobility management of the UE, lists of allowed or established slices or PDU sessions, and/or a registration area of the UE (i.e., a list of tracking areas covering the geographical area where the wireless device is likely to be found).

While the UE is RM registered 950, the network may store the UE context of the UE, and if necessary use the UE context to reach the UE. Moreover, some services may not be provided by the network unless the UE is registered. The UE may update its UE context while remaining in RM registered 950 (registration update accept 955). For example, if the UE leaves one tracking area and enters another tracking area, the UE may provide a tracking area identifier to the network. The network may deregister the UE, or the UE may deregister itself (deregistration 954). For example, the network may automatically deregister the wireless device if the wireless device is inactive for a certain amount of time. Upon deregistration, the UE may transition to RM deregistered 940.

FIG. 9C is an example diagram showing connection management (CM) state transitions of a wireless device (e.g., a UE), shown from a perspective of the wireless device. The UE may be in CM idle 960 (e.g., CM-IDLE) or CM connected 970 (e.g., CM-CONNECTED).

In CM idle 960, the UE does not have a non access stratum (NAS) signalling connection with the network. As a result, the UE can not communicate with core network functions. The UE may transition to CM connected 970 by establishing an AN signalling connection (AN signalling connection establishment 967). This transition may be initiated by sending an initial NAS message. The initial NAS message may be a registration request (e.g., if the UE is RM deregistered 940) or a service request (e.g., if the UE is RM registered 950). If the UE is RM registered 950, then the UE may initiate the AN signalling connection establishment by sending a service request, or the network may send a page, thereby triggering the UE to send the service request.

In CM connected 970, the UE can communicate with core network functions using NAS signalling. As an example, the UE may exchange NAS signalling with an AMF for registration management purposes, service request procedures, and/or authentication procedures. As another example, the UE may exchange NAS signalling, with an SMF, to establish and/or modify a PDU session. The network may disconnect the UE, or the UE may disconnect itself (AN signalling connection release 976). For example, if the UE transitions to RM deregistered 940, then the UE may also transition to CM idle 960. When the UE transitions to CM idle 960, the network may deactivate a user plane connection of a PDU session of the UE.

FIG. 9D is an example diagram showing CM state transitions of the wireless device (e.g., a UE), shown from a network perspective (e.g., an AMF). The CM state of the UE, as tracked by the AMF, may be in CM idle 980 (e.g., CM-IDLE) or CM connected 990 (e.g., CM-CONNECTED). When the UE transitions from CM idle 980 to CM connected 990, the AMF many establish an N2 context of the UE (N2 context establishment 989). When the UE transitions from CM connected 990 to CM idle 980, the AMF many release the N2 context of the UE (N2 context release 998).

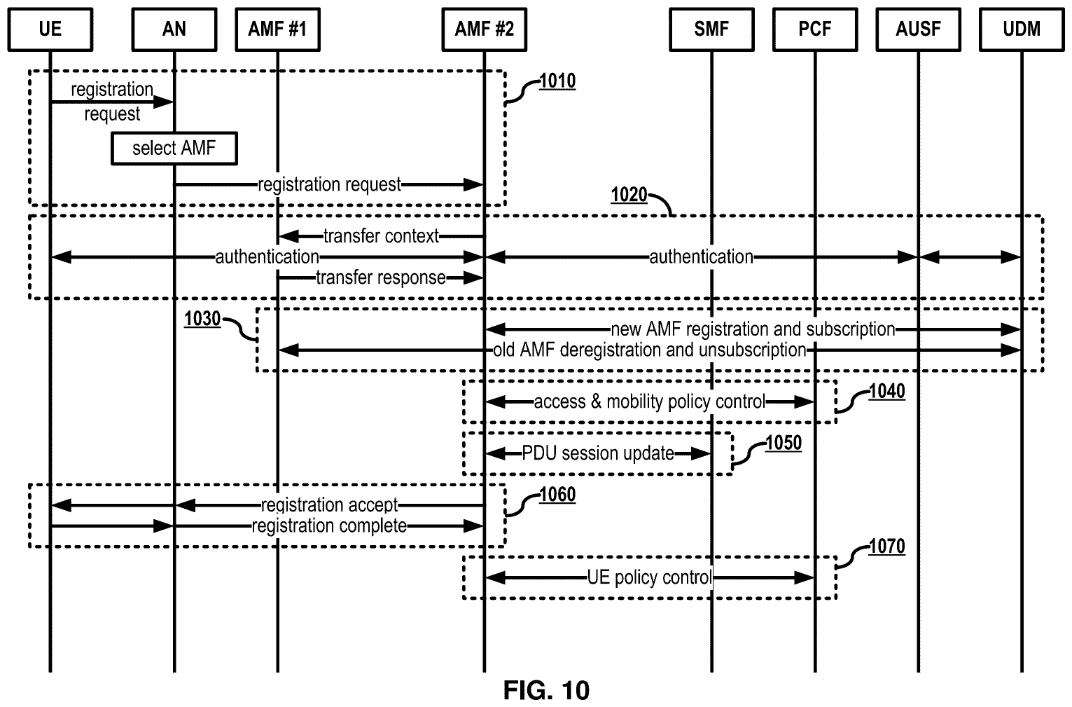

FIGS. 10-12 illustrate example procedures for registering, service request, and PDU session establishment of a UE.

FIG. 10 illustrates an example of a registration procedure for a wireless device (e.g., a UE). Based on the registration procedure, the UE may transition from, for example, RM deregistered 940 to RM registered 950.

Registration may be initiated by a UE for the purposes of obtaining authorization to receive services, enabling mobility tracking, enabling reachability, or other purposes. The UE may perform an initial registration as a first step toward connection to the network (for example, if the UE is powered on, airplane mode is turned off, etc.). Registration may also be performed periodically to keep the network informed of the UE's presence (for example, while in CM-IDLE state), or in response to a change in UE capability or registration area. Deregistration (not shown in FIG. 10) may be performed to stop network access.

At 1010, the UE transmits a registration request to an AN. As an example, the UE may have moved from a coverage area of a previous AMF (illustrated as AMF #1) into a coverage area of a new AMF (illustrated as AMF #2). The registration request may be a NAS message. The registration request may include a UE identifier. The AN may select an AMF for registration of the UE. For example, the AN may select a default AMF. For example, the AN may select an AMF that is already mapped to the UE (e.g., a previous AMF). The NAS registration request may include a network slice identifier and the AN may select an AMF based on the requested slice. After the AMF is selected, the AN may send the registration request to the selected AMF.

At 1020, the AMF that receives the registration request (AMF #2) performs a context transfer. The context may be a UE context, for example, an RRC context for the UE. As an example, AMF #2 may send AMF #1 a message requesting a context of the UE. The message may include the UE identifier. The message may be a Namf_Communication_UEContextTransfer message. AMF #1 may send to AMF #2 a message that includes the requested UE context. This message may be a Namf_Communication_UEContextTransfer message. After the UE context is received, the AMF #2 may coordinate authentication of the UE. After authentication is complete, AMF #2 may send to AMF #1 a message indicating that the UE context transfer is complete. This message may be a Namf_Communication_UEContextTransfer Response message.

Authentication may require participation of the UE, an AUSF, a UDM and/or a UDR (not shown). For example, the AMF may request that the AUSF authenticate the UE. For example, the AUSF may execute authentication of the UE. For example, the AUSF may get authentication data from UDM. For example, the AUSF may send a subscription permanent identifier (SUPI) to the AMF based on the authentication being successful. For example, the AUSF may provide an intermediate key to the AMF. The intermediate key may be used to derive an access-specific security key for the UE, enabling the AMF to perform security context management (SCM). The AUSF may obtain subscription data from the UDM. The subscription data may be based on information obtained from the UDM (and/or the UDR). The subscription data may include subscription identifiers, security credentials, access and mobility related subscription data and/or session related data.

At 1030, the new AMF, AMF #2, registers and/or subscribes with the UDM. AMF #2 may perform registration using a UE context management service of the UDM (Nudm_UECM). AMF #2 may obtain subscription information of the UE using a subscriber data management service of the UDM (Nudm_SDM). AMF #2 may further request that the UDM notify AMF #2 if the subscription information of the UE changes. As the new AMF registers and subscribes, the old AMF, AMF #1, may deregister and unsubscribe. After deregistration, AMF #1 is free of responsibility for mobility management of the UE.

At 1040, AMF #2 retrieves access and mobility (AM) policies from the PCF. As an example, the AMF #2 may provide subscription data of the UE to the PCF. The PCF may determine access and mobility policies for the UE based on the subscription data, network operator data, current network conditions, and/or other suitable information. For example, the owner of a first UE may purchase a higher level of service than the owner of a second UE. The PCF may provide the rules associated with the different levels of service. Based on the subscription data of the respective UEs, the network may apply different policies which facilitate different levels of service.

For example, access and mobility policies may relate to service area restrictions, RAT/frequency selection priority (RFSP, where RAT stands for radio access technology), authorization and prioritization of access type (e.g., LTE versus NR), and/or selection of non-3GPP access (e.g., Access Network Discovery and Selection Policy (ANDSP)). The service area restrictions may comprise a list of tracking areas where the UE is allowed to be served (or forbidden from being served). The access and mobility policies may include a UE route selection policy (URSP)) that influences routing to an established PDU session or a new PDU session. As noted above, different policies may be obtained and/or enforced based on subscription data of the UE, location of the UE (i.e., location of the AN and/or AMF), or other suitable factors.

At 1050, AMF #2 may update a context of a PDU session. For example, if the UE has an existing PDU session, the AMF #2 may coordinate with an SMF to activate a user plane connection associated with the existing PDU session. The SMF may update and/or release a session management context of the PDU session (Nsmf_PDUSession_UpdateSMContext, Nsmf_PDUSession_ReleaseSMContext).

At 1060, AMF #2 sends a registration accept message to the AN, which forwards the registration accept message to the UE. The registration accept message may include a new UE identifier and/or a new configured slice identifier. The UE may transmit a registration complete message to the AN, which forwards the registration complete message to the AMF #2. The registration complete message may acknowledge receipt of the new UE identifier and/or new configured slice identifier.

At 1070, AMF #2 may obtain UE policy control information from the PCF. The PCF may provide an access network discovery and selection policy (ANDSP) to facilitate non-3GPP access. The PCF may provide a UE route selection policy (URSP) to facilitate mapping of particular data traffic to particular PDU session connectivity parameters. As an example, the URSP may indicate that data traffic associated with a particular application should be mapped to a particular SSC mode, network slice, PDU session type, or preferred access type (3GPP or non-3GPP).

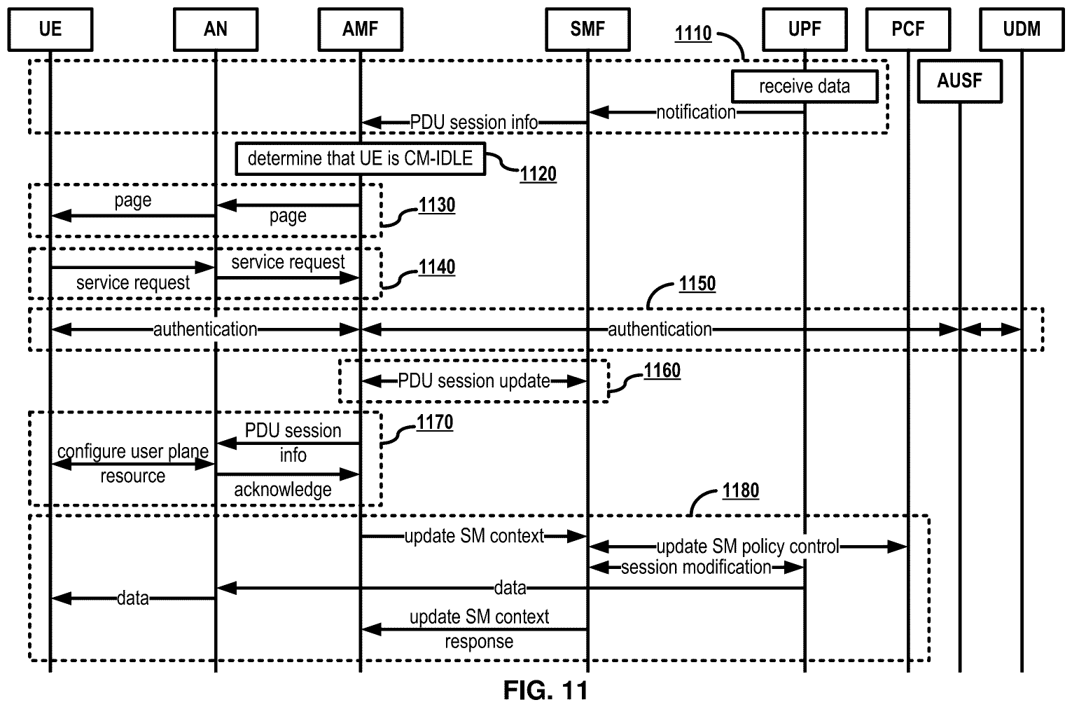

FIG. 11 illustrates an example of a service request procedure for a wireless device (e.g., a UE). The service request procedure depicted in FIG. 11 is a network-triggered service request procedure for a UE in a CM-IDLE state. However, other service request procedures (e.g., a UE-triggered service request procedure) may also be understood by reference to FIG. 11, as will be discussed in greater detail below.

At 1110, a UPF receives data. The data may be downlink data for transmission to a UE. The data may be associated with an existing PDU session between the UE and a DN. The data may be received, for example, from a DN and/or another UPF. The UPF may buffer the received data. In response to the receiving of the data, the UPF may notify an SMF of the received data. The identity of the SMF to be notified may be determined based on the received data. The notification may be, for example, an N4 session report. The notification may indicate that the UPF has received data associated with the UE and/or a particular PDU session associated with the UE. In response to receiving the notification, the SMF may send PDU session information to an AMF. The PDU session information may be sent in an N1N2 message transfer for forwarding to an AN. The PDU session information may include, for example, UPF tunnel endpoint information and/or QoS information.

At 1120, the AMF determines that the UE is in a CM-IDLE state. The determining at 1120 may be in response to the receiving of the PDU session information. Based on the determination that the UE is CM-IDLE, the service request procedure may proceed to 1130 and 1140, as depicted in FIG. 11. However, if the UE is not CM-IDLE (e.g., the UE is CM-CONNECTED), then 1130 and 1140 may be skipped, and the service request procedure may proceed directly to 1150.

At 1130, the AMF pages the UE. The paging at 1130 may be performed based on the UE being CM-IDLE. To perform the paging, the AMF may send a page to the AN. The page may be referred to as a paging or a paging message. The page may be an N2 request message. The AN may be one of a plurality of ANs in a RAN notification area of the UE. The AN may send a page to the UE. The UE may be in a coverage area of the AN and may receive the page.

At 1140, the UE may request service. The UE may transmit a service request to the AMF via the AN. As depicted in FIG. 11, the UE may request service at 1140 in response to receiving the paging at 1130. However, as noted above, this is for the specific case of a network-triggered service request procedure. In some scenarios (for example, if uplink data becomes available at the UE), then the UE may commence a UE-triggered service request procedure. The UE-triggered service request procedure may commence starting at 1140.

At 1150, the network may authenticate the UE. Authentication may require participation of the UE, an AUSF, and/or a UDM, for example, similar to authentication described elsewhere in the present disclosure. In some cases (for example, if the UE has recently been authenticated), the authentication at 1150 may be skipped.

At 1160, the AMF and SMF may perform a PDU session update. As part of the PDU session update, the SMF may provide the AMF with one or more UPF tunnel endpoint identifiers. In some cases (not shown in FIG. 11), it may be necessary for the SMF to coordinate with one or more other SMFs and/or one or more other UPFs to set up a user plane.

At 1170, the AMF may send PDU session information to the AN. The PDU session information may be included in an N2 request message. Based on the PDU session information, the AN may configure a user plane resource for the UE. To configure the user plane resource, the AN may, for example, perform an RRC reconfiguration of the UE. The AN may acknowledge to the AMF that the PDU session information has been received. The AN may notify the AMF that the user plane resource has been configured, and/or provide information relating to the user plane resource configuration.

In the case of a UE-triggered service request procedure, the UE may receive, at 1170, a NAS service accept message from the AMF via the AN. After the user plane resource is configured, the UE may transmit uplink data (for example, the uplink data that caused the UE to trigger the service request procedure).

At 1180, the AMF may update a session management (SM) context of the PDU session. For example, the AMF may notify the SMF (and/or one or more other associated SMFs) that the user plane resource has been configured, and/or provide information relating to the user plane resource configuration. The AMF may provide the SMF (and/or one or more other associated SMFs) with one or more AN tunnel endpoint identifiers of the AN. After the SM context update is complete, the SMF may send an update SM context response message to the AMF.

Based on the update of the session management context, the SMF may update a PCF for purposes of policy control. For example, if a location of the UE has changed, the SMF may notify the PCF of the UE's a new location.

Based on the update of the session management context, the SMF and UPF may perform a session modification. The session modification may be performed using N4 session modification messages. After the session modification is complete, the UPF may transmit downlink data (for example, the downlink data that caused the UPF to trigger the network-triggered service request procedure) to the UE. The transmitting of the downlink data may be based on the one or more AN tunnel endpoint identifiers of the AN.

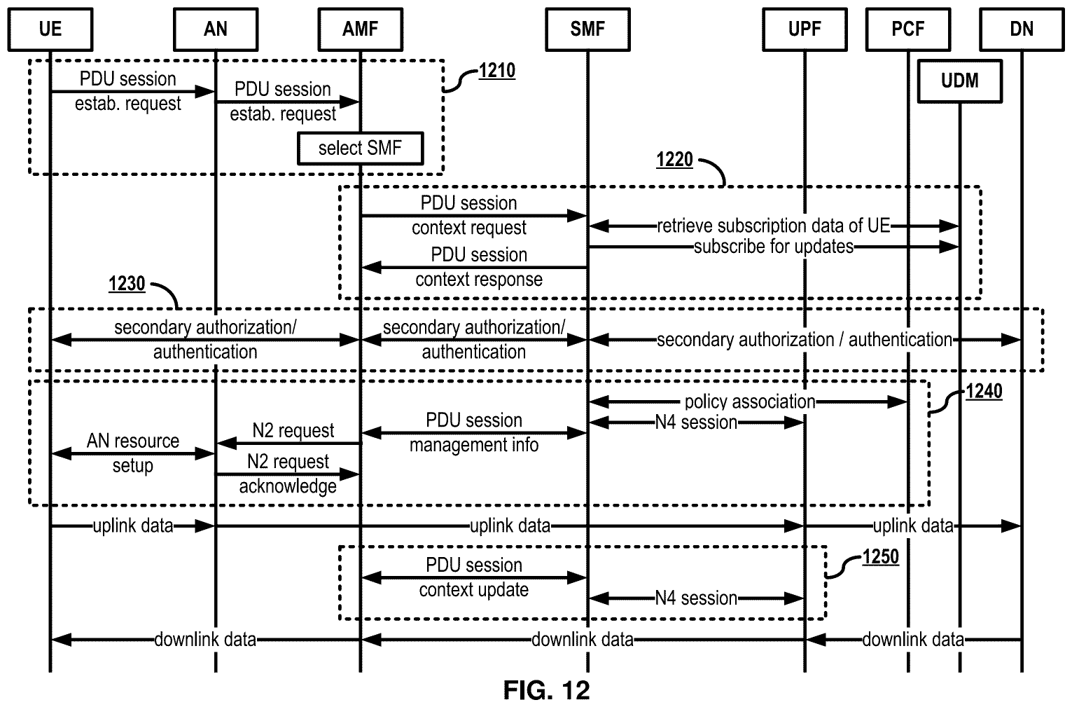

FIG. 12 illustrates an example of a protocol data unit (PDU) session establishment procedure for a wireless device (e.g., a UE). The UE may determine to transmit the PDU session establishment request to create a new PDU session, to hand over an existing PDU session to a 3GPP network, or for any other suitable reason.

At 1210, the UE initiates PDU session establishment. The UE may transmit a PDU session establishment request to an AMF via an AN. The PDU session establishment request may be a NAS message. The PDU session establishment request may indicate: a PDU session ID; a requested PDU session type (new or existing); a requested DN (DNN); a requested network slice (S-NSSAI); a requested SSC mode; and/or any other suitable information. The PDU session ID may be generated by the UE. The PDU session type may be, for example, an Internet Protocol (IP)-based type (e.g., IPv4, IPv6, or dual stack IPv4/IPv6), an Ethernet type, or an unstructured type.

The AMF may select an SMF based on the PDU session establishment request. In some scenarios, the requested PDU session may already be associated with a particular SMF. For example, the AMF may store a UE context of the UE, and the UE context may indicate that the PDU session ID of the requested PDU session is already associated with the particular SMF. In some scenarios, the AMF may select the SMF based on a determination that the SMF is prepared to handle the requested PDU session. For example, the requested PDU session may be associated with a particular DNN and/or S-NSSAI, and the SMF may be selected based on a determination that the SMF can manage a PDU session associated with the particular DNN and/or S-NSSAI.

At 1220, the network manages a context of the PDU session. After selecting the SMF at 1210, the AMF sends a PDU session context request to the SMF. The PDU session context request may include the PDU session establishment request received from the UE at 1210. The PDU session context request may be a Nsmf_PDUSession_CreateSMContext Request and/or a Nsmf_PDUSession_UpdateSMContext Request. The PDU session context request may indicate identifiers of the UE; the requested DN; and/or the requested network slice. Based on the PDU session context request, the SMF may retrieve subscription data from a UDM. The subscription data may be session management subscription data of the UE. The SMF may subscribe for updates to the subscription data, so that the PCF will send new information if the subscription data of the UE changes. After the subscription data of the UE is obtained, the SMF may transmit a PDU session context response to the AMG. The PDU session context response may be a Nsmf_PDUSession_CreateSMContext Response and/or a Nsmf_PDUSession_UpdateSMContext Response. The PDU session context response may include a session management context ID.

At 1230, secondary authorization/authentication may be performed, if necessary. The secondary authorization/authentication may involve the UE, the AMF, the SMF, and the DN. The SMF may access the DN via a Data Network Authentication, Authorization and Accounting (DN AAA) server.

At 1240, the network sets up a data path for uplink data associated with the PDU session. The SMF may select a PCF and establish a session management policy association. Based on the association, the PCF may provide an initial set of policy control and charging rules (PCC rules) for the PDU session. When targeting a particular PDU session, the PCF may indicate, to the SMF, a method for allocating an IP address to the PDU Session, a default charging method for the PDU session, an address of the corresponding charging entity, triggers for requesting new policies, etc. The PCF may also target a service data flow (SDF) comprising one or more PDU sessions. When targeting an SDF, the PCF may indicate, to the SMF, policies for applying QoS requirements, monitoring traffic (e.g., for charging purposes), and/or steering traffic (e.g., by using one or more particular N6 interfaces).

The SMF may determine and/or allocate an IP address for the PDU session. The SMF may select one or more UPFs (a single UPF in the example of FIG. 12) to handle the PDU session. The SMF may send an N4 session message to the selected UPF. The N4 session message may be an N4 Session Establishment Request and/or an N4 Session Modification Request. The N4 session message may include packet detection, enforcement, and reporting rules associated with the PDU session. In response, the UPF may acknowledge by sending an N4 session establishment response and/or an N4 session modification response.

The SMF may send PDU session management information to the AMF. The PDU session management information may be a Namf_Communication_N1N2MessageTransfer message. The PDU session management information may include the PDU session ID. The PDU session management information may be a NAS message. The PDU session management information may include N1 session management information and/or N2 session management information. The N1 session management information may include a PDU session establishment accept message. The PDU session establishment accept message may include tunneling endpoint information of the UPF and quality of service (QoS) information associated with the PDU session.

The AMF may send an N2 request to the AN. The N2 request may include the PDU session establishment accept message. Based on the N2 request, the AN may determine AN resources for the UE. The AN resources may be used by the UE to establish the PDU session, via the AN, with the DN. The AN may determine resources to be used for the PDU session and indicate the determined resources to the UE. The AN may send the PDU session establishment accept message to the UE. For example, the AN may perform an RRC reconfiguration of the UE. After the AN resources are set up, the AN may send an N2 request acknowledge to the AMF. The N2 request acknowledge may include N2 session management information, for example, the PDU session ID and tunneling endpoint information of the AN.

After the data path for uplink data is set up at 1240, the UE may optionally send uplink data associated with the PDU session. As shown in FIG. 12, the uplink data may be sent to a DN associated with the PDU session via the AN and the UPF.

At 1250, the network may update the PDU session context. The AMF may transmit a PDU session context update request to the SMF. The PDU session context update request may be a Nsmf_PDUSession_UpdateSMContext Request. The PDU session context update request may include the N2 session management information received from the AN. The SMF may acknowledge the PDU session context update. The acknowledgement may be a Nsmf_PDUSession_UpdateSMContext Response. The acknowledgement may include a subscription requesting that the SMF be notified of any UE mobility event. Based on the PDU session context update request, the SMF may send an N4 session message to the UPF. The N4 session message may be an N4 Session Modification Request. The N4 session message may include tunneling endpoint information of the AN. The N4 session message may include forwarding rules associated with the PDU session. In response, the UPF may acknowledge by sending an N4 session modification response.

After the UPF receives the tunneling endpoint information of the AN, the UPF may relay downlink data associated with the PDU session. As shown in FIG. 12, the downlink data may be received from a DN associated with the PDU session via the AN and the UPF.

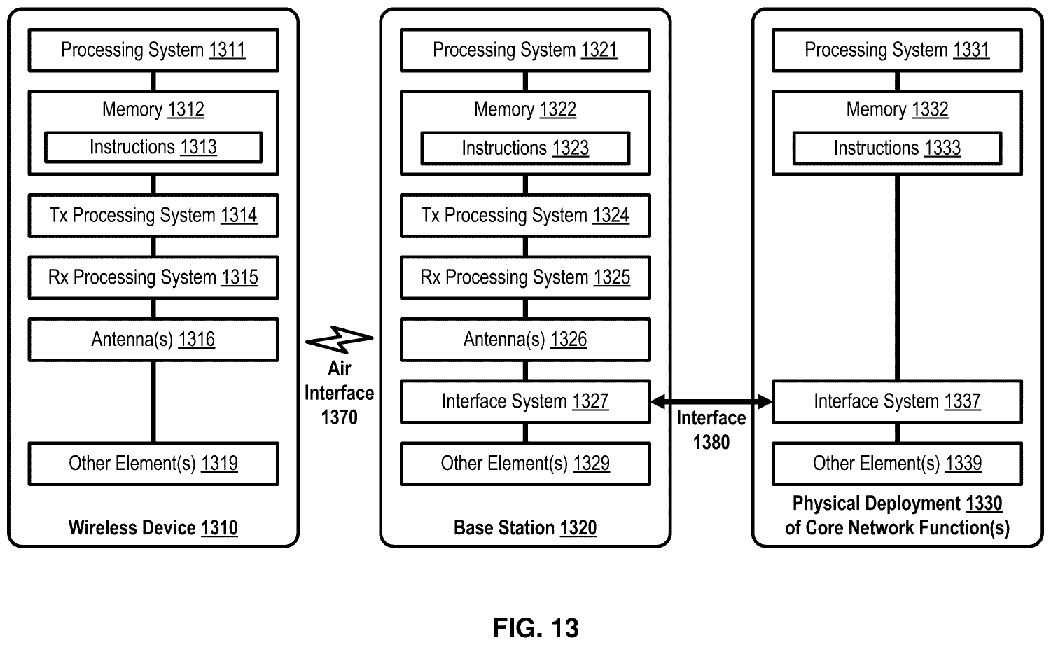

FIG. 13 illustrates examples of components of the elements in a communications network. FIG. 13 includes a wireless device 1310, a base station 1320, and a physical deployment of one or more network functions 1330 (henceforth “deployment 1330”). Any wireless device described in the present disclosure may have similar components and may be implemented in a similar manner as the wireless device 1310. Any other base station described in the present disclosure (or any portion thereof, depending on the architecture of the base station) may have similar components and may be implemented in a similar manner as the base station 1320. Any physical core network deployment in the present disclosure (or any portion thereof, depending on the architecture of the base station) may have similar components and may be implemented in a similar manner as the deployment 1330.

The wireless device 1310 may communicate with base station 1320 over an air interface 1370. The communication direction from wireless device 1310 to base station 1320 over air interface 1370 is known as uplink, and the communication direction from base station 1320 to wireless device 1310 over air interface 1370 is known as downlink. Downlink transmissions may be separated from uplink transmissions using FDD, TDD, and/or some combination of duplexing techniques. FIG. 13 shows a single wireless device 1310 and a single base station 1320, but it will be understood that wireless device 1310 may communicate with any number of base stations or other access network components over air interface 1370, and that base station 1320 may communicate with any number of wireless devices over air interface 1370.

The wireless device 1310 may comprise a processing system 1311 and a memory 1312. The memory 1312 may comprise one or more computer-readable media, for example, one or more non-transitory computer readable media. The memory 1312 may include instructions 1313. The processing system 1311 may process and/or execute instructions 1313. Processing and/or execution of instructions 1313 may cause wireless device 1310 and/or processing system 1311 to perform one or more functions or activities. The memory 1312 may include data (not shown). One of the functions or activities performed by processing system 1311 may be to store data in memory 1312 and/or retrieve previously-stored data from memory 1312. In an example, downlink data received from base station 1320 may be stored in memory 1312, and uplink data for transmission to base station 1320 may be retrieved from memory 1312. As illustrated in FIG. 13, the wireless device 1310 may communicate with base station 1320 using a transmission processing system 1314 and/or a reception processing system 1315. Alternatively, transmission processing system 1314 and reception processing system 1315 may be implemented as a single processing system, or both may be omitted and all processing in the wireless device 1310 may be performed by the processing system 1311. Although not shown in FIG. 13, transmission processing system 1314 and/or reception processing system 1315 may be coupled to a dedicated memory that is analogous to but separate from memory 1312, and comprises instructions that may be processed and/or executed to carry out one or more of their respective functionalities. The wireless device 1310 may comprise one or more antennas 1316 to access air interface 1370.

The wireless device 1310 may comprise one or more other elements 1319. The one or more other elements 1319 may comprise software and/or hardware that provide features and/or functionalities, for example, a speaker, a microphone, a keypad, a display, a touchpad, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, a global positioning sensor (GPS) and/or the like). The wireless device 1310 may receive user input data from and/or provide user output data to the one or more one or more other elements 1319. The one or more other elements 1319 may comprise a power source. The wireless device 1310 may receive power from the power source and may be configured to distribute the power to the other components in wireless device 1310. The power source may comprise one or more sources of power, for example, a battery, a solar cell, a fuel cell, or any combination thereof.

The wireless device 1310 may transmit uplink data to and/or receive downlink data from base station 1320 via air interface 1370. To perform the transmission and/or reception, one or more of the processing system 1311, transmission processing system 1314, and/or reception system 1315 may implement open systems interconnection (OSI) functionality. As an example, transmission processing system 1314 and/or reception system 1315 may perform layer 1 OSI functionality, and processing system 1311 may perform higher layer functionality. The wireless device 1310 may transmit and/or receive data over air interface 1370 using one or more antennas 1316. For scenarios where the one or more antennas 1316 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise a processing system 1321 and a memory 1322. The memory 1322 may comprise one or more computer-readable media, for example, one or more non-transitory computer readable media. The memory 1322 may include instructions 1323. The processing system 1321 may process and/or execute instructions 1323. Processing and/or execution of instructions 1323 may cause base station 1320 and/or processing system 1321 to perform one or more functions or activities. The memory 1322 may include data (not shown). One of the functions or activities performed by processing system 1321 may be to store data in memory 1322 and/or retrieve previously-stored data from memory 1322. The base station 1320 may communicate with wireless device 1310 using a transmission processing system 1324 and a reception processing system 1325. Although not shown in FIG. 13, transmission processing system 1324 and/or reception processing system 1325 may be coupled to a dedicated memory that is analogous to but separate from memory 1322, and comprises instructions that may be processed and/or executed to carry out one or more of their respective functionalities. The wireless device 1320 may comprise one or more antennas 1326 to access air interface 1370.

The base station 1320 may transmit downlink data to and/or receive uplink data from wireless device 1310 via air interface 1370. To perform the transmission and/or reception, one or more of the processing system 1321, transmission processing system 1324, and/or reception system 1325 may implement OSI functionality. As an example, transmission processing system 1324 and/or reception system 1325 may perform layer 1 OSI functionality, and processing system 1321 may perform higher layer functionality. The base station 1320 may transmit and/or receive data over air interface 1370 using one or more antennas 1326. For scenarios where the one or more antennas 1326 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise an interface system 1327. The interface system 1327 may communicate with one or more base stations and/or one or more elements of the core network via an interface 1380. The interface 1380 may be wired and/or wireless and interface system 1327 may include one or more components suitable for communicating via interface 1380. In FIG. 13, interface 1380 connects base station 1320 to a single deployment 1330, but it will be understood that wireless device 1310 may communicate with any number of base stations and/or CN deployments over interface 1380, and that deployment 1330 may communicate with any number of base stations and/or other CN deployments over interface 1380. The base station 1320 may comprise one or more other elements 1329 analogous to one or more of the one or more other elements 1319.

The deployment 1330 may comprise any number of portions of any number of instances of one or more network functions (NFs). The deployment 1330 may comprise a processing system 1331 and a memory 1332. The memory 1332 may comprise one or more computer-readable media, for example, one or more non-transitory computer readable media. The memory 1332 may include instructions 1333. The processing system 1331 may process and/or execute instructions 1333. Processing and/or execution of instructions 1333 may cause the deployment 1330 and/or processing system 1331 to perform one or more functions or activities. The memory 1332 may include data (not shown). One of the functions or activities performed by processing system 1331 may be to store data in memory 1332 and/or retrieve previously-stored data from memory 1332. The deployment 1330 may access the interface 1380 using an interface system 1337. The deployment 1330 may comprise one or more other elements 1339 analogous to one or more of the one or more other elements 1319.

One or more of the systems 1311, 1314, 1315, 1321, 1324, 1325, and/or 1331 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. One or more of the systems 1311, 1314, 1315, 1321, 1324, 1325, and/or 1331 may perform signal coding/processing, data processing, power control, input/output processing, and/or any other functionality that may enable wireless device 1310, base station 1320, and/or deployment 1330 to operate in a mobile communications system.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise computers, microcontrollers, microprocessors, DSPs, ASICs, FPGAs, and complex programmable logic devices (CPLDs). Computers, microcontrollers and microprocessors may be programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

The wireless device 1310, base station 1320, and/or deployment 1330 may implement timers and/or counters. A timer/counter may start at an initial value. As used herein, starting may comprise restarting. Once started, the timer/counter may run. Running of the timer/counter may be associated with an occurrence. When the occurrence occurs, the value of the timer/counter may change (for example, increment or decrement). The occurrence may be, for example, an exogenous event (for example, a reception of a signal, a measurement of a condition, etc.), an endogenous event (for example, a transmission of a signal, a calculation, a comparison, a performance of an action or a decision to so perform, etc.), or any combination thereof. In the case of a timer, the occurrence may be the passage of a particular amount of time. However, it will be understood that a timer may be described and/or implemented as a counter that counts the passage of a particular unit of time. A timer/counter may run in a direction of a final value until it reaches the final value. The reaching of the final value may be referred to as expiration of the timer/counter. The final value may be referred to as a threshold. A timer/counter may be paused, wherein the present value of the timer/counter is held, maintained, and/or carried over, even upon the occurrence of one or more occurrences that would otherwise cause the value of the timer/counter to change. The timer/counter may be un-paused or continued, wherein the value that was held, maintained, and/or carried over begins changing again when the one or more occurrence occur. A timer/counter may be set and/or reset. As used herein, setting may comprise resetting. When the timer/counter sets and/or resets, the value of the timer/counter may be set to the initial value. A timer/counter may be started and/or restarted. As used herein, starting may comprise restarting. In some embodiments, when the timer/counter restarts, the value of the timer/counter may be set to the initial value and the timer/counter may begin to run.

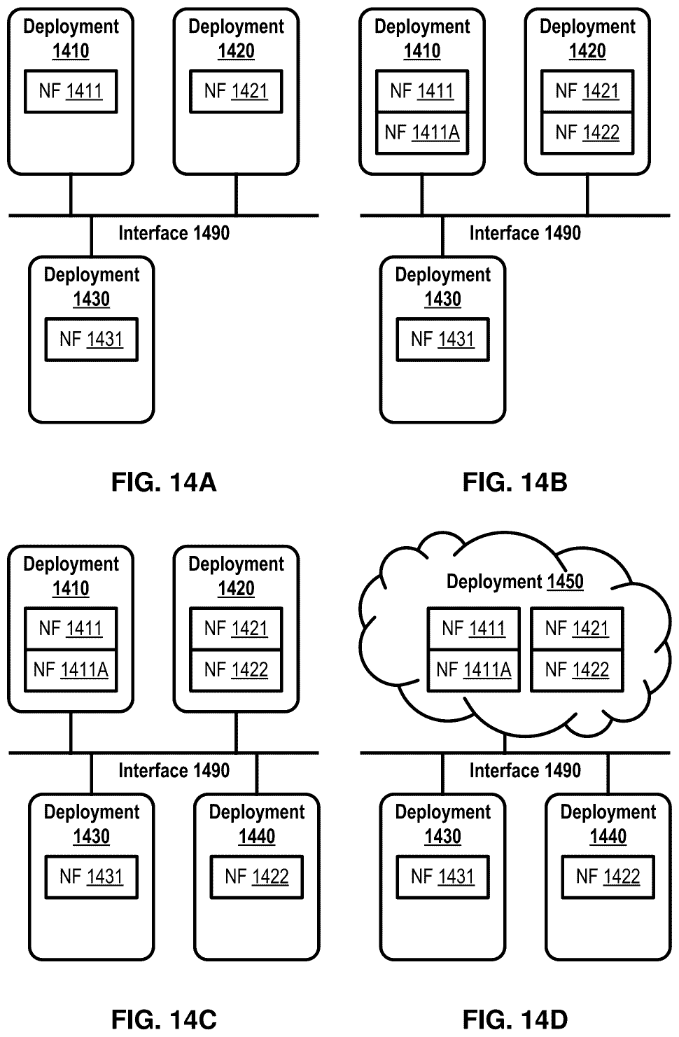

FIGS. 14A, 14B, 14C, and 14D illustrate various example arrangements of physical core network deployments, each having one or more network functions or portions thereof. The core network deployments comprise a deployment 1410, a deployment 1420, a deployment 1430, a deployment 1440, and/or a deployment 1450. Each deployment may be analogous to, for example, the deployment 1330 depicted in FIG. 13. In particular, each deployment may comprise a processing system for performing one or more functions or activities, memory for storing data and/or instructions, and an interface system for communicating with other network elements (for example, other core network deployments). Each deployment may comprise one or more network functions (NFs). The term NF may refer to a particular set of functionalities and/or one or more physical elements configured to perform those functionalities (e.g., a processing system and memory comprising instructions that, when executed by the processing system, cause the processing system to perform the functionalities). For example, in the present disclosure, when a network function is described as performing X, Y, and Z, it will be understood that this refers to the one or more physical elements configured to perform X, Y, and Z, no matter how or where the one or more physical elements are deployed. The term NF may refer to a network node, network element, and/or network device.

As will be discussed in greater detail below, there are many different types of NF and each type of NF may be associated with a different set of functionalities. A plurality of different NFs may be flexibly deployed at different locations (for example, in different physical core network deployments) or in a same location (for example, co-located in a same deployment). A single NF may be flexibly deployed at different locations (implemented using different physical core network deployments) or in a same location. Moreover, physical core network deployments may also implement one or more base stations, application functions (AFs), data networks (DNs), or any portions thereof. NFs may be implemented in many ways, including as network elements on dedicated or shared hardware, as software instances running on dedicated or shared hardware, or as virtualized functions instantiated on a platform (e.g., a cloud-based platform).

FIG. 14A illustrates an example arrangement of core network deployments in which each deployment comprises one network function. A deployment 1410 comprises an NF 1411, a deployment 1420 comprises an NF 1421, and a deployment 1430 comprises an NF 1431. The deployments 1410, 1420, 1430 communicate via an interface 1490. The deployments 1410, 1420, 1430 may have different physical locations with different signal propagation delays relative to other network elements. The diversity of physical locations of deployments 1410, 1420, 1430 may enable provision of services to a wide area with improved speed, coverage, security, and/or efficiency.

FIG. 14B illustrates an example arrangement wherein a single deployment comprises more than one NF. Unlike FIG. 14A, where each NF is deployed in a separate deployment, FIG. 14B illustrates multiple NFs in deployments 1410, 1420. In an example, deployments 1410, 1420 may implement a software-defined network (SDN) and/or a network function virtualization (NFV).

For example, deployment 1410 comprises an additional network function, NF 1411A. The NFs 1411, 1411A may consist of multiple instances of the same NF type, co-located at a same physical location within the same deployment 1410. The NFs 1411, 1411A may be implemented independently from one another (e.g., isolated and/or independently controlled). For example, the NFs 1411, 1411A may be associated with different network slices. A processing system and memory associated with the deployment 1410 may perform all of the functionalities associated with the NF 1411 in addition to all of the functionalities associated with the NF 1411A. In an example, NFs 1411, 1411A may be associated with different PLMNs, but deployment 1410, which implements NFs 1411, 1411A, may be owned and/or operated by a single entity.

Elsewhere in FIG. 14B, deployment 1420 comprises NF 1421 and an additional network function, NF 1422. The NFs 1421, 1422 may be different NF types. Similar to NFs 1411, 1411A, the NFs 1421, 1422 may be co-located within the same deployment 1420, but separately implemented. As an example, a first PLMN may own and/or operate deployment 1420 having NFs 1421, 1422. As another example, the first PLMN may implement NF 1421 and a second PLMN may obtain from the first PLMN (e.g., rent, lease, procure, etc.) at least a portion of the capabilities of deployment 1420 (e.g., processing power, data storage, etc.) in order to implement NF 1422. As yet another example, the deployment may be owned and/or operated by one or more third parties, and the first PLMN and/or second PLMN may procure respective portions of the capabilities of the deployment 1420. When multiple NFs are provided at a single deployment, networks may operate with greater speed, coverage, security, and/or efficiency.

FIG. 14C illustrates an example arrangement of core network deployments in which a single instance of an NF is implemented using a plurality of different deployments. In particular, a single instance of NF 1422 is implemented at deployments 1420, 1440. As an example, the functionality provided by NF 1422 may be implemented as a bundle or sequence of subservices. Each subservice may be implemented independently, for example, at a different deployment. Each subservices may be implemented in a different physical location. By distributing implementation of subservices of a single NF across different physical locations, the mobile communications network may operate with greater speed, coverage, security, and/or efficiency.

FIG. 14D illustrates an example arrangement of core network deployments in which one or more network functions are implemented using a data processing service. In FIG. 14D, NFs 1411, 1411A, 1421, 1422 are included in a deployment 1450 that is implemented as a data processing service. The deployment 1450 may comprise, for example, a cloud network and/or data center. The deployment 1450 may be owned and/or operated by a PLMN or by a non-PLMN third party. The NFs 1411, 1411A, 1421, 1422 that are implemented using the deployment 1450 may belong to the same PLMN or to different PLMNs. The PLMN(s) may obtain (e.g., rent, lease, procure, etc.) at least a portion of the capabilities of the deployment 1450 (e.g., processing power, data storage, etc.). By providing one or more NFs using a data processing service, the mobile communications network may operate with greater speed, coverage, security, and/or efficiency.

As shown in the figures, different network elements (e.g., NFs) may be located in different physical deployments, or co-located in a single physical deployment. It will be understood that in the present disclosure, the sending and receiving of messages among different network elements is not limited to inter-deployment transmission or intra-deployment transmission, unless explicitly indicated.

In an example, a deployment may be a ‘black box’ that is preconfigured with one or more NFs and preconfigured to communicate, in a prescribed manner, with other ‘black box’ deployments (e.g., via the interface 1490). Additionally or alternatively, a deployment may be configured to operate in accordance with open-source instructions (e.g., software) designed to implement NFs and communicate with other deployments in a transparent manner. The deployment may operate in accordance with open RAN (O-RAN) standards.

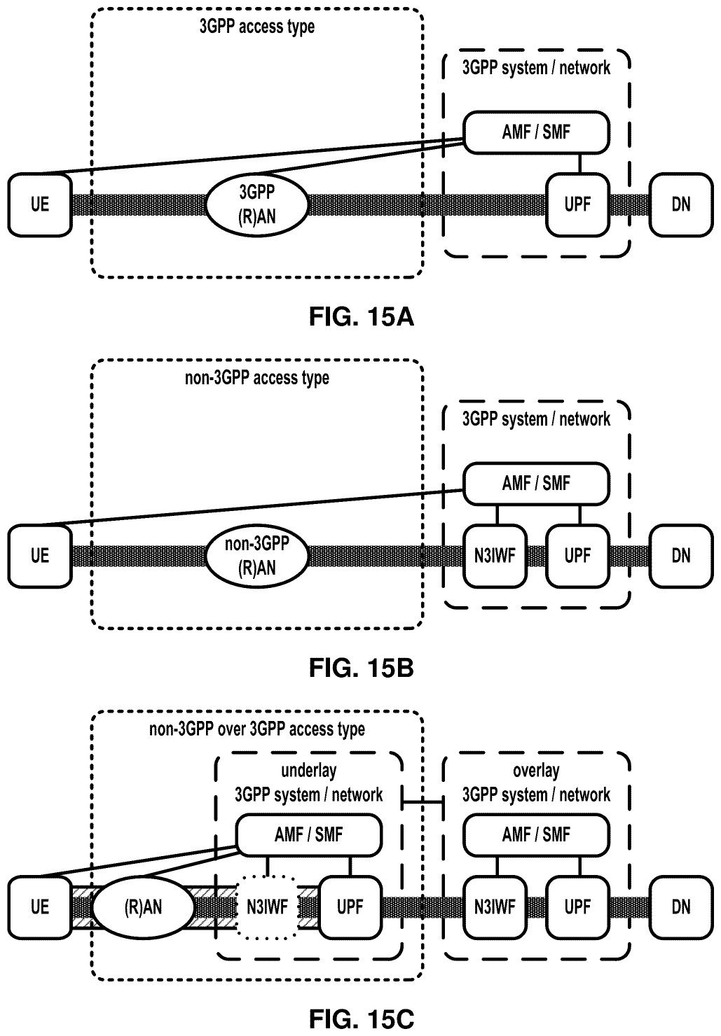

In an example embodiment as depicted in FIG. 15A, FIG. 15B and FIG. 15C, a UE may access a network via different access types. The UE may access the network via a 3GPP access type as in FIG. 15A. A 3GPP access type may comprise GRAN: GSM radio access network (GRAN), EDGE packet radio services with GRAN (GERAN), UMTS radio access network (UTRAN), E-UTRAN: The Long Term Evolution (LTE) high speed and low latency radio access network, New Radio (NR), 5G NR, and/or the like.

In an example, as depicted in FIG. 15B, a non-3GPP (N3GPP) access type may be employed. Examples of N3GPP access type may comprise trusted or untrusted WiFi access, IEEE based access, wireline access, fixed access, WiMAX, and/or the like. In an example, N31WF—Non-3GPP Interworking Function may be employed for access of a UE to the network via N3GPP access. The N3IWF may be employed for interworking between untrusted non-3GPP networks and the 5G Core. As such, the N3IWF may support both N2 and N3 based connectivity to the core, whilst supporting IPSec connectivity towards the UE.

In an example embodiment as depicted in FIG. 15C, the UE may access the network (e.g., a PLMN, SNPN/NPN, etc.) via another network (referred to as an underlay network e.g., a PLMN, SNPN/NPN, and/or the like) such as a 3GPP network/system. Access of the UE to the network via an underlay network may be referred to as an extended access type, an auxiliary access type, an underlay network access type, an intermediate access type, and/or the like. In an example, the extended access type may refer to access of the UE to an overlay network (or a first network) via a 3GPP access of an underlay network (a second network). In an example, the extended access type may refer to access of the UE to the overlay network (or the first network) via a N3GPP access of the underlay network (the second network). For example, the UE may access a network via 3GPP access or via non-3GPP access.

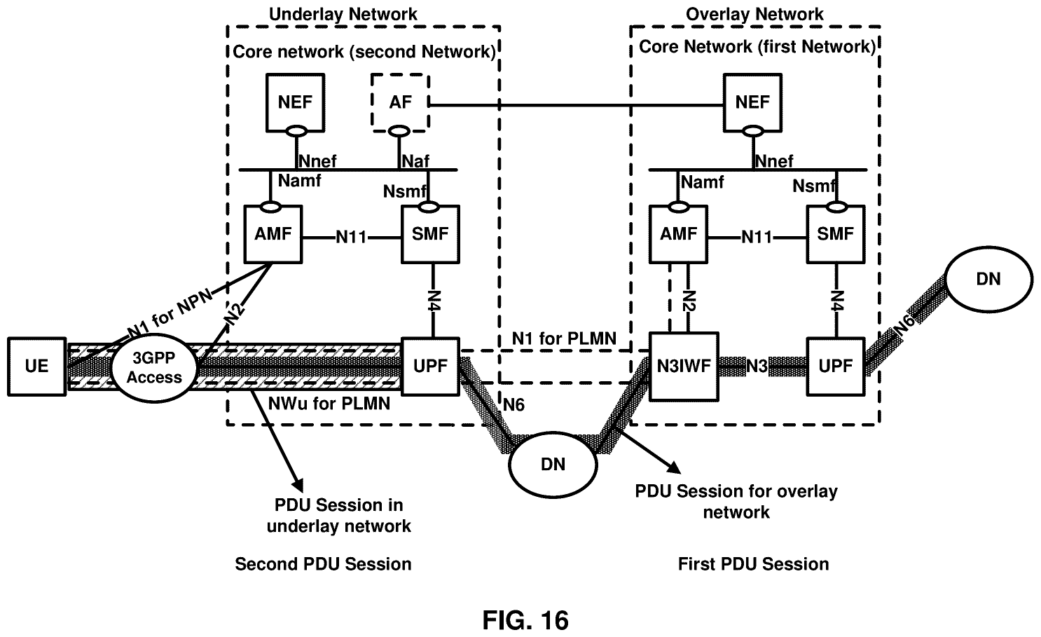

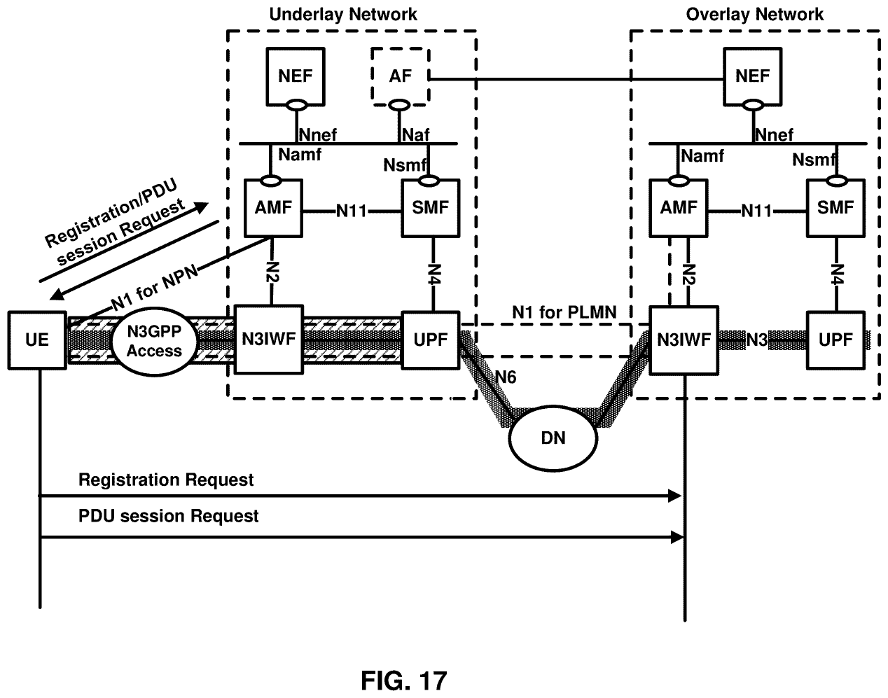

FIGS. 16-17 illustrate detailed examples of the access type depicted in FIG. 15C, which may be known by the name ‘non-3GPP over 3GPP’ access type, or any other suitable name.

In an example as depicted in FIG. 16, the UE may access an underlay network via the 3GPP access in order to access an overlay network via non-3GPP interworking function of the overlay network.

As depicted in FIG. 17, the UE may access a network via the non-3GPP access of the underlay network in order to access an overlay network via non-3GPP interworking function of the overlay network. In an example, the extended access type may be a third access type such as underlay access, non-3GPP access over(via) 3GPP access, IPsec access over 3GPP access, and/or the like. In an example, an extended access type indication may be an indication that a UE may access a network via an underlay network. In an example, an extended access type indication may be an indication that an overlay network may be involved. The extended access type indication may comprise an indication that the UE may employ configuration parameters from at least one of a first network (overlay network) and a second network (underlay network). The configuration parameters may comprise UE route selection policy URSP, TAI, registration area, mobility restrictions, and/or the like.

In an example embodiment, the extended access type or extended access type indication may be via a 3GPP access or a N3GPP access of the underlay network.

MA-PDUIn an example embodiments as depicted in FIG. 16 and FIG. 17, a UE may access to a first network (overlay network) services via a second network (e.g., non-public network, PLMN, underlay network). The UE may first obtain IP connectivity by registering with the underlay network. Then the UE may obtain connectivity to the 5GC in the overlay network via an interworking function (e.g., a proxy, N3|WF, and/or the like). The underlay network may deploy a 3GPP RAT (as in FIG. 16), N3GPP RAT (as in FIG. 17), and/or the like.

5GS may support multi access packet data unit PDU sessions (MA-PDU sessions). MA-PDU sessions may simultaneously employ different access types such as 3GPP access types with radio access technology (RAT) types such as NG-RAN, new radio NR, E-UTRA, and/or the like, and/or non-3GPP access type with RAT type or AN type such as WLAN, NB-IoT, E-UTRA, NR, and/or the like. In an example, an NG-RAN node may be a gNB, providing NR user plane and control plane protocol terminations towards a wireless device (UE) and/or, an ng-eNB, providing E-UTRA user plane and control plane protocol terminations towards the UE. Access traffic steering, switching and splitting ATSSS may enable steering, switching and split of data traffic among accesses associated with an MA-PDU session. The feature may provide enhanced continuity, efficient bandwidth usage and aggregation, improved performance, improved reliability, load balancing, and/or the like.

MA-PDUMA-PDUMA-PDUMA-PDUMA-PDUMA-PDUMA-PDUMA-PDUIn an example the MA-PDU session feature may be employed for management of applications. In an example, an MA-PDU session may be employed to steer, split, switch traffic for application signalling and application data (e.g., media files). In an example, application signalling may be transmitted via a first child session associated to a first access network and user data (e.g., media traffic) may be transmitted via a second child session associated with a second access network.

In an example, an MA-PDU session may be employed for a case where a first child session of an MA-PDU session may employ control plane data transmission (e.g., CIoT data transmission, CIoT control plane optimization, and/or the like) and a second child session the MA-PDU session may employ user plane resources and/or employ user plane optimization (e.g., CIoT user plane optimization, and/or the like.)

In an example embodiment, access traffic steering, switching and splitting may be employed by the 5GS. In an example, access traffic steering may be a procedure that may select one or more access network(s) for a new data flow and may transfer the traffic of the data flow over the selected one or more access network(s). Access traffic steering may be applicable between 3GPP and non-3GPP accesses, and/or among different radio access technologies (RAT). In an example, access traffic switching may be a procedure that moves traffic of an ongoing data flow from one access network to another access network in a way that may maintain continuity of the data flow. In an example, access traffic switching may be applicable between 3GPP and non-3GPP accesses and/or among different RATs. In an example, access traffic splitting may be a procedure that may split the traffic of a data flow across multiple access networks. When traffic splitting is applied to a data flow, some traffic of the data flow may be transferred via one access and some other traffic of the same data flow may be transferred via another access. Access traffic splitting may be applicable between 3GPP and non-3GPP accesses and/or among different RATs.

In an example, a multi access PDU session (MA-PDU session) may be a PDU session whose traffic may be sent over 3GPP access, or over non-3GPP access, or over both accesses and/or over one or more RATs.

In an example embodiment, an MA-PDU session may be identified by a MA-PDU session ID, a PDU session ID, an MA-PDU capability flag, access information, and/or the like. In an example, access information may comprise access type (e.g., 3GPP access, non-3GPP access, and/or the like), RAT information (e.g., E-UTRA, NR, WLAN, NB-IoT, cell identifier, access identifier, and/or the like). In an example, access information may be network instance, or an information element indicating access type, RAT, access point identifier, access network identifier, cell identifier, tunneling information, and/or the like. In an example embodiment, an access of the MA-PDU session may refer to an access leg, a child session, and/or the like.

In an example embodiment, different steering modes may be applied for a MA-PDU session. The steering modes may be applied in a MA-PDU session by enforcing an appropriate ATSSS policy for the MA-PDU session. For example, during the establishment of an MA-PDU session, the PCF in the network may create the ATSSS policy for the MA-PDU, which may be transferred to the UE for uplink traffic steering and to a UPF for downlink traffic steering. The ATSSS policy may include a prioritized list of ATSSS rules and each ATSSS rule may include a steering mode that may be applied to the traffic matching this rule.

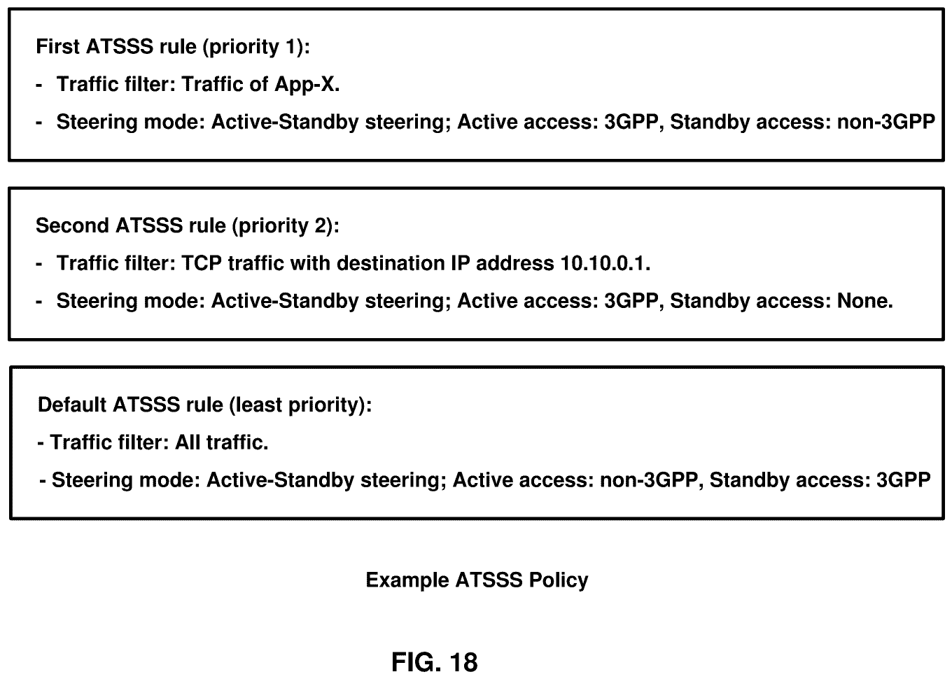

FIG. 18 depicts an example of an ATSSS policy. In FIG. 18, the first ATSSS rule may steer traffic of a first application (App-X). The ATSSS rule may steer traffic of App-X to 3GPP access, if 3GPP access is available; or to non-3GPP access, if 3GPP access is not available. The ATSSS rules may treat (steer, split, etc.) user datagram protocol (UDP) and transport control protocol (TCP) differently. For example, the second ATSSS rule may steer the TCP traffic (traffic that use transport control protocol) with destination IP address 10.10.0.1 to 3GPP access only. Since no standby access is defined, this traffic may not be transferred over non-3GPP access, even when the 3GPP access becomes unavailable. The default ATSSS rule may steer the rest of the traffic (that do not have a designated rule) to non-3GPP, if available; if not available, it may be steered to 3GPP access.

In an example embodiment, different steering modes may be applied. In an example, an active-standby steering may be employed. In active-standby steering, all (or some of) the traffic of the MA-PDU session may be sent to one access only, which is called the active access. The other access may serve as a standby access and may take traffic when the active access becomes unavailable. When the active access becomes available, the traffic may be transferred to the active access. The active access may be defined when the MA-PDU session is established and may remain the same during the lifetime of the MA-PDU session or may change during the lifetime of the MA-PDU session.

In an example embodiment, a priority-based steering may be employed. The two accesses may be assigned a priority, e.g. during the establishment of the MA-PDU session. All traffic (or some) of the MA-PDU session may be sent to the high priority access. When congestion arises on the high priority access, new data flows (e.g., the overflow traffic) may be sent to the low priority access. When the high priority access becomes unavailable, traffic may be switched to the low priority access. It may be possible to change the priorities of the accesses during the lifetime of the MA-PDU session.

In an example embodiment, best-access steering method may be employed. The high priority access may be the one that may provide the best performance, e.g. the one with the smallest round trip time (RTT). In this case, the high priority access may not be pre-defined (as in Priority-based steering) but it may be estimated and may change.

In an example embodiment, in redundant steering mode all (or some) data flows may be transmitted on both accesses.

In an example embodiment, in load-balance steering mode, each access may receive a percentage of the data flows transmitted via the MA-PDU session. Each access may be assigned a weight factor (e.g. 50%, 80%, and/or the like) and may receive a percentage of the MA-PDU session traffic corresponding to this factor. As an example, in a 50/50 (50%) load-balancing, the overall traffic of the MA-PDU session is equally split across the two accesses. In an 80/20 load-balancing, about 80% of the overall traffic may be sent on one access and 20% on the other access.

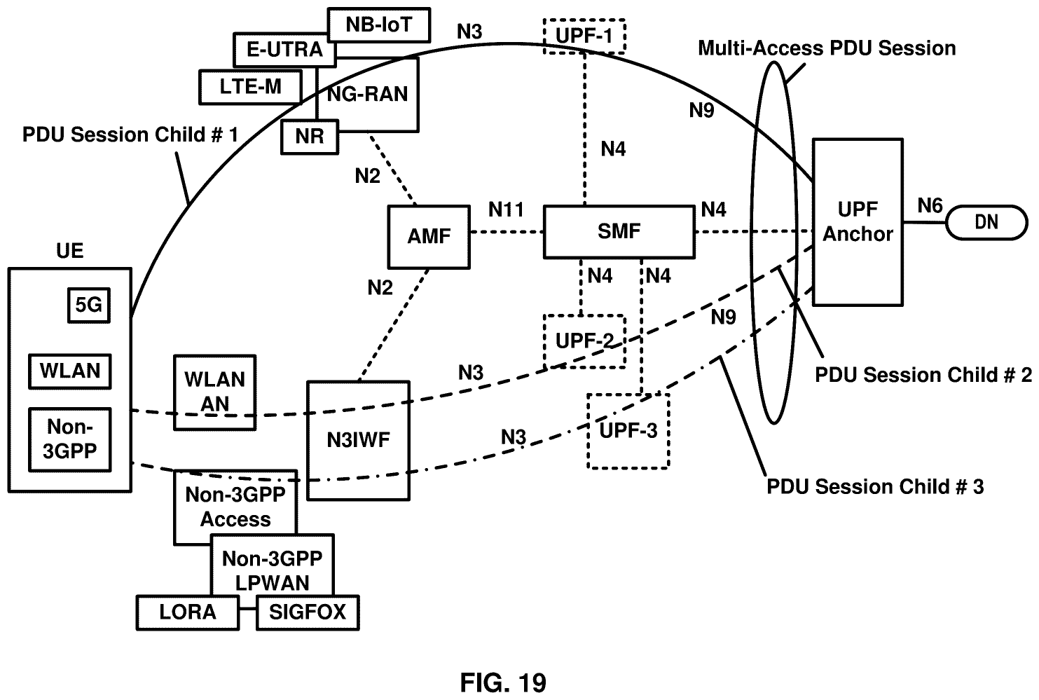

An example FIG. 19 depicts a MA-PDU session comprising three accesses e.g., child sessions, access legs, (e.g., sub-PDU sessions, child PDU sessions). An MA-PDU session may be created by bundling together two or more separate PDU sessions, which may be established over different accesses or RATs. An MA-PDU session may comprise one, two or more PDU sessions (or sub-PDU sessions), referred to as child PDU sessions; some established over 3GPP access and the others established over untrusted non-3GPP access (e.g. a WLAN AN).

The child PDU sessions of a MA-PDU session may share a common DNN, a common UPF anchor (UPF-A), a common PDU type (e.g. IPv6), a common IP address(es), a common SSC mode, a common S-NSSAI and/or the like. An MA-PDU session may be deployed via a multi-path data link between a UE and an anchor UPF-A, as depicted in FIG. 19.

In an example, an MA-PDU session may be established with separate PDU session establishment procedures; one of each child PDU session, e.g., separate establishment.

In an example, an MA-PDU session may be established with a single MA-PDU session establishment procedure, where the child PDU sessions may be established in parallel, e.g., combined establishment.

In an example, a UE may determine to establish a MA-PDU session based on configured policy in the UE that may indicate whether multi-access is preferred when a PDU session is triggered;

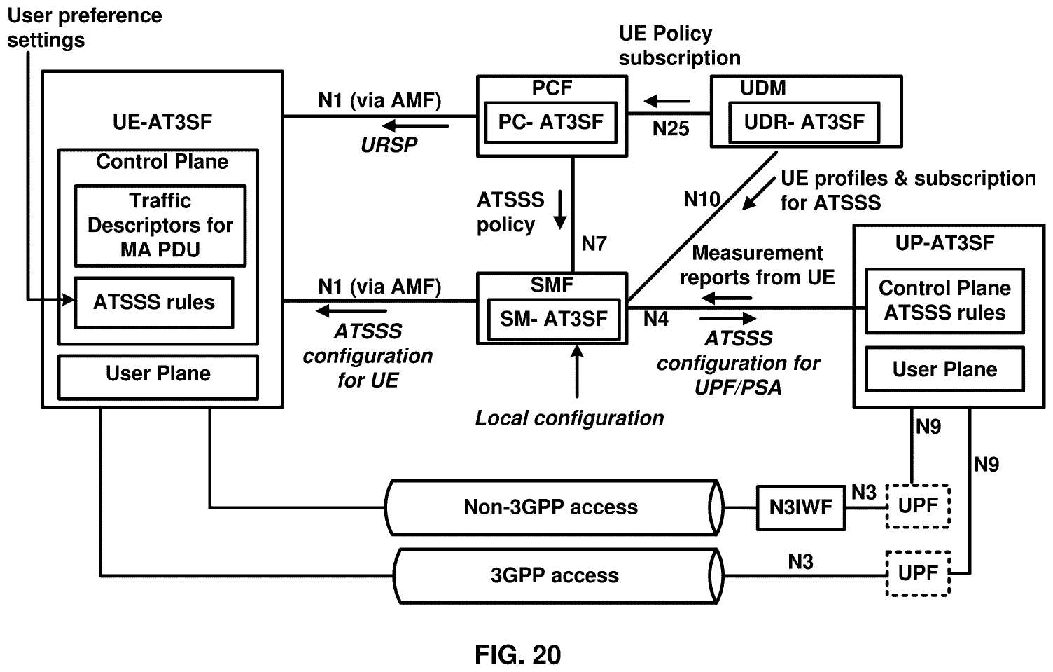

In an example embodiment as depicted in FIG. 20, a wireless device may be capable of ATSSS, or ATSSS-LL (ATSSS low layer). In an example, ATSSS rules and policy may be implemented in the UE, and the network elements such as user plane network elements or control plane network elements.

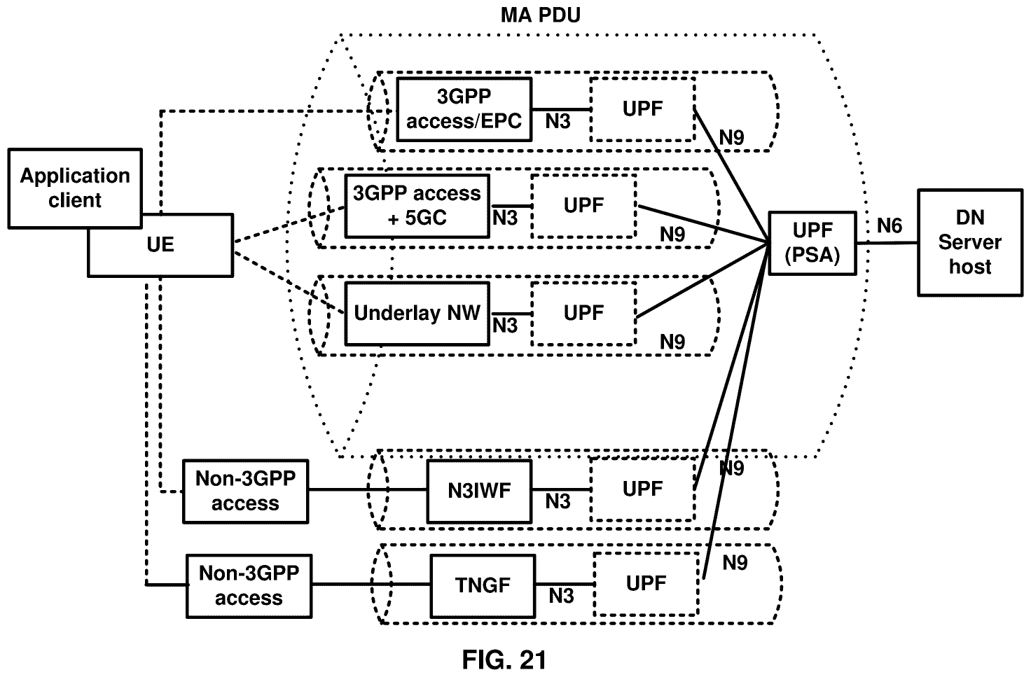

In an example as depicted in FIG. 21, a MA-PDU session may comprise one or more accesses that may be referred to access legs, child sessions, sub-sessions, and/or the like. In an example, the UE may establish the MA-PDU session to access the network simultaneously via one or more accesses or steer/switch between accesses or access via one access of the MA-PDU session at a time. In an example, accesses of the MA-PDU session may be 3GPP access, N3GPP access, or underlay access. In an example, the UE may access via one or more N3GPP accesses, one or more 3GPP accesses, one or more underlay accesses.

In an example embodiment, measurement assistance information (MAI) may be transmitted by the network to the UE. If the UE is capable of supporting MA-PDU session, and ATSSS (e.g., using multipath TCP (MPTCP) functionality) with any steering mode, the network may send measurement assistance information for the UE to send access availability/unavailability to the UPF.

The measurement assistance information MAI may comprise:
a) addressing for the performance measurement function (PMF) in the UPF according to:
1) if the PDU session is IP type, the measurement assistance information contains IP address for the PMF with an allocated port number associated with the 3GPP access network and another allocated port number associated with non-3GPP access network; and
2) if the PDU session is Ethernet type, the measurement assistance information contains a MAC address associated with the 3GPP access network and another MAC address associated with the non-3GPP address network for the PMF; and
b) an indicator to report the availability and unavailability of an access network.

The measurement assistance information contains addressing information for the PMF in the UPF and is encoded as shown below:

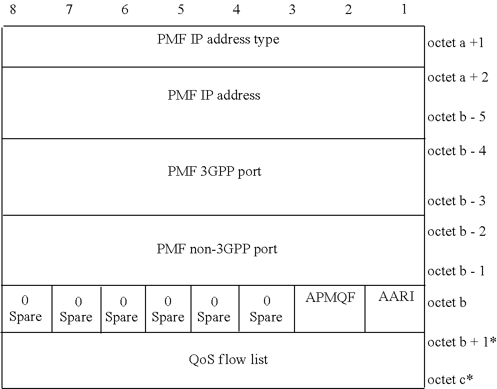

### PMF IP Address Type

PMF IP address type (octet a + 1) is set as follows:
Bits

| 8 | 7 | 6 | 5 | 4 | 3 | 2 | 1 | |
|---|---|---|---|---|---|---|---|---|
| 0 | 0 | 0 | 0 | 0 | 0 | 0 | 1 | IPv4 |
| 0 | 0 | 0 | 0 | 0 | 0 | 1 | 0 | IPv6 |
| 0 | 0 | 0 | 0 | 0 | 0 | 1 | 1 | IPv4IPv6 |

AARI (access availability reporting indicator)
(octet b, bit 1) is set as follows:

| Bit | |
|---|---|
| 1 | |
| 0 | Do not report the access availability |
| 1 | Report the access availability |

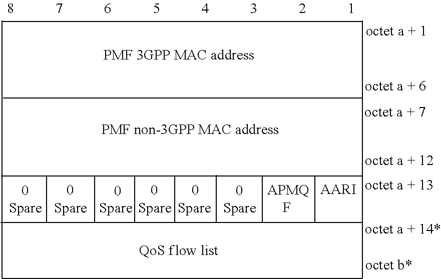

### ATSSS Parameter Contents Including One PMF MAC Address Information

### PMF MAC Address Type

PMF 3GPP MAC address contains a 6 octet MAC address
associated with the 3GPP access network and is dedicated
for the QoS flow of the default QoS flow.
PMF non-3GPP MAC address contains a 6 octet MAC
address associated with the non-3GPP access network and is
dedicated for the QoS flow of the default QoS flow.
AARI (access availability reporting indicator)
(octet a + 13, bit 1) is set as follows:

| Bit | |
|---|---|
| 1 | |
| 0 | Do not report the access |
| | availability |
| 1 | Report the access availability |

APMQF (access performance measurements per QoS flow
indicator) (octet a + 13, bit 2) is and set as follows:

| Bit | |
|---|---|
| 1 | |
| 0 | Perform access performance measurements using |
| | default QoS rule. |
| 1 | Perform access performance measurements using |
| | non-default QoS rule. |

In an example embodiment, even if AARI is set to do not report the access availability during the MA-PDU session establishment procedure, the UE may still need to perform access availability or unavailability report procedure over an access after the MA-PDU session is established to enable the UPF to determine the UDP port of the PMF in the UE or the UDP port and the IPv6 address of the PMF in the UE.

In an example, ATSSS request PCO parameter may be employed in some procedures. The purpose of the ATSSS request PCO parameter is to provide UE parameters for MA-PDU session management. The ATSSS request PCO parameter container contents may be one or more octets long.

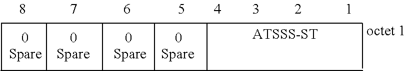

### ATSSS Request PCO Parameter Container Contents

### ATSSS Request PCO Parameter Container Contents

Supported ATSSS steering functionalities and steering modes
(ATSSS-ST) (octet 1, bits 1, 2, 3 and 4) (see NOTE)
This field indicates the 5GSM capability of ATSSS
steering functionalities and steering modes.

| Bits | | | | |
|---|---|---|---|---|
| 4 | 3 | 2 | 1 | |
| 0 | 0 | 0 | 1 | ATSSS Low-Layer functionality with any steering |
| | | | | mode supported |
| 0 | 0 | 1 | 0 | MPTCP functionality with any steering mode and |
| | | | | ATSSS-LL functionality with only active-standby |
| | | | | steering mode supported |
| 0 | 0 | 1 | 1 | MPTCP functionality with any steering mode and |
| | | | | ATSSS-LL functionality with any steering mode |
| | | | | supported |

All other values are reserved.
All other bits in octet 1 are spare and shall be coded as zero.
NOTE:
If the ATSSS request PCO parameter is included in the PDN CONNECTIVITY REQUEST message with the request type information element set to “handover”, the ATSSS-ST field is ignored.

In an example, PMFP echo request may be employed in a procedure. The PMFP ECHO REQUEST message may be sent by the UE to the UPF or by the UPF to the UE to initiate detection of RTT.

| | | | Pres- | For- | |
|---|---|---|---|---|---|
| IEI | Information Element | Type/Reference | ence | mat | Length |
| | PMFP echo request | Message type | M | V | 1 |
| | message identity | | | | |
| | EPTI | Extended procedure | M | V | 2 |
| | | transaction identity | | | |
| | RI | Request identity | M | V | 1 |
| 70 | Padding | Padding | O | TLV-E | 3-1000 |

In an example, the PMFP ECHO RESPONSE message may be sent by the UPF to the UE or by the UE to the UPF as response to an PMFP ECHO REQUEST message to enable detection of RTT.

### PMFP ECHO RESPONSE Message Content

| | | | Pres- | For- | |
|---|---|---|---|---|---|
| IEI | Information Element | Type/Reference | ence | mat | Length |
| | PMFP echo | Message type | M | V | 1 |
| | response message | | | | |
| | identity | | | | |
| | EPTI | Extended procedure | M | V | 2 |
| | | transaction identity | | | |
| | RI | Request identity | M | V | 1 |
| 70 | Padding | Padding | O | TLV-E | 3-1000 |

In an example, PMFP ACCESS REPORT message may be sent by the UE to the UPF to inform the UPF about access availability or unavailability.

### PMFP ACCESS REPORT Message Content

| | | | Pres- | For- | |
|---|---|---|---|---|---|
| IEI | Information Element | Type/Reference | ence | mat | Length |
| | PMFP access report | Message type | M | V | 1 |
| | message identity | | | | |
| | EPTI | Extended procedure | M | V | 2 |
| | | transaction identity | | | |
| | Access availability | Access availability | M | V | ½ |
| | state | state | | | |
| | Spare half octet | Spare half octet | M | V | ½ |

In an example, the PMFP ACKNOWLEDGEMENT message may be sent by the UPF to the UE to acknowledge reception of a PMFP ACCESS REPORT message.

### PMFP ACKNOWLEDGEMENT Message Content

| | | | Pres- | For- | |
|---|---|---|---|---|---|
| IEI | Information Element | Type/Reference | ence | mat | Length |
| | PMFP | Message type | M | V | 1 |
| | acknowledgement | | | | |
| | message identity | | | | |
| | EPTI | Extended procedure | M | V | 2 |
| | | transaction identity | | | |

In an example, The PMFP PLR COUNT REQUEST message may be sent by the UE or the UPF to initiate a PMFP PLR measurement procedure.

### PMFP PLR COUNT REQUEST Message Content

| | | | Pres- | For- | |
|---|---|---|---|---|---|
| IEI | Information Element | Type/Reference | ence | mat | Length |
| | PMFP PLR count | Message type | M | V | 1 |
| | request | | | | |
| | message identity | | | | |
| | EPTI | Extended procedure | M | V | 2 |
| | | transaction identity | | | |

In an example, the PMFP PLR COUNT RESPONSE message may be sent by the UE or the UPF to the UE to acknowledge reception of a PMFP PLR COUNT REQUEST message.

### PMFP PLR COUNT RESPONSE Message Content

| | | | Pres- | For- | |
|---|---|---|---|---|---|
| IEI | Information Element | Type/Reference | ence | mat | Length |
| | PMFP PLR count | Message type | M | V | 1 |
| | response | | | | |
| | message identity | | | | |
| | EPTI | Extended procedure | M | V | 2 |
| | | transaction identity | | | |

In an example, the PMFP PLR REPORT REQUEST message may be sent by either UE or UPF to request the report of the counting result.

### PMFP PLR REPORT REQUEST Message Content

| | | | Pres- | For- | |
|---|---|---|---|---|---|
| IEI | Information Element | Type/Reference | ence | mat | Length |
| | PMFP PLR report | Message type | M | V | 1 |
| | request | | | | |
| | message identity | | | | |
| | EPTI | Extended procedure | M | V | 2 |
| | | transaction identity | | | |
| | Additional request | Additional request | O | TV | 1 |

In an example, the PMFP PLR REPORT RESPONSE message may be sent by either UE or the UPF to respond the PMFP PLR REPORT REQUEST message and report the counting result.

### PMFP PLR REPORT RESPONSE Message Content

| | | | Pres- | For- | |
|---|---|---|---|---|---|
| IEI | Information Element | Type/Reference | ence | mat | Length |
| | PMFP PLR report | Message type | M | V | 1 |
| | response | | | | |
| | message identity | | | | |
| | EPTI | Extended procedure | M | V | 2 |
| | | transaction identity | | | |
| | Counting result | Counting result | M | V | 4 |
| | Additional request | Additional request | O | TV | 1 |

In an example, the purpose of the access availability state information element is to provide information about availability of access.

The access availability state information element is coded as shown below:

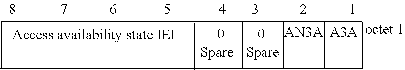

### Access Availability State Information Element

### Access Availability State Information Element

Availability over 3GPP access (A3A) (octet 1, bit 1)

| Bit | |
|---|---|
| 1 | |
| 0 | 3GPP access not available |
| 1 | 3GPP access available |

Availability over non-3GPP access (AN3A) (octet 1, bit 2)

| Bit | |
|---|---|
| 2 | |
| 0 | non-3GPP access not available |
| 1 | non-3GPP access available |

In an example embodiment, performance measurement function protocol (PMFP) procedures may be performed between a performance measurement function (PMF) in a UE and a PMF in the UPF. The following UE-initiated PMFP procedures may be implemented:
a) UE-initiated round trip time (RTT) measurement procedure; and
b) access availability or unavailability report procedure;
c) UE-initiated packet loss ratio (PLR) measurement procedure; and
d) UE assistance data provisioning procedure.

The following UPF-initiated PMFP procedures are specified:
a) UPF-initiated RTT measurement procedure; and
b) UPF-initiated PLR measurement procedure.

In an example, the UE-initiated PMFP procedures and the UPF-initiated PMFP procedures may be performed in an MA-PDU session when measurement assistance information (MAI) is provided to the UE during establishment of the MA-PDU session. PMFP messages may be transported in an IP packet or an Ethernet frame. If the UE supports performance measurement function protocol procedures for the QoS flow of a non-default QoS rule, the UE indicates its “access performance measurements per QoS flow” capability to the SMF. If the SMF determines that PMFP using the QoS flow of the non-default QoS rule is applied to the MA-PDU session for the UE, the SMF provides the UE with the MAI including a list of QoS flows over which access performance measurements may be performed. The UE may perform the RTT measurement procedure or the PLR measurement procedure over the QoS flow(s) as indicated in the received MAI.

In an example, if the UPF receives the indication from the SMF that the performance measurement is for QoS flow(s) of the non-default QoS rule, the UPF performs the RTT measurement procedure or the PLR measurement procedure over the QoS flow(s) of non-default QoS rule as indicated by the SMF. Otherwise, the UPF performs the RTT measurement procedure or the PLR measurement procedure over the QoS flow of the default QoS rule.

PMFP messages transported between the UE and the UPF (and vice versa) may be protected using the security mechanisms protecting the user data packets transported over NG-RAN or non-3GPP access connected to the 5GCN and over the N3 and N9 reference points.

In an example, the access availability or unavailability report procedure may be performed over the QoS flow of the default QoS rule.

In an example, in order to send a PMFP message over an access of an MA-PDU session of IPv4, IPv6 or IPv4v6 PDU session type:
a) if the UE obtained IPv4 address for the PDU session and the received measurement assistance information contains an IPv4 address of the PMF in the UPF, the UE may create a UDP/IPv4 packet. In the UDP/IPv4 packet, the UE:
1) may set the data octets field to the PMFP message;
2) may set the source port field to the UDP port of the PMF in the UE;
3) may set the destination port field to the UDP port of the PMF in the UPF associated with the access of the MA-PDU session, included in the received measurement assistance information;
4) may set the source address field to the IPv4 address of the UE; and
5) may set the destination address field to the IPv4 address of the PMF in the UPF, included in the received measurement assistance information; or
b) if the UE obtained IPv6 prefix for the PDU session, generated an IPv6 address for the PMF in the UE and the received measurement assistance information contains an IPv6 address of the PMF in the UPF, the UE may create a UDP/IPv6 packet. In the UDP/IPv6 packet, the UE:
1) may set the data octets field to the PMFP message;
2) may set the source port field to the UDP port of the PMF in the UE;
3) may set the destination port field to the UDP port of the PMF in the UPF associated with the access of the MA-PDU session, included in the received measurement assistance information;
4) may set the source address field to the IPv6 address of the PMF in the UE; and
5) may set the destination address field to the IPv6 address of the PMF in the UPF, included in the received measurement assistance information.

In an example, the UE may send the UDP/IPv4 packet or UDP/IPv6 packet over the access of the MA-PDU session. In order to send a PMFP message over an access of an MA-PDU session of IPv4, IPv6 or IPv4v6 PDU session type:
a) if the UPF is aware of the UDP port of the PMF in the UE used with IPv4, the UPF may create a UDP/IPv4 packet. In the UDP/IPv4 packet, the UPF:
1) may set the data octets field to the PMFP message;
2) may set the source port field to the UDP port of the PMF in the UPF associated with the access of the MA-PDU session, included in the measurement assistance information provided to the UE;
3) may set the destination port field to the UDP port of the PMF in the UE used with IPv4;
4) may set the source address field to the IPv4 address of the PMF in the UPF, included in the measurement assistance information provided to the UE; and
5) may set the destination address field to the IPv4 address of the UE; or
a) if the UPF is aware of the UDP port and the IPv6 address of the PMF in the UE, the UPF may create a UDP/IPv6 packet. In the UDP/IPv6 packet, the UPF:
1) may set the data octets field to the PMFP message;
2) may set the source port field to the UDP port of the PMF in the UPF associated with the access of the MA-PDU session, included in the measurement assistance information provided to the UE;
3) may set the destination port field to the UDP port of the PMF in the UE;
4) may set the source address field to the IPv6 address of the PMF in the UPF, included in the measurement assistance information provided to the UE; and
5) may set the destination address field to the IPv6 address of the PMF in the UE.

The UPF may send the UDP/IPv4 packet or UDP/IPv6 packet over the access of the MA-PDU session.

The UE may select the UDP port of the PMF in the UE upon establishment of an MA-PDU session of IPv4, IPv6 or IPv4v6 PDU session type. The UE may use the same UDP port of the PMF in the UE till release of the MA-PDU session. The UE may select the IPv6 address of the PMF in the UE upon establishment of an MA-PDU session of IPv6 or IPv4v6 PDU session type. The UE may use the same IPv6 address of the PMF in the UE till release of the MA-PDU session.

The UPF may discover the UDP port of the PMF in the UE used with IPv4 of an MA-PDU session of IPv4 or IPv4v6 PDU session type, in the source port field of an UDP/IPv4 packet:
a) received via the MA-PDU session;
b) with the destination port field set to the UDP port of the PMF in the UPF associated with an access, included in the measurement assistance information provided to the UE; and
c) with the destination address field set to the IPv4 address of the PMF in the UPF, included the measurement assistance information provided to the UE.

The UPF may discover the UDP port and the IPv6 address of the PMF in the UE of an MA-PDU session of IPv6 or IPv4v6 PDU session type, in the source port field and the source address field of an UDP/IPv6 packet:
a) received via the MA-PDU session;
b) with the destination port field set to the UDP port of the PMF in the UPF associated with an access, included in the measurement assistance information provided to the UE; and
c) with the destination address field set to the IPv6 address of the PMF in the UPF, included the measurement assistance information provided to the UE.

In order to enable the UPF to discover:
a) the UDP port of the PMF in the UE in case of an MA-PDU session of IPv4 or IPv4v6 PDU session type, or
b) the UDP port and the IPv6 address of the PMF in the UE in case of an MA-PDU session of IPv6 or IPv4v6 PDU session type;
   the UE may perform a access availability or unavailability report procedure over an access immediately after the MA-PDU session is established. If the MA-PDU session is established over both 3GPP access and non-3GPP access, the UE may use either of the accesses for the access availability or unavailability report procedure. If the access availability or unavailability report procedure is aborted, the UE may repeat the access availability or unavailability report procedure over the same access or, if the MA-PDU session is established over both 3GPP access and non-3GPP access, over the other access.

In an example, in order to send a PMFP message over an access of an MA-PDU session of Ethernet PDU session type, the UE may create an Ethernet frame as specified in IEEE 802.3. In the Ethernet frame, the UE:
a) shall set the length/type field of the Ethernet frame to the ethertype value included in the received measurement assistance information;
b) may set the destination address field of the Ethernet frame to the MAC address of the PMF in the UPF associated with the access of the MA-PDU session, included in the received measurement assistance information;
c) may set the source address field of the Ethernet frame to the MAC address of the PMF in the UE;
d) may set the MAC client data field of the Ethernet frame to the 3GPP IEEE MAC based protocol family envelope;
e) may set the protocol subtype field of the 3GPP IEEE MAC based protocol family envelope to “Performance measurement function protocol (PMFP)”; and
f) may set the PMFP message field of the protocol data field of the 3GPP IEEE MAC based protocol family envelope to the PMFP message.

The UE may send the Ethernet frame over the access of the MA-PDU session.

In order to send a PMFP message over an access of an MA-PDU session, the UPF may create an Ethernet frame as specified in IEEE 802.3. In the Ethernet frame, the UPF:
a) may set the length/type field of the Ethernet frame to the ethertype value included in the measurement assistance information provided to the UE;
b) may set the source address field of the Ethernet frame to the MAC address of the PMF in the UPF associated with the access of the MA-PDU session, included in the measurement assistance information provided to the UE;
c) may set the destination address field of the Ethernet frame to the MAC address of the PMF in the UE;
d) may set the MAC client data field of the Ethernet frame to the 3GPP IEEE MAC based protocol family envelope;
e) may set the protocol subtype field of the 3GPP IEEE MAC based protocol family envelope to “Performance measurement function protocol (PMFP)”; and
f) may set the PMFP message field of the protocol data field of the 3GPP IEEE MAC based protocol family envelope to the PMFP message.

The UPF may send the Ethernet frame so that the UE receives it over the access of the MA-PDU session.

The UE may select the MAC address of the PMF in the UE upon establishment of an MA-PDU session of Ethernet PDU session type. The UE may use the same MAC address of the PMF in the UE till release of the MA-PDU session.

The UPF may discover the MAC address of the PMF in the UE of an MA-PDU session of Ethernet PDU session type, in the source address field of an Ethernet frame:
a) received via the MA-PDU session;
b) with the length/type field of the Ethernet frame set to the ethertype value included in the measurement assistance information provided to the UE; and
c) with the destination address field of the Ethernet frame set to the MAC address of the PMF in the UPF associated with an access, included in the measurement assistance information provided to the UE.

In order to enable the UPF to discover the MAC address of the PMF in the UE of an MA-PDU session of Ethernet PDU session type, the UE may perform an access availability or unavailability report procedure over an access immediately after the MA-PDU session is established. If the MA-PDU session is established over both 3GPP access and non-3GPP access, the UE may use either of the accesses for the access availability or unavailability report procedure. If the access availability or unavailability report procedure is aborted, the UE may repeat the access availability or unavailability report procedure over the same access or, if the MA-PDU session is established over both 3GPP access and non-3GPP access, over the other access.

In an example, in order to send/transmit/transport PMFP ECHO REQUEST message, PMFP ECHO RESPONSE message, PMFP PLR COUNT REQUEST message, PMFP PLR COUNT RESPONSE message, PMFP PLR REPORT REQUEST message and PMFP PLR REPORT RESPONSE message over specific QoS flows, SMF may provide the UE with the QoS rules including the packet filters containing the UDP port or the MAC address associated with the QoS flow in the MAI.

The SMF may provide the UPF with the UL PDR including the UDP port or the MAC address associated with a QoS flow via N4 related procedures and messages.

Extended procedure transaction identity (EPTI) may employed in procedures. The UE may maintain the current available UE EPTI value. When the MA-PDU session is established, the UE may set the current available UE EPTI value to 0000H. When a UE-initiated PMFP procedure is initiated, the UE may allocate the current available UE EPTI value to the UE-initiated PMFP procedure and:
if the current available UE EPTI value is 7FFFH, shall set the current available UE EPTI value to 0000H; or
otherwise, shall increase the current available UE EPTI value by one.

The UE may release the EPTI value allocated to the UE-initiated PMFP procedure when the UE-initiated PMFP procedure completes or is aborted.

The UPF may maintain the current available UPF EPTI value. When the MA-PDU session is established, the UPF may set the current available UPF EPTI value to 8000H. When a UPF-initiated PMFP procedure is initiated, the UPF may allocate the current available UPF EPTI value to the UPF-initiated PMFP procedure and:
if the current available UPF EPTI value is FFFFH, shall set the current available UPF EPTI value to 8000H; or
otherwise, shall increase the current available UPF EPTI value by one.

In an example, the UPF may release the EPTI value allocated to the UPF-initiated PMFP procedure when the UPF-initiated PMFP procedure completes or is aborted.

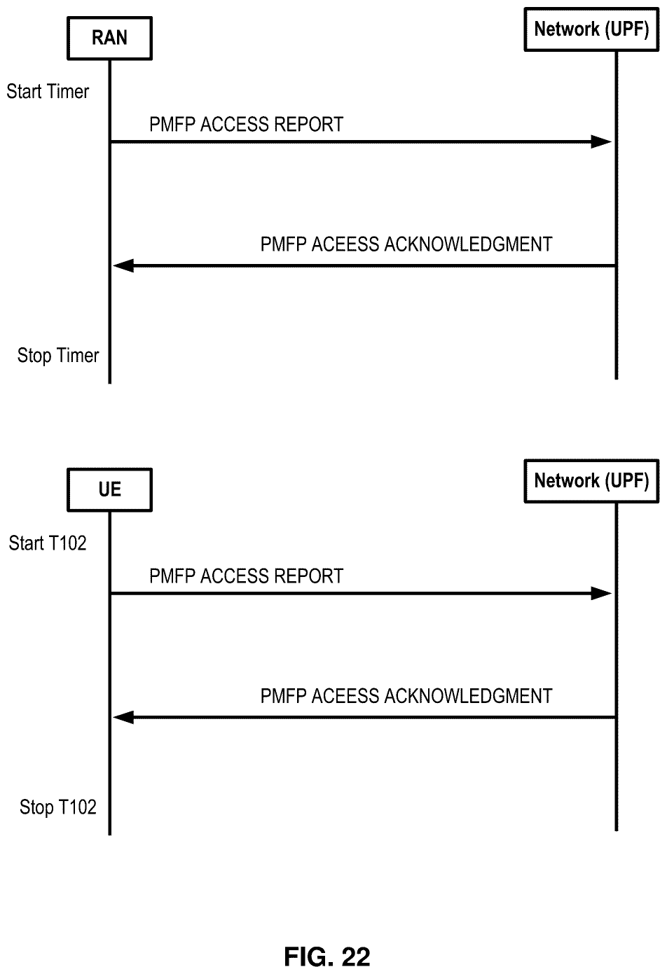

In an example embodiment as depicted in FIG. 22, access availability or unavailability report procedure may be employed. The purpose of the access availability or unavailability report procedure is to enable the UE to inform the UPF about availability or unavailability of an access of an MA-PDU session. In an example, the procedure for reporting of the access availability or unavailability may be employed to enable a RAN node to inform the UPF about availability or unavailability of an access of an MA-PDU session. In an example, the report may comprise an access type (being 3GPP, N3GPP, underlay access, and/or the like), a radio access technology (RAT) (e.g., being LTE, E-UTRA, satellite, NR, and/or the like), an identifier of the RAN node (e.g., base station identifier, an IP address associated with a GTP-U or GTP tunnel of the RAN node, and/or the like), and, a cause value (e.g., radio link failure, resource capacity, congestion, etc.), and/or the like.

In an example, access availability or unavailability report procedure between a RAN node and a UPF may comprise the following. In order to initiate an access availability or unavailability report procedure over an access of a PDU session or an access of an MA-PDU session, the RAN node may allocate a EPTI value and may create a PMFP ACCESS REPORT message. In the PMFP ACCESS REPORT message, the RAN node may set the EPTI IE to the allocated EPTI value. The RAN node may send the PMFP ACCESS REPORT message over the access of the MA-PDU session (or an N3 tunnel to the UPF) and may start a timer.

In an example, upon reception of the PMFP ACCESS REPORT message, the UPF may create a PMFP ACKNOWLEDGEMENT message. In the PMFP ACKNOWLEDGEMENT message, the UPF may set the EPTI IE to the EPTI value in the PMFP ACCESS REPORT message. The UPF may send the PMFP ACKNOWLEDGEMENT message over the access (or the N3 tunnel) of the MA-PDU session via which the PMFP ACCESS REPORT message was received. Upon reception of a PMFP ACKNOWLEDGEMENT message with the same EPTI as the allocated EPTI value, the RAN node may stop the timer.

In an example, access availability or unavailability report procedure between a UE and a UPF may comprise the following. In order to initiate an access availability or unavailability report procedure over an access of of a PDU session or an access of an MA-PDU session, the UE may allocate a EPTI value and may create a PMFP ACCESS REPORT message. In the PMFP ACCESS REPORT message, the UE may set the EPTI IE to the allocated EPTI value. The UE may send the PMFP ACCESS REPORT message over the access of the MA-PDU session or the N3 tunnel and may start a timer T102.

In an example, upon reception of the PMFP ACCESS REPORT message, the UPF may create a PMFP ACKNOWLEDGEMENT message. In the PMFP ACKNOWLEDGEMENT message, the UPF may set the EPTI IE to the EPTI value in the PMFP ACCESS REPORT message. The UPF may send the PMFP ACKNOWLEDGEMENT message over the access of the MA-PDU session or the N3 tunnel via which the PMFP ACCESS REPORT message was received. Upon reception of a PMFP ACKNOWLEDGEMENT message with the same EPTI as the allocated EPTI value, the UE may stop the timer T102.

In an example embodiment, a PDU session supporting a multi-access PDU connectivity service is referred to as multi-access PDU (MA-PDU) session. An MA-PDU session is a PDU session which may use at least one 3GPP access network and/or at least one non-3GPP access network at a time, or simultaneously one or more 3GPP access networks and one or more non-3GPP access networks. An MA-PDU session may employ one or more 3GPP access types, one or more N3GPP access types, one or more underlay access networks, and/or the like, at a time or simultaneously. An MA-PDU session may be established when the UE is registered to the same PLMN over 3GPP access network, non-3GPP access network and underlay access or registered to different PLMNs over 3GPP access network, non-3GPP access network, and underlay access respectively. A UE may initiate MA-PDU session establishment when the UE is registered to a PLMN over both 3GPP access network, non-3GPP access network, and underlay access, or only registered to one access network. Therefore, at any given time, the MA-PDU session may have user-plane resources established on at least one or more of 3GPP access, non-3GPP access, and underlay access, or on one access only (either 3GPP access or non-3GPP access, or underlay access), or may have no user-plane resources established on any access.

In an example embodiment, access availability or unavailability may refer to at least one state of the UE connection via the access (e.g., RRC connection state, CM connection state, and/or the like). In an example, access availability or unavailability may refer to or depend on the UE being in the coverage of the access or not. In an example, access availability or unavailability may refer to or depend on the link status of the UE with the base station (or a cell of the base station) associated with the access (e.g., RAT). In an example, when a radio link failure (RLF) occurs, the UE may determine that the access is unavailable. In an example, the UE may or may not report access availability during an RLF recovery procedure. The UE may report the access as unavailable when the RLF recovery fails or a certain time has elapsed since the RLF recovery started. In an example, the UE may determine the access being unavailable when the UE is not within a coverage of the access. In an example, the UE may determine the access to be unavailable when the RRC connection state of the access is in RRC-INACTIVE, RRC-IDLE, and/or the like. The UE may report availability of the access when the RRC connection transitions to RRC-CONNECTED state, or the UE moves to a coverage area of the base station (or a cell of the base station) associated with the access.

In an example embodiment, a radio access technology (RAT) may be a sub-category of an access type. In an example, the access type may comprise a 3GPP access, a non-3GPP access, an underlay access, and/or the like. In an example, 3GPP access types may be categorized in different RAT types e.g., new radio (NR), LTE, UTRA, EUTRA, HSPA, satellite, a non-terrestrial network (NTN) radio access technology, a terrestrial network radio access technology, and/or the like. In an example, RAT (types) for non-3GPP access types may comprise different access network types or technologies such as WiFi, IEEE 80.11, IEEE 802.16, and/or the like.

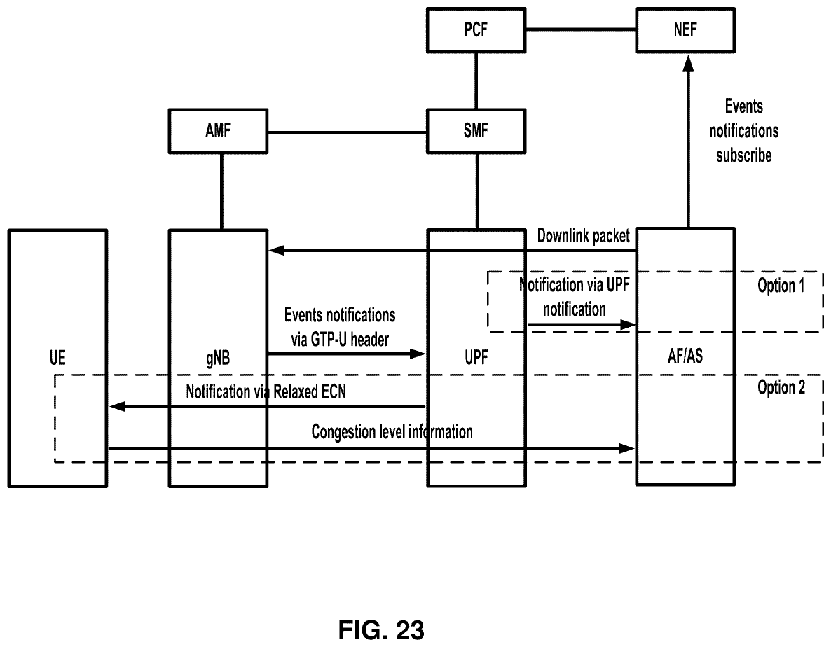

In an example embodiment, as depicted in FIG. 23, Low Latency, Low Loss and Scalable Throughput (L4S), may be a network service using AQM-like mechanism which, instead of dropping packets, may use link state indications and rate adjustments proportional to the queue delay. To address service requirements of L4S, ECN bits may be employed for marking of payload packets (as specified in RFC 8311). In an example, the NG-RAN may expose a load level (e.g., current, future etc.). Example embodiments may comprise use of ECN bits in NG-RAN for L4S, enablement of using ECN bits for L4S, and/or the like. In an example, the RAN node or NG-RAN may determine the resource availability and sudden changes on the radio interface that impact the performance in terms of latency. In an example, any fast reaction to trigger rate adaptation, that is required for services with tight latency requirements and benefit from bounded latency, may be triggered by NG-RAN. NG-RAN may employ ECN bits for marking of payload packets as specified in RFC 8311 to support L4S. ECN bits marking may interact with the application layer, wherein the application layer may triggers rate adaptation based on feedback using ECN bits. In an example, NG-RAN may employ ECN bits marking for DL and/or UL direction.

In an example, as in FIG. 23, the following information may be exposed from 5GS to AF via the user plane:
Congestion level information: degree of RAN congestion. This notification may apply for the non-GBR QoS flows. Extended reality and media service (XRM) services may have high requirements for low latency and high bandwidth, which the congestion problem cannot be ignored. Based on the information exposure, application may adjust the codec/rate to alleviate 5GS congestion according to the congestion level information for the QoS flow from 5GS.
QoS Notification Control (QNC) information: the notification whether the GFBR can no longer (or can again) be guaranteed for a QoS Flow during the lifetime of the QoS Flow. If RAN receives the QNC and the GFBR can no longer (or can again) be guaranteed, RAN node (NG-RAN) may send the notification to AF via the UPF.

In an example, a common Tunnel Endpoint Identifier (C-TEID) may be employed to identify a tunnel endpoint in the receiving GTP-U protocol entity for a given UDP/IP endpoint. The sending end side of a GTP tunnel locally assigns the C-TEID value used in the TEID field and signals it to the destination Tunnel Endpoint using a control plane message.

In an example, GTP-U Message such as GTP-U (user plane) messages may be either user plane messages or signalling messages. User plane messages may be employed to carry user data packets between GTP-U entities. Signalling messages may be sent between network nodes for path management and tunnel management. GTP-U peer may be a node implementing at least one side of any of the GTP user plane based protocols. RNC, SGSN, GGSN, eNodeB, SGW, ePDG, gNB, N31WF, UPF, PGW or TWAN or MME.

In an example, a GTP-U tunnel may be identified in each node with a TEID, an IP address and a UDP port number. A GTP-U tunnel is necessary to enable forwarding packets between GTP-U entities.

In an example, a GTP-U tunnel endpoint may identify a user plane context (e.g., EPS bearer, PDU session or a RAB) for which a received GTP-U packet is intended. A given GTP-U tunnel endpoint may receive GTP-U packets from more than one source GTP-U peer. In an example, a UDP/IP Path may be a connection-less unidirectional or bidirectional path defined by two end-points. An IP address and a UDP port number define an end-point. A UDP/IP path may carry GTP messages between network nodes related to one or more GTP tunnels.

In an example, a GTP-PDU e.g., a GTP Protocol Data Unit (PDU) may be a GTP-U message, which may be either a G-PDU or a signalling message. A G-PDU may be user data packet (T-PDU) plus GTP-U header, sent between GTP network nodes.

In an example, signalling message may be a GTP-U message (e.g., GTP-PDU that may or may not be a G-PDU) sent between GTP network nodes. These may be Path Management messages or Tunnel Management messages.

In an example, T-PDU may be a user data packet, for example an IP datagram, sent between a UE and a network entity in an external packet data network. A T-PDU is the payload that is tunnelled in the GTP-U tunnel.

In an example, Tunnel Endpoint Identifier (TEID) may identify a tunnel endpoint in the receiving GTP-U protocol entity for a given UDP/IP endpoint. The receiving end side of a GTP tunnel may locally assign the TEID value the transmitting side has to use. The TEID values may be exchanged between tunnel endpoints using control plane message.

In an example, GTP-U Tunnels may be employed to carry encapsulated T-PDUs and signalling messages between a given pair of GTP-U Tunnel Endpoints. The Tunnel Endpoint ID (TEID) which is present in the GTP header may indicate which tunnel a particular T-PDU belongs to. In this manner, packets are multiplexed and de-multiplexed by GTP-U between a given pair of Tunnel Endpoints. The TEID value to be used in the TEID field may be be signalled to the peer GTP-U entity using a control plane protocol like GTPv1-C, GTPv2-C, RANAP or S1-AP.

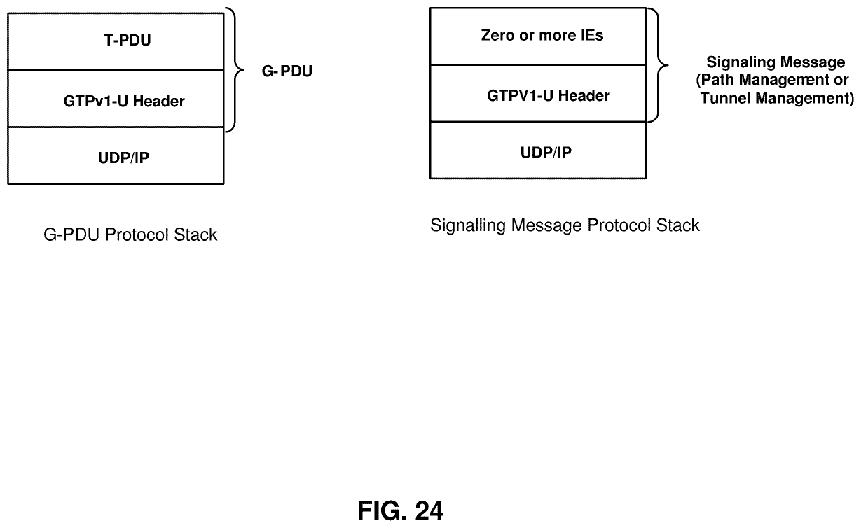

In an example, the protocol stack for a GTP-PDU G-PDU and the protocol stack for a GTP-PDU signalling message may be depicted as shown in FIG. 24. T-PDU may comprise an IP Datagram, Ethernet or unstructured PDU Data frames.

In an example embodiment, for the GTP-U messages described below (other than the Echo Response message), the UDP Source Port or the Flow Label field) may be set dynamically by the sending GTP-U entity to help balancing the load in the transport network.

When using GTP-U over IPv6 (IETF RFC 8200), the UDP checksum may not be set to zero by the sending GTP-U entity unless it is ensured that the peer GTP-U entity and the path in-between supports UDP zero checksum. GTP-U entities complying with an earlier version of the specification or on path IPv6 middleboxes may implement IPv6 as specified in IETF RFC 2460 and discard UDP packets containing a zero checksum. In an example, Echo Request Message may employ the UDP Destination Port number for GTP-U request such as 2152. It is the registered port number for GTP-U. In an example, Echo Response Message may employ the UDP Destination Port value that may be the value of the UDP Source Port of the corresponding request message. The UDP Source Port may be the value from the UDP Destination Port of the corresponding request message. In an example, encapsulated T-PDUs may employ the UDP Destination Port number that may be 2152. It is the registered port number for GTP-U. In an example, error Indication may be employed. The UDP destination port for the Error Indication may be the user plane UDP port (2152). In an example, Supported Extension Headers Notification may be employed. The UDP destination port for the Supported Extension Headers Notification may be the user plane UDP port (2152). In an example, End Marker may be employed. The UDP Destination Port number may be 2152. It is the registered port number for GTP-U. The UDP Destination Port and UDP Source Port may be the same as those of the corresponding GTP-U tunnel for which the End Marker message is sent.

In an example, tunnel status information may be employed. The UDP destination port for the tunnel status may be the user plane UDP port (2152). In an example, for the tunnel status, the IP source address may be an IP address of the source GTP-U entity from which the message is originating. The IP Destination Address may be an IP address of the destination GTP-U entity. The IP Destination Address and IP Source Address may be the same as the corresponding GTP-U tunnel (to send G-PDU) for which the tunnel status message is sent.

In an example, GTP-U Message Formats may comprise the following. GTP-U may define a set of messages between the two ends of the user plane of the interfaces Iu, Gn, Gp, S1-U, S11-U, S2a, S2b, S4, S5, S8, S12, X2, M1, Sn, Xn, N3, N9 and N19.

GTP-U messages are sent across a GTP user plane tunnel. A GTP-U message may be either a signalling message across the user plane tunnel, or a G-PDU message.
GTP-U signalling messages are used for user plane path management, or for user plane tunnel management.
G-PDU is a vanilla user plane message, which carries the original packet (T-PDU). In G-PDU message, GTP-U header is followed by a T-PDU.

A T-PDU is an original packet, for example an IP datagram, Ethernet frame or unstructured PDU Data, from an UE, or from a network node in an external packet data network.

The complete range of message types defined for GTPv1 is defined in 3GPP TS 29.060. The table below includes those applicable to GTP user plane. The three columns to the right define which of the three protocols sharing the common header of GTPv1 (GTP-C, GTP-U or GTP’) might implement the specific message type.

### Messages in GTP-U

| | | | | | |
|---|---|---|---|---|---|
| Message Type | | | | | |
| value | | Refer- | | | |
| (Decimal) | Message | ence | GTP-C | GTP-U | GTP′ |

| | | | | |
|---|---|---|---|---|
| 1 | Echo Request | X | X | x |
| 2 | Echo Response | X | X | x |
| 3-25 | Reserved in 3GPP | | | |
| | TS 32.295 and | | | |
| | 3GPP TS 29.060 | | | |
| 26 | Error Indication | | X | |
| 27-30 | Reserved in 3GPP | | | |
| | TS 29.060 | | | |
| 31 | Supported Extension | X | X | |
| | Headers Notification | | | |
| 32-252 | Reserved in 3GPP | | | |
| | TS 29.060 | | | |
| 253 | Tunnel Status | | X | |
| 254 | End Marker | | X | |
| 255 | G-PDU | | X | |

In an example embodiment, Tunnel Management Messages may be employed that may comprise the following.

Error Indication: When a GTP-U node receives a G-PDU for which no EPS Bearer context, PDP context, PDU Session, MBMS Bearer context, or RAB exists, the GTP-U node may discard the G-PDU. If the TEID of the incoming G-PDU is different from the value ‘all zeros’ the GTP-U node may also return a GTP error indication to the originating node. GTP entities may include the “UDP Port” extension header (Type 0x40), in order to simplify the implementation of mechanisms that can mitigate the risk of Denial-of-Service attacks in some scenarios. The information element Tunnel Endpoint Identifier Data I may be the TEID fetched from the G-PDU that triggered this procedure. The information element GTP-U Peer Address may be the destination address (e.g. destination IP address, MBMS Bearer Context) fetched from the original user data message that triggered this procedure. A GTP-U Peer Address can be a GGSN, SGSN, RNC, PGW, SGW, ePDG, eNodeB, TWAN, MME, gNB, N31WF, or UPF address. The TEID and GTP-U peer Address together uniquely identify the related PDP context, RAB, PDU session or EPS bearer in the receiving node.

The optional Private Extension contains vendor or operator specific information. Information Elements in an Error Indication may be depicted in the following table.

| Information element | Presence requirement |
|---|---|
| Tunnel Endpoint Identifier Data I | Mandatory |
| GTP-U Peer Address | Mandatory |
| Recovery Time Stamp | Optional |
| Private Extension | Optional |

Tunnel Status: The Tunnel Status message may be a transmitted or received by a GTP-U entity, if it supports the message, may send one or more tunnel status message to the peer GTP-U entity to provide the status information related to the corresponding GTP-U tunnel in the sending GTP-U entity. If a Tunnel Status message is received with a TEID for which there is no context, or the message is not supported, then the receiver may ignore this message. The following table depicts information elements in tunnel status message

| Information element | Presence requirement |
|---|---|
| GTP-U Tunnel Status Information | Mandatory |
| Private Extension | Optional |

In an example, GTP-U Tunnel Status Information may comprise the following. The GTP-U Tunnel Status Information contains the status information related to the corresponding GTP-U tunnel in the sending GTP-U entity.

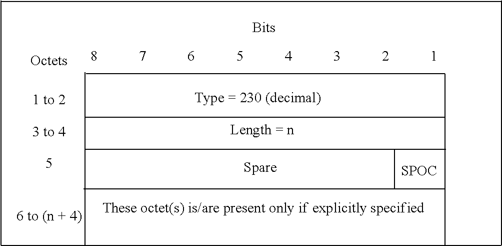

### GTP-U Tunnel Status Information

The octet 5 may be encoded as follows:
Bit 1—SPOC (Start Pause Of Charging): when set to “1”, this indicates a request to the receiving GTP-U entity to stop usage measurement for the URR(s) with the Applicable for Start of Pause of Charging Flag set to “1” as specified in 3GPP TS 29.244 for the PFCP session (identified by the IP address and TEID of the header of the Tunnel Status message). The GTP-U entity shall forward Tunnel Status message to the upstream GTP-U entity if it is not a PSA UPF or PGW-U connecting to N6/SGi interface.

In an example embodiment, user plane congestion may refer to a state wherein the network may drop packets or be unable to process packets for transmission and/or reception. User plane congestion may refer to a state where the packet loss ratio exceeds a threshold due to queue delay, link failure, buffer or queue overflow, and/or the like. User plane congestion may be a state of congestion at the user plane of a network. When user plane congestion occurs, control plane message may be transmitted via signalling and the control plane of the network. User plane congestion may occur when link capacity is utilized beyond a threshold. User plane congestion may occur when a load condition of the network node such as a UPF, a RAN node, a cell of a base station, and/or the like is exceeded by a threshold. In an example, the user plane congestion may be RAN congestion. In an example, congestion may be load or capacity of a RAN node, or UPF node, and/or the like. In an example, congestion may be a link level congestion, congestion of a path, congestion of link between two network nodes (e.g., N3 interface, Uu interface, and/or the like), congestion as determined by the transport layer, application layer, link layer or physical layer, congestion as identified by an explicit congestion notification (ECN as in IETF), and/or the like.

In an example embodiment, an event may comprise a user plane congestion, congestion level information, access being unavailable/available, a packet loss ratio exceed a threshold, congestion level reaching a threshold as determined by a trigger condition, RAN congestion notification, congestion of user plane resources of a network slice associated with network slice ID (network slice ID may comprise S-NSSAI, network slice instance (NSI) ID, NSSAI, and/or the like), congestion of user plane resources associated with a DNN, and/or the like. In an example, an event may be mapped to an event ID. In an example, the event ID may identify an event with cause such as access unavailability, user plane congestion, and/or the like and with a value for the threshold such as congestion level value (e.g., in a range of one or more integer values), and S-NSSAI, and/or the like.

In an example, a network slice identifier may be a S-NSSAI, network slice instance (NSI) ID, NSSAI, and/or the like.

In an example, a triggering condition may comprise a threshold value for a utilization ratio of user plane resources, a threshold value for congestion level value of the congestion level information, access being available or unavailable, and/or the like. In an example, the triggering condition may comprise a value for congestion level information. For example, the triggering condition may comprise a condition such as congestion level being equal or greater than a value (e.g., an integer from the range values for the congestion level value e.g., 1-31). In an example, the triggering condition may comprise a slice ID, a DNN, and/or the like.

As depicted in example embodiments, existing technologies may support user plane congestion reporting over user plane. When a RAN node sends a congestion notification to a UPF via a GTP tunnel associated with a PDU session of a wireless device, the UPF may determine to perform an action on data transmission of the wireless device. In existing technologies, the UPF may be configured by the SMF via session level signalling to report congestion of user plane to an AF. Configuration of UPF via SMF requires additional signalling steps in the core network to trigger the SMF to perform the configuration. As a result, the configuration may be applicable to a QoS flow or a session of a wireless device. In an example, for a number of wireless devices, performing configuration of congestion reporting on a per session basis, may cause additional signalling and unnecessary utilization of network resources.

Example embodiments improve system performance by signalling enhancements between the UPF node and the control plane to configure the UPF node to report congestion of user plane resources per network slice. In an example, the example embodiments may employ node level signalling to reduce the overhead of configuration and reporting of user plane congestion.

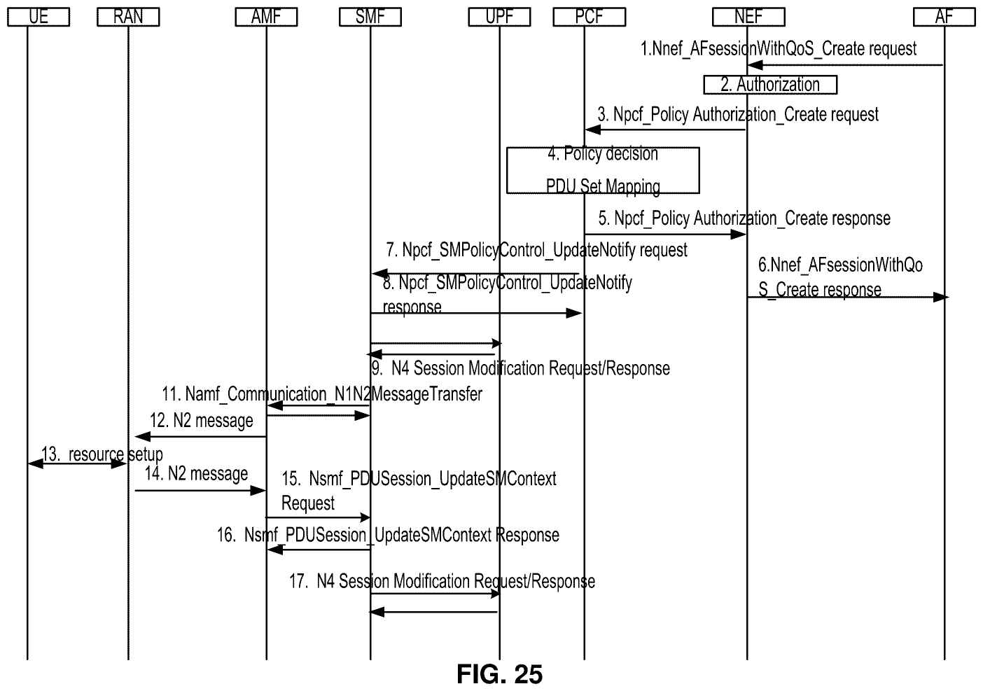

FIG. 25 illustrates an example event exposure subscription procedure in a network in accordance with embodiments of the present disclosure. In an example, the AF may subscribe to an event such as the Network Congestion (e.g., RAN congestion) by sending Nnef_EventExposure_Subscribe request (comprising: UE address, event ID(s)). In an example, the NEF may authorize the AF request. The NEF may interact with the PCF by triggering a Npcf_PolicyAuthorization_Subscribe request to the Network Congestion (e.g. RAN congestion) event. Upon reception of the subscribe request of Network Congestion for a UE address, the PCF may generate a QoS rule for RAN to report RAN's congestion. The PCC rule includes an indication that the PCC rule is used for RAN report information. The PCF may generate a QoS monitoring policy for network congestion measurement. The PCF may respond to the NEF a Npcf_Policy Authorization_Create response. The NEF may send a Nnef_AFsessionWithQoS_Create response message to the AF. In an example, the PCF may initiate SM Policy Association Modification Request (PCC rule) to the SMF. In an example, the SMF may map a QoS flow for the PCC rule from the PCF. In an example, the QoS flow's QoS profile may include the indication that the QoS flow is used for RAN report information. In an example, the SMF may generate the QoS Monitoring configuration for UPF to perform e.g., RAN congestion detection indication. The SMF may generate the QoS Monitoring configuration for RAN: RAN congestion measurement indication, measure frequency, report threshold. The SMF may reply with SM Policy Association Modification Response to the PCF. The SMF may initiate N4 Session Modification Request (QoS Monitoring configuration, QoS rule) to the UPF. In an example, upon reception of QoS Monitoring configuration, the UPF may enable the RAN's congestion detection and report. In an example, the UPF(s) may respond to the SMF. For SMF requested modification, the SMF may invoke Namf_Communication_N1N2MessageTransfer ([N2 SM information](PDU Session ID, QFI(s), QoS Profile(s), QoS Monitoring configuration), N1 SM container)). In an example, the AMF may send N2 ([N2 SM information received from SMF], NAS message (PDU Session ID, N1 SM container (PDU Session Modification Command))) Message to the (R)AN. In an example, upon reception of QoS flow's QoS profile and the indication that the QoS flow is used for RAN report information, the RAN may skip to map DRB for the QoS flow and make the QoS flow terminated between the RAN and the UPF. Upon reception of QoS Monitoring configuration, the RAN may enable the RAN congestion measurement and report. The (R)AN may acknowledge N2 PDU Session Request by sending a N2 PDU Session Ack Message to the AMF. The AMF may forward the N2 SM information and the User location Information received from the AN to the SMF via Nsmf_PDUSession_UpdateSMContext service operation. The SMF replies with a Nsmf_PDUSession_UpdateSMContext Response. The SMF may update N4 session of the UPF(s) that are involved by the PDU Session Modification by sending N4 Session Modification Request message to the UPF.

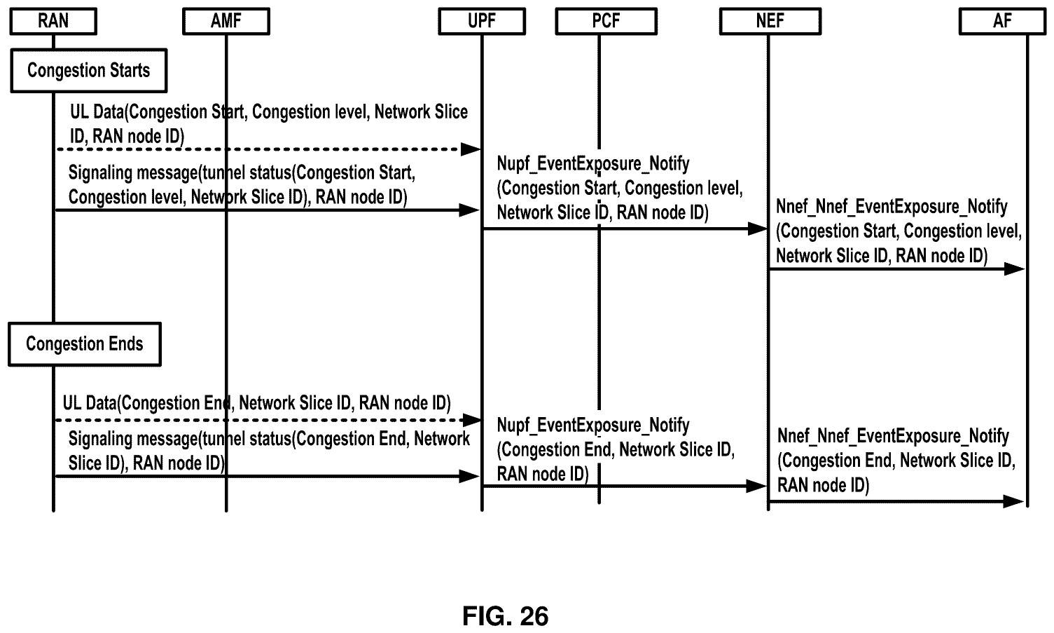

FIG. 26 illustrates an example information report procedure in a network in accordance with embodiments of the present disclosure. In an example, when the RAN congestion for a network slice and/or a DNN starts or congestion level of user plane resources of a network slice reaches the report threshold as configured by the core network (e.g., AMF or SMF), the NG-RAN may send a notification message to indicate the RAN Congestion Start and RAN congestion level in the GTP-U header of the UL data. In an example, the notification message may comprise an identifier of the network slice associated with the congested user plane resources. In an example, the notification may comprise an identifier of the RAN node (NG-RAN), wherein the identifier may comprise a base station ID, an address (e.g., IP address, and/or the like) of a tunnel between the RAN node and the UPF, and/or the like. In an example, the notification message may comprise a DNN associated with the congested user plane resources.

In an example, the notification from the NG-RAN to the UPF may be the signaling message as described in an example. In an example embodiment, the signalling message may comprise the tunnel status information element (IE) as described in an example embodiment. In an example, the tunnel status (the tunnel status IE) may comprise a user plane congestion notification, a RAN congestion notification, a GTP tunnel congestion indication, the congestion level information, the congestion start indication, the network slice identifier associated with the congestion, and/or the like. In an example, the signalling message may comprise the notification message to indicate the RAN Congestion Start and RAN congestion level. In an example, the signalling message may comprise the user plane congestion notification, a RAN congestion notification, a GTP tunnel congestion indication, the congestion level information, the congestion start indication, the network slice identifier associated with the congestion, and/or the like. In an example, upon detection of the RAN Congestion Start and RAN congestion level from the UL data, the UPF triggers the Nupf_EventExposure_Notify message to report the RAN Congestion Start and RAN congestion level. In an example, the UPF may transmit the identifier of the network slice to the AF via the NEF (e.g., via the Nupf_EventExposure_Notify message). In an example, the UPF may determine an identifier of a target node (e.g., AF, or AS) based on the identifier of the network slice. In an example, the signalling message may comprise a DNN associated with the congested user plane resources. In an example, the tunnel status IE may comprise a DNN associated with the congested user plane resources.

In an example, the NEF may send a Nnef_Nnef_EventExposure_Notify (comprising RAN Congestion Start and RAN congestion level, the identifier of the network slice, and/or the like) message to the AF. In an example, when the RAN congestion ends, the NG RAN indicates the RAN Congestion End for the network slice in the GTP-U header of the UL data. In an example, the notification of congestion end may comprise the identifier of the network slice. In an example, upon detection of the RAN Congestion End from the UL data, the UPF may trigger the Nupf_EventExposure_Notify message to report the RAN Congestion End. In an example, the Nupf_EventExposure_Notify message may comprise the identifier of the network slice. The NEF may send a Nnef_Nnef_EventExposure_Notify (RAN Congestion End) to the AF. In an example, the Nnef_Nnef_EventExposure_Notify may comprise the identifier of the network slice associated with the congested user plane resources.

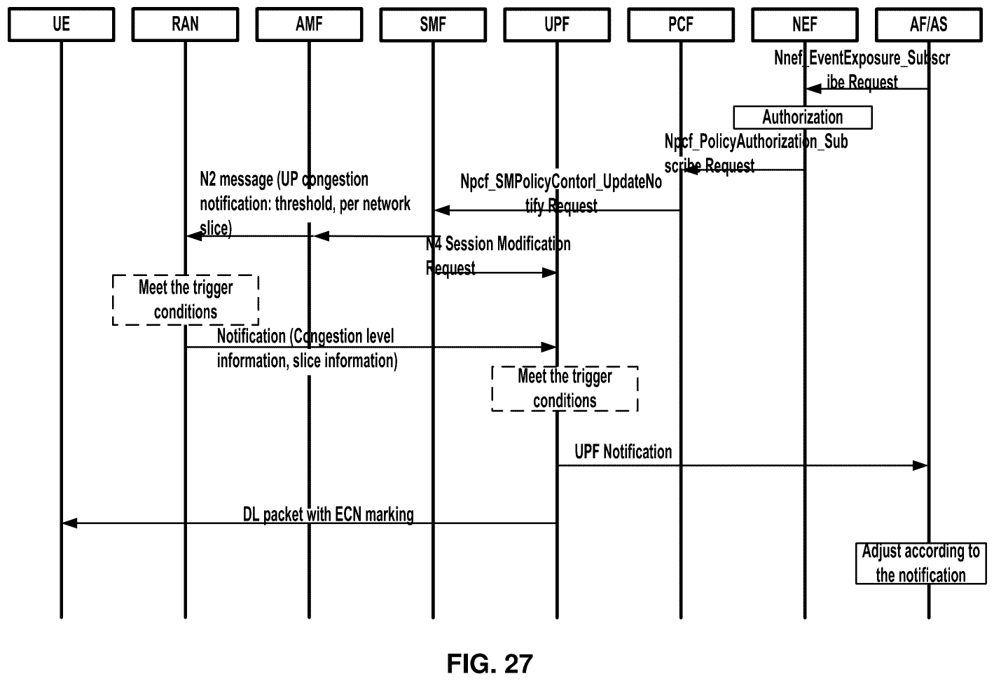

FIG. 27 illustrates an example information exposure configuration and information reporting procedure in a network in accordance with embodiments of the present disclosure.

In an example embodiment, an application function (AF) may send Nnef_EventExposure_subscribe request to subscribe the events notifications, that may the trigger conditions. In an example, an event may comprise:
(a). Congestion level information: AF sends this subscription message to request that 5GS sends the congestion notification for the QoS flow when the trigger conditions are met. The congestion level information is used to adjust the codec/rate of transmission to assist in alleviating 5GS congestion. In this event, the trigger conditions may include the follows:
   The queue delay, packet loss rate and buffer size are greater than the threshold #A, B, C.
   The congestion level. In an example, the congestion level may be associated with a network slice with network slice identifier and/or may be associated with user plane resources used by a DNN with a DNN ID.
(b). QoS Notification Control (QNC) information: AF sends this subscription message to request that 5GS sends the QNC information to indicate whether the GFBR can no longer (or can again) be guaranteed for a QoS Flow during the lifetime of the QoS Flow.

In an example embodiment, the trigger condition may be per network slice and/or per DNN.

In an example, the NEF may perform the necessary authorization control. In an example, the NEF may employ the Npcf_PolicyAuthorization_Subscribe request message to send the AF request information to the PCF to generate the SM policy with the events notifications and the corresponding trigger conditions. If the AF is considered to be trusted by the operator, the AF may employ the Npcf_PolicyAuthorization_Subscribe request to interact directly with PCF to subscribe the above event notifications.

In an example, the PCF sends the SM policy to the SMF by Npcf_SMPolicyControl_UpdateNotify request, which may comprise the events notifications and the corresponding trigger conditions. In an example, the SMF may send the events notifications to RAN by N2 message via AMF, to configure the RAN node to send the notifications to UPF via the GTP-U header. In an example, the N2 message may be employed by the AMF to configure the RAN node (NG-RAN) to report RAN congestion information per network slice to the UPF. The configuration may indicate to the RAN node to send the notification via the signalling message, or employ tunnel status IE to report RAN congestion for the network slice. In an example, the N2 message may comprise a request to report user plane congestion, RAN congestion, and/or the like. In an example, the N2 message may comprise a threshold value or a trigger condition for reporting the event (e.g., RAN congestion). In an example, the trigger condition may comprise the identifier of the network slice for which the congestion to be reported, a threshold value for the level of congestion for the user plane resources associated with the network slice, a threshold value for the level of congestion for the user plane resources associated with the DNN. In an example the N2 message may comprise the identifier of the network slice, the identifier of the DNN, RAN congestion report indication (for the network slice and/or DNN), user plane congestion report indication, triggering conditions, and/or the like.

In an example, the SMF may send the trigger conditions to RAN. Then, RAN only sends the notifications when the trigger conditions are met. In an example, the SMF may send the events notifications to UPF by N4 session modification request to configure/instruct the UPF to forward the notifications received by RAN to AF. If SMF does not send the trigger conditions to the RAN node, the SMF may send the trigger conditions to the UPF. In an example, the UPF may forwards the notifications when the trigger conditions are met. In an example, the SMF may instruct the UPF to mark DL traffic using Relaxed ECN based on notification from RAN.

In an example, the RAN node may send the notifications to the UPF via the UL GTP-U header. The GTP-U packet may be employed to send the notifications or also send the UL data. In an example, the RAN node may send the notifications to the UPF via the signalling messages. In an example, the RAN node may send the notifications to the UPF via a GTP message wherein the GTP message may comprise the tunnel status information or IE. In an example, the tunnel status IE may comprise an element of the notification message as described in an example embodiment of the present disclosure.

In an example, if RAN receives the trigger conditions, it performs the judgement whether the trigger conditions are met.

In an example, the UPF may forward the notifications to AF. If UPF receives the trigger conditions, the UPF may perform the judgement whether the trigger conditions are met. If the congestion level information is exposed and Relaxed ECN (defined in RFC 8311) is used for the exposure, the UPF may mark the ECN bits of DL IP packets of the QoS Flow based on the notification message (the congestion level information, the identifier of the network slice, and/or the like) reported by the RAN node. In an example, the UE may feedback congestion status by using ECN feedback mechanisms of layer 4 protocol following existing IETF standardization. In an example, the AF may receive the notifications via either UPF notification or mechanisms defined by RFC 8311 and performs the corresponding handling. For example:
Congestion level and slice information for adjusting: If the notification shows the congestion level, the AF may know the degree of congestion and reduce the rate correspondingly for the data packets or traffic associated with the network slice.
QoS Notification Control (QNC) information: the notification shows whether the GFBR can no longer (or can again) be guaranteed for a QoS Flow during the lifetime of the QoS Flow.

In an example embodiment, GTP-U extension headers may be employed. The format of GTP-U Extension Headers may comprise the following. The Extension Header Length field specifies the length of the particular Extension header in 4 octets units. The Next Extension Header Type field specifies the type of any Extension Header that may follow a particular Extension Header. If no such Header follows, then the value of the Next Extension Header Type may be 0.

| | |
|---|---|
| Octets 1 | Extension Header Length |
| 2 − m | Extension Header Content |
| m + 1 | Next Extension Header Type |

### Outline of the Extension Header Format

The length of the Extension header may be defined in a variable length of 4 octets, i.e. m+1=n*4 octets, where n is a positive integer.

Bits 7 and 8 of the Next Extension Header Type define how the recipient may handle unknown Extension Types. The recipient of an extension header of unknown type but marked as ‘comprehension not required’ for that recipient may read the ‘Next Extension Header Type’ field (using the Extension Header Length field to identify its location in the GTP-PDU). The recipient of an extension header of unknown type, but marked as ‘comprehension required’ for that recipient, may:
If the message with the unknown extension header was a request or a G-PDU, send a Supported Extension Headers Notification to the originator of the GTP-PDU, discard the message and log an error.
   Bits 7 and 8 of the Next Extension Header Type have the following meaning:

| Bits | | |
|---|---|---|
| 8 | 7 | Meaning |
| 0 | 0 | Comprehension of this extension header is not required. An |
| | | Intermediate Node shall forward it to any Receiver Endpoint |
| 0 | 1 | Comprehension of this extension header is not required. |
| | | An Intermediate Node shall discard the Extension Header |
| | | Content and not forward it to any Receiver Endpoint. |
| | | Other extension headers shall be treated independently |
| | | of this extension header. |
| 1 | 0 | Comprehension of this extension header is required by |
| | | the Endpoint Receiver but not by an Intermediate Node. An |
| | | Intermediate Node shall forward the whole field to |
| | | the Endpoint Receiver. |
| 1 | 1 | Comprehension of this header type is required by recipient |
| | | (either Endpoint Receiver or Intermediate Node) |

### Definition of Bits 7 and 8 of the Extension Header Type

An Endpoint Receiver is the ultimate receiver of the GTP-PDU (e.g. an RNC or the GGSN for the GTP-U plane). An Intermediate Node is a node that handles GTP but is not the ultimate endpoint (e.g. an SGSN for the GTP-U plane traffic between GGSN and RNC).

Definition of Extension Header Type may be shown as follows.

| Next Extension | |
|---|---|
| Header Field Value | Type of Extension Header |
| 0000 0000 | No more extension headers |
| 0000 0001 | Reserved - Control Plane only. |
| 0000 0010 | Reserved - Control Plane only. |
| 0000 0011 | Long PDCP PDU Number. |
| | See NOTE 2. |
| 0010 0000 | Service Class Indicator |
| 0100 0000 | UDP Port. Provides the UDP |
| | Source Port of the triggering |
| | message. |
| 1000 0001 | RAN Container |
| 1000 0010 | Long PDCP PDU Number. |
| | See NOTE 3. |
| 1000 0011 | Xw RAN Container |
| 1000 0100 | NR RAN Container |
| 1000 0101 | PDU Session Container. See |
| | NOTE 4. |
| 1100 0000 | PDCP PDU Number. See NOTE 1. |
| 1100 0001 | Reserved - Control Plane only. |
| 1100 0010 | Reserved - Control Plane only. |

NOTE 1:
As an exception to the comprehension rule specified above, for a G-PDU with a Next Extension Header Field set to the value “1100 0000”, the SGW shall consider this corresponding extension header as ‘comprehension not required’.
NOTE 2:
This value shall be used by a source eNB or gNB complying with this release of the specification.
NOTE 3:
This value shall not be used by a source eNB or gNB complying with this release of the specification. It may be received from a source eNB complying with an earlier release of the specification, i.e. not supporting the extension header value “0000 0011”.
NOTE 4:
For a GTP-PDU with several Extension Headers, the PDU Session Container should be the first Extension Header.

In an example, the extension header may comprise the PDU session container. This extension header may be transmitted in a G-PDU over the N3 and N9 user plane interfaces, between NG-RAN and UPF, or between two UPFs. It may also be transmitted in End Marker packets over data forwarding tunnels in 5GS, for data forwarding between 5GS and EPS. The PDU Session Container may have a variable length.

In an example, frame format for the PDU Session user plane protocol (PDU session container) may comprise the following: DL PDU SESSION INFORMATION (PDU Type 0). This frame format is defined to allow the NG-RAN to receive some control information elements which are associated with the transfer of a packet over the interface.

The following shows the respective DL PDU SESSION INFORMATION frame.

| Bits | | | | | | | | Number of |
|---|---|---|---|---|---|---|---|---|
| 7 | 6 | 5 | 4 | 3 | 2 | 1 | 0 | Octets |

| | | | | | |
|---|---|---|---|---|---|
| PDU Type (=0) | QMP | SNP | MSNP | Spare | 1 |

| | | | |
|---|---|---|---|
| PPP | RQI | QoS Flow Identifier | 1 |

| | | |
|---|---|---|
| PPI | Spare | 0 or 1 |

| | |
|---|---|
| DL Sending Time Stamp | 0 or 8 |
| DL QFI Sequence Number | 0 or 3 |
| DL MBS QFI Sequence Number | 0 or 4 |
| Padding | 0-3 |

### DL PDU Session Information (PDU Type 0) Format

In an example, the UL PDU SESSION INFORMATION (PDU Type 1) may comprise the following. This frame format is defined to allow the UPF to receive some control information elements which are associated with the transfer of a packet over the interface.

The following shows the respective UL PDU SESSION INFORMATION frame.

| Bits | | | | | | | | Number of |
|---|---|---|---|---|---|---|---|---|
| 7 | 6 | 5 | 4 | 3 | 2 | 1 | 0 | Octets |
| PDU Type (=1) | | | | QMP | DL | UL | SNP | 1 |
| | | | | | Delay | Delay | | |
| | | | | | Ind. | Ind. | | |
| N3/N9 | New IE | QoS Flow Identifier | | | | | | 1 |
| Delay | Flag | | | | | | | |
| Ind. | | | | | | | | |
| DL Sending Time Stamp Repeated | | | | | | | | 0 or 8 |
| DL Received Time Stamp | | | | | | | | 0 or 8 |
| UL Sending Time Stamp | | | | | | | | 0 or 8 |
| DL Delay Result | | | | | | | | 0 or 4 |
| UL Delay Result | | | | | | | | 0 or 4 |
| UL QFI Sequence Number | | | | | | | | 0 or 3 |
| N3/N9 Delay Result | | | | | | | | 0 or 4 |
| New IE | New IE | New IE | New IE | New IE | New IE | New IE | New IE | 0 or 1 |
| flag | Flag 6 | Flag 5 | Flag 4 | Flag 3 | Flag 2 | Flag 1 | Flag 0 | New IE |
| 7(E) | | | | | | | | Flags |
| | | | | | | | | Octet |

| Spare | D1 UL | 0 or 1 |
|---|---|---|
| | PDCP | |
| | Delay | |
| | Result | |
| | Ind | |

| | |
|---|---|
| Padding | 0-3 |

### UL PDU Session Information (PDU Type 1) Format

The New IF Flag in bit 6 of 2nd octet in UL PDU SESSION INFORMATION (PDU Type 1) indicates if the first octet of New IF Flags Octet is present or not.

Bit 0 of New IF Flags Octet in UL PDU SESSION INFORMATION (PDU Type 1) indicates if the D1 UL PDCP Delay Result Ind is present (1) or not (0).

In an example, the PDU Type may indicate the structure of the PDU session UP frame. The field takes the value of the PDU Type it identifies; e.g., “0” for PDU Type 0. The PDU type is in bit 4 to bit 7 in the first octet of the frame.

In an example, QoS Monitoring Packet (QMP) may be employed to indicate that the transferred packet is used for QoS monitoring. This parameter may also indicate the presence of the DL Sending Time Stamp in the DL PDU Session Information frame and the presence of the DL Sending Time Stamp Repeated, the DL Receiving Time Stamp, the UL Sending Time Stamp in the UL PDU Session Information frame. If QoS monitoring has not been configured for the involved QoS flow, the QMP may be ignored by the NG-RAN node. A value range may be employed such as {0=not used for QoS monitoring, 1=used for QoS monitoring}.

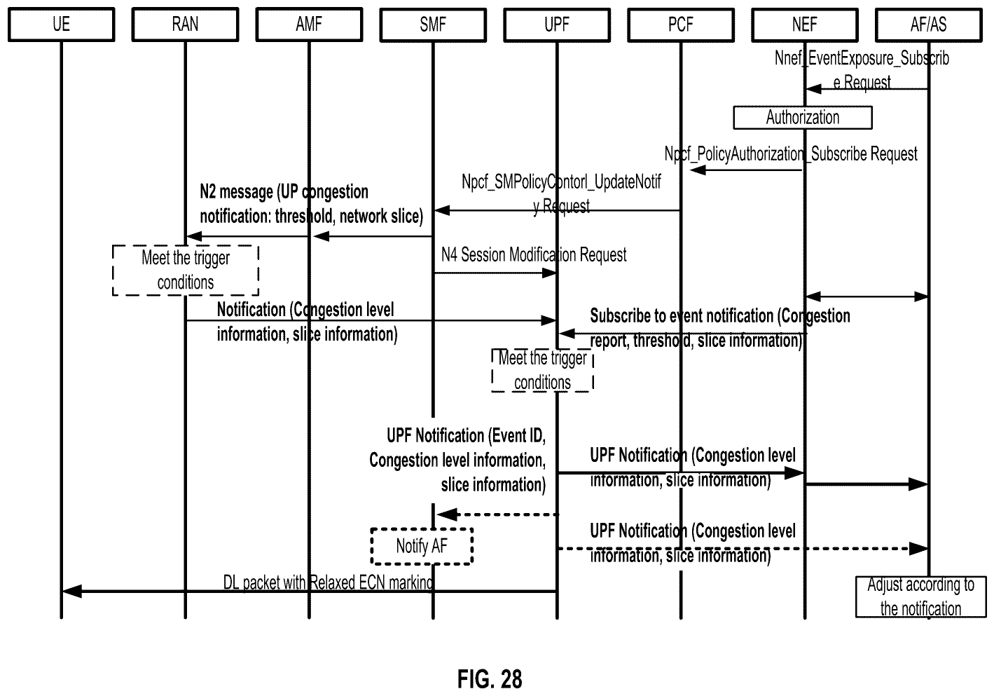

FIG. 28 illustrates an example information exposure configuration and information reporting procedure in a network in accordance with embodiments of the present disclosure. The example embodiment may enhance the signalling performance of the network by configuring the UPF to report status of user plane resources such as congestion, on a per network slice basis wherein the configuration is performed via the NEF directly. Doing so may reduce the probability of increasing the congestion level on user plane and reduce impact on the performance of data transmissions for other network slices, UEs and applications. Furthermore, configuration of the UPF via the NEF directly may avoid signalling via the SMF and hence reduce signalling load and delay. In an example, the UPF may be configured to report user plane congestion. In an example, the NEF may configure the UPF to report user plane congestion per network slice and/or per DNN. In an example, the NEF or the AF may configure the UPF to report an event e.g., the event as described in an example embodiment.

In an example embodiment the NEF (or the AF) may send a message to the UPF. In an example, the sending may be in response to receiving by the NEF the request to subscribe to the event(s) notification. In an example, the message may be to configure the UPF, to subscribe notification of the event from the UPF, and/or the like. In an example, the message may be an Nupf message to subscribe to an event (e.g., user plane congestion per network slice and/or DNN). In an example, the AF or the AS may send the message (the Nupf message) to the UPF.

In an example embodiment, the Nupf services may comprise the following. In an example, an Nupf_EventExposure Service may be employed. In an example, the service may expose UPF related information to other NFs (e.g., a NF consumer node) such as the NEF, SMF, AF, AS, and/or the like. In an example the operation for the service may be employed for notifying events on the PDU Session to the NFs, notifying events on the user plane resource status, user plane congestion information, user plane congestion information per network slice and/or DNN, user plane resource status for a network slice, and/or the like.

In an example, the following events may be notified to the NF consumer node.

1) User plane resource status information: that may comprise resource usage status per network slice, congestion level information per network slice, user plane congestion information, utilization information of user plane resources per network slice, and/or the like.

2) QoS Monitoring for URLLC: the event notification may contain the QoS Monitoring report. In an example, the event notification may comprise the following information: QoS monitoring result e.g., end to end delay for specific QoS flow or for specific PDU session.

In an example, the Nupf_EventExposure_Notify service operation may employ Nupf_EventExposure_Notify operation. This service operation may report the event and information to the NF consumer node that has subscribed e.g, the NEF, the AF, and/or the like. In an example, the AF may subscribe via the NEF.

In an example, the request message for subscription may comprise at least one of an Event ID, a trigger condition, a threshold value for reporting, a PDU session ID, an identifier of the network slice (S-NSSAI), a DNN ID, a UE address (e.g., an identifier, IP address or MAC address).

In an example, event ID may associated with an event such as user plane congestion, RAN congestion, and/or the like. In an example, an event ID may be associated with a combination of the event and an element of the trigger condition or triggering condition.

In an example embodiment, the UPF may determine that the trigger condition is met. In an example, the determining may be based on the notification received from the RAN node as per an example embodiment. In an example, the determining may be based on a UPF internal procedure. In an example, the determining may be based on the PMF procedure and performance measurement (e.g., PLR, delay, RTT, available buffer, available queue, and/or the like) of a tunnel or link between the UPF and the RAN node or between the UPF and the UE. In an example, the UPF may determine the user plane congestion via header of data packets associated with a UE or a PDU session.

In an example, the UPF may determine that user plane resources associated with the network slice are congested. The determining may be based on the PDU session or N4 session ID being associated with the network slice.

In an example, the UPF may determine that user plane resources or connections via a RAN node is congested. In an example, the UPF may determine the RAN node (identify the RAN node) based on an IP address associated with the GTP tunnel. The GTP-U messages may comprise headers that may comprise an identifier of the end point on the RAN node side, or an IP address.

In an example embodiment, the UPF may send a notification to the AF. In an example the sending may be based on the determination of congestion or the trigger condition being met. In an example, the UPF may send a notification to the NEF. In an example, the notification may comprise at least one of the event, the event ID, congestion level information, the S-NSSAI associated with the event (e.g., congestion), the DNN associated with the event, and/or the like.

In an example, the UPF may send a notification to the SMF. In an example, the notification may comprise at least one of the event, the event ID, congestion level information, the S-NSSAI associated with the event (e.g., congestion), the DNN associated with the event, and/or the like. In an example, the SMF may send the notification to the AF via the NEF.

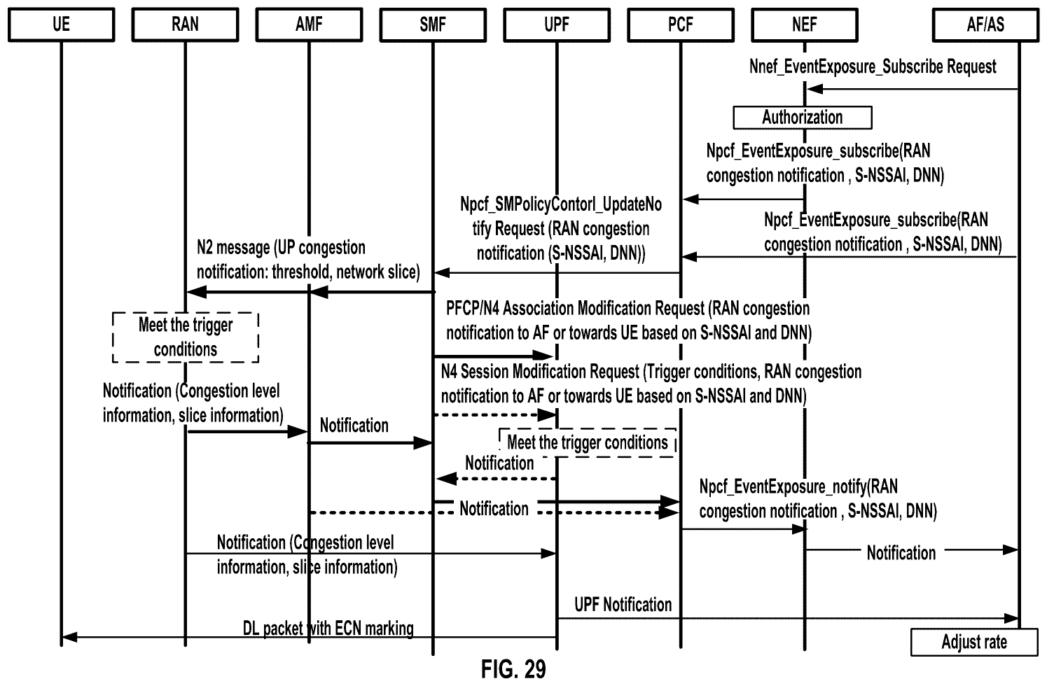

FIG. 29 illustrates an example configuration procedure for information exposure and information reporting in a network in accordance with embodiments of the present disclosure. The example embodiment may enhance the signalling performance of the network by configuring the UPF to report status of user plane resources such as congestion, on a per network slice basis wherein the configuration is performed based on node level signalling. Doing so may reduce the signalling overload by avoiding session level signalling and hence reduce the number of signalling messages as the number of the UEs and session increase. Example embodiment, employs node level configuration via PCF service as well as PFCP association procedures for configuration of the UPF by the SMF. In an example, the UPF may be configured to report user plane congestion. In an example, the NEF may employ event exposure service of the PCF to configure the UPF to report user plane congestion per network slice and/or per DNN. In an example, the NEF or the AF may employ the event exposure service of the PCF to configure the UPF to report an event e.g., the event as described in an example embodiment.

In an example embodiment, the AF may send AFSessionWithQoS Create request to subscribe the events notifications, which may comprise at least one of the user plane congestion, RAN congestion, congestion of user plane resources associated with a network slice, and/or a DNN, and/or the like. In an example, the trigger conditions may comprise the congestion level information wherein a level of congestion exceeds a value or threshold. The AF may send this subscription message to request that 5GS sends the congestion notification for the network slice, the DNN, the UE, a PDU session of the UE, a QoS flow, and/or the like when the trigger conditions are met. The congestion level information may be employed to adjust the codec/rate of transmission to assist in alleviating 5GS congestion. In this event, the trigger conditions may include the follows:
The queue delay, packet loss rate and buffer size are greater than the threshold #A, B, C.
The congestion level.

In an example, the AF may send the subscription request to the NEF, the PCF, the UPF, and/or the like.

In an example embodiment, the NEF (and/or the AF) may send to the PCF a message to request or subscribe to an event exposure (notification). In an example, the message may comprise a message/procedure from an Npcf_EventExposure service. In an example, the service may enable an NF to subscribe and get notified about PCF events for a network slice (S-NSSAI), a DNN, a group of UE(s) or any UE accessing a combination of (DNN, S-NSSAI), and/or the like. In an example, the following service operations may be employed for the Npcf_EventExposure service:
Npcf_EventExposure_Subscribe.
Npcf_EventExposure_UnSubscribe.
Npcf_EventExposure_Notify.

In an example, the Npcf_EventExposure_Subscribe message may comprise the following. The consumer NF may employ this service operation to subscribe to or modify event reporting for the user plane congestion of the network slice (S-NAASI) and/or the DNN, a group of UE(s) or any UE accessing a combination of (DNN, S-NSSAI).

In an example, the Npcf_EventExposure_Subscribe message may comprise at least one of: NF ID, Target of Event Reporting (Internal Group Identifier or indication that any UE accessing a combination of (DNN, S-NSSAI) is targeted, (set of) Event ID(s) (e.g., associated with user plane congestion, RAN congestion, and/or the like associated with the network slice or DNN), Notification Target Address (+Notification Correlation ID) and Event Reporting Information.

In an example, the NEF or the NF consumer may subscribe to the event notification by invoking Npcf_EventExposure to the PCF. The PCF may allocate a Subscription Correlation ID for the subscription and responds to the consumer NF with the Subscription Correlation ID. Event receiving NF ID may identify the NF that may receive the event reporting.

In an example, an Npcf_EventExposure_Unsubscribe service operation may be employed to unsubscribe for the event for a group of UE(s) or any UE accessing a combination of (DNN, S-NSSAI).

In an example embodiment, when the event occurs, an Npcf_EventExposure_Notify service operation may be invoked. In an example, an Npcf_EventExposure_Notify message may be employed to report the event to the consumer e.g., the NEF, the AF, and/or the like that has previously subscribed.

In an example, the Npcf_EventExposure_Notify message may comprise at least one of the event ID (e.g., associated with the event, user plane congestion, RAN congestion, and/or the like), access information associated with the event, the network slice ID (S-NSSAI) associated with the event, DNN ID associated with the event, corresponding UE ID (e.g., GPSI), application ID associated with the event, Notification Correlation Information, time stamp, event specific information, and/or the like.

In an example, when the PCF detects the event subscribed by the NF consumer, the PCF reports the subscribed event together with the Notification Target Address (+Notification Correlation ID) to the Event Receiving NF (e.g., the NEF, AF, and/or the like).

The optional event specific parameter list provides the values that matched for generating the event notification.

In an example, in the case of UE Policies change, this notification may be the result of an implicit subscription of the NEF/AF due to service specific provisioning or application guidance for URSP determination.

In an example embodiment, the Npcf_EventExposure_Notify message may be triggered based on one or more of the following. The PCF may receive from the SMF the notification of congestion for user plane resources associated with the network slice and/or the DNN with congestion level information. In an example, the SMF may receive the notification from the AMF, the UPF, and/or the like. In an example, the PCF may receive the notification from the AMF wherein the AMF receives the notification from the RAN node as described in example embodiments.

In an example embodiment, the AMF may receive from the RAN node the notification of congestion based on the triggering conditions being met in the RAN node. For example, the RAN node may send the notification to the AMF when the trigger conditions are met. In an example, the AMF may send the notification to the SMF. In an example, the SMF may send the notification to the AF. In an example, the SMF may send the notification to the NEF and the NEF may notify the AF with one or more elements of the notification message. In an example, the SMF may send an N4 message to the UPF to instruct the UPF to buffer, suspend data transmission via the congested user plane resources. The SMF may identify an identifier of a PDU session associated with the congested user plane resources and send the N4 message to the UPF comprising an N4 session identifier associated with a session that employs the congested user plane resources. The N4 message may be an N4/PFCP session modification message.

In an example, the SMF may send the events notifications to UPF by N4 session modification request to configure/instruct the UPF to forward the notifications received by RAN to AF. If SMF does not send the trigger conditions to the RAN node, the SMF may send the trigger conditions to the UPF. In an example, the UPF may forward the notifications when the trigger conditions are met. In an example, the SMF may instruct the UPF to mark DL traffic using Relaxed ECN based on notification from RAN.

In an example embodiment, the SMF may receive from the PCF a request for the event notification. The request may be a request message for event exposure. In an example, the request message may comprise at least one of the event (e.g., the user plane congestion notification request, and/or the like as described in an example embodiment), the triggering condition, the access information, the S-NSSAI and/or the DNN ID associated with the user plane resources, the DNN. In an example, the SMF may send a message (e.g., a node configuration message) to the UPF to configure the UPF to report user plane congestion associated with the network slice and/or the DNN. In an example, the message from the SMF to the UPF may be an N4 association message, packet flow control protocol (PFCP) association message, an N4 association request, N4 association setup/establishment request, N4 association update/modification request, a PFCP association request, a PFCP association setup/establishment request, a PFCP association update/modification request, and/or the like. In an example, the node configuration message sent from the SMF to the UPF may comprise the event, event ID, the triggering condition, the network slice ID and/or DNN ID for which the event to be reported, and/or the like.

In an example embodiment, a PFCP association (or N4 association) may be set up between the CP function and the UP function prior to establishing PFCP sessions (or N4 sessions, PDU sessions, and/or the like) on that UP function. In an example, one PFCP association may be setup between a given pair of CP and UP functions, even if the CP and/or UP function exposes multiple IP addresses. A single PFCP association may also be setup between a SMF set (e.g., one or more SMFs) and a UPF. The CP function and the UP function may support the PFCP association setup procedure initiated by the CP function. The CP function and the UP function may additionally support the PFCP Association Setup procedure initiated by the UP function. A CP function may have PFCP Associations set up with multiple UP functions. A UP function may have PFCP Associations set up with multiple CP functions. A CP function or a UP function may be identified by a unique Node ID. A Node ID may be set to an FQDN or an IP address. When set to an IP address, the node ID may indicate that the CP/UP function may expose one IP address for the PFCP Association signalling. The PFCP entities may accept any new IP address allocated as part of F-SEID other than the one(s) communicated in the Node Id.

In an example, the CP function may be at least one of the SMF, the PCF, the NEF, the AMF, and/or the like. In an example, the UP function may be at least one of the UPF, P-GW, SGW, RAN node, and/or the like.

In an example, when a PFCP Association is established with a UP function, the CP function:
may provision node related parameters (i.e. parameters that apply to all PFCP sessions) in the UP function, if any, e.g., PFDs;
may provision the UP function with the list of features (affecting the UP function behaviour) the CP function supports, if any, e.g., support of user plane congestion reporting, support of load and/or overload control, and/or the like.
may check the responsiveness of the UP function using the Heartbeat procedures.
may establish PFCP sessions on that UP function;
may refrain from attempting to establish new PFCP sessions on the UP function, if the UP function has indicated that user plane resources associated with the UPF are congested, user plane resources of the network slice on the UPF are congested, the UPF may shut down gracefully, and/or the like.

In an example, when a PFCP Association is established with a CP function, the UP function:
may update the CP function with the list of features it supports;
may update the CP function with its load and/or overload control information, if load and/or overload control is supported by the CP and UP functions;
may update the CP function with congestion level information associated with user plane resources/connections, congestion level information (of user plane resources) associated with a network slice and/or DNN, and/or the like.
may accept PFCP Session related messages from that CP function (unless prevented by other reasons, e.g., user plane congestion, overload, and/or the like);
may check the responsiveness of the CP function using the Heartbeat procedures.
may indicate to the CP function if it will shut down within a graceful period and, when possible, if it fails and becomes out of service;
may report UE IP address usage information to the CP function, if UE IP addresses are allocated by the UP function and the UE IP Address Usage Reporting feature is supported by the CP function.

In an example, the UPF may report to a CP function (such as the SMF, the NEF, the PCF, and/or the like), an identifier of the RAN node (RAN node ID) that has established a connection (e.g., a tunnel, GTP-U tunnel, and/or the like) with the UPF. In an example, the identifier (e.g., the RAN node ID) may be an address (e.g., IP address, MAC address, tunnel end point identifier, and/or the like) of the GTP tunnel, an identifier of a base station, an identifier of a cell of the base station (or the RAN node), and/or the like. In an example, one or more addresses may be associated with the tunnel. In an example, the address may be common among tunnels that connect or terminate at the same RAN node. In an example, the report may be triggered by establishment of a (new) connection or tunnel with a new RAN node. In an example, the report may comprise congestion level information associated with the network slice and/or the DNN for user plane resources of the RAN node. The report may comprise at least one of the RAN node ID, the S-NSSAI, the DNN, the congestion level information, and/or the like.

In an example embodiment, per GTP-U Path QoS Monitoring (GPQM) procedure may be employed by the network. In an example, the UPF may set the GPQM feature flag in a UP Function Features IE if it supports per GTP-U Path QoS monitoring. In an example, GTP-U path monitoring may comprise the following. If the UPF is known to support this feature (e.g., by the UP Function Features IE), the SMF may request the UPF to measure the packet delay for transport paths towards remote GTP-U peers during a PFCP association setup or a PFCP association update procedure, by provisioning GTP-U Path QoS Control Information including:
the identification of the GTP-U paths to be monitored, e.g.:
the IP destination address of one or more remote GTP-U peers, and if available, the network instance used to reach each remote GTP-U peer and the DSCP value(s) to measure the packet delay; or
the interface type(s) (i.e. N9 and/or N3) of the GTP-U paths;
the values of the DSCP in the TOS/Traffic Class field to measure the packet delay, if available;
the conditions and QoS parameters for the UPF to report measurements to the SMF, e.g., one or more of:
immediate report;
periodic report, with the reporting time period; and/or
event triggered report, when the average, minimum and/or maximum packet delay on a GTP-U path exceeds corresponding thresholds.

In an example embodiment, per GTP-U Path congestion Monitoring (GPCM) procedure may be employed by the network. In an example, the UPF may set the GPCM feature flag in the UP Function Features IE if it supports per GTP-U Path congestion monitoring. In an example, GTP-U path monitoring may comprise the following. If the UPF is known to support this feature (e.g., by the UP Function Features IE), the SMF may request the UPF to detect congestion information received from the RAN node during a PFCP association setup or a PFCP association update procedure, by provisioning GTP-U path congestion control information including:
the identification of the GTP-U paths to be monitored, e.g.:
the IP destination address of one or more remote GTP-U peers, and if available, the network instance used to reach each remote GTP-U peer and the DSCP value(s) to measure or determine the congestion information; or
the interface type(s) (i.e. N9 and/or N3) of the GTP-U paths;
the values of the DSCP in the TOS/Traffic Class field to measure or detect the congestion information, if available;
the conditions and congestion information parameters for the UPF to report measurements to the SMF, e.g., one or more of:
immediate report;
periodic report, with the reporting time period; and/or
event triggered report, when the average, minimum and/or maximum packet delay on a GTP-U path exceeds corresponding thresholds as indicated by the triggering conditions.

If so instructed, the UPF may perform a determination of congestion or an estimation of the RTT for the GTP-U paths requested to be monitored, by sending Echo Request messages (with each requested DSCP value, if any) and measuring the time that elapses between the transmission of the Echo Request message and the reception of the Echo Response message. The UPF may compute the packet delay by adding RTT/2 and the UPF internal processing time, thus the measured delay represents an estimated elapsed time for the GTP-U path (since a user plane packet entered the UPF and its reception by the next downstreams or upstreams GTP-U peer). The UPF may send QoS reports to the SMF by including GTP-U Path QoS Report IE(s) in a PFCP Node Report Request message. If the GTP-U paths to be monitored are identified by their interface types (e.g., N9 and/or N3), the UPF may monitor all GTP-U paths of all PFCP sessions established with a FAR including a matching Destination Interface Type. For event triggered reporting, the UPF may send a first report when a reporting threshold is exceeded and a minimum waiting time may be applied for the subsequent report for the same type of measurement (e.g., maximum packet delay) and the same remote GTP-U peer (if the threshold is exceeded after the waiting time).

In an example, the UPF may send a message to the RAN node via a GTP-U message, GTP signalling message, PMFP message, and/or the like to request congestion information associated with the network slice and/or the DNN. In an example, the UPF may receive the congestion information from the RAN node.

In an example embodiment, the PFCP association setup procedure may comprise the following. PFCP Association Setup may be a node level procedure. The PFCP Association Setup procedure may be used to setup a PFCP association between the CP function and the UP function, to enable the CP function to use the resources of the UP function subsequently, e.g., establish PFCP Sessions. The setup of a PFCP association may be initiated by the CP function or the UP function. The CP function and the UP function may support the PFCP association setup initiated by the CP function. The CP function and the UP function may support the PFCP Association Setup initiated by the UP function. The PFCP Association Setup may be initiated by the CP Function: the CP function may initiate the PFCP Association Setup procedure to request to setup a PFCP association towards a UP function prior to establishing a first PFCP session on this UP function. The CP function may retrieve an IP address of the UP function to send the PFCP Association Setup Request, and may send a PFCP Association Setup Request to the UP function comprising at least one of: the Node ID of the CP function; the list of optional features the CP function supports which may affect the UP function behaviour, the PFCP Session Retention Information IE to request the UP function to retain all or part of the existing PFCP sessions if a PFCP association already exists in the UP function for the same Node ID, and/or the like. The CP function may initiate PFCP Session related signalling procedures toward a UP function after it receives the PFCP Association Setup Response with a successful cause from the UP function. The CP function may determine whether the UP function supports Sxa, Sxb, Sxc and/or combined Sxa/Sxb by local configuration or via DNS if deployed. In an example, the UP Function behaviour when receiving a PFCP Association Setup Request may comprise the following. The UP function:
if the request is accepted: may store the Node ID of the CP function as the identifier of the PFCP association; may send a PFCP Association Setup Response that may comprise: a successful cause; its Node ID; information of all supported optional features in the UP function; one or more UE IP address Pool Information IE which contains a list of UE IP Address Pool Identities per Network Instance, S-NSSAI and IP version; the NF Instance ID of the UPF if available. In an example, the UP may send a PFCP Version Not Supported Response if the PFCP header of the request indicates a PFCP protocol version that is not supported by the UP function; otherwise, may send a PFCP Association Setup Response with an appropriate error cause if the request is rejected. If the PFCP Association Setup Request contains a Node ID for which a PFCP association was already established, the UP function may: proceed with establishing the new PFCP association (regardless of the Recovery Timestamp received in the request), overwriting the existing association; retain the PFCP sessions that were established with the existing PFCP association and that are requested to be retained, if the PFCP Session Retention Information IE was received in the request; otherwise, delete the PFCP sessions that were established with the existing PFCP association;

In an example embodiment, the PFCP Association Update Procedure may be a node level procedure. The PFCP Association Update procedure may be employed to modify an existing PFCP association between the CP function and the UP function. It may be initiated by the UP function or by the CP function to update the supported features or available resources of the UP function.

In an example embodiment the PFCP association message (e.g., the PFCP association setup message, the PCFP association update message, and/or the like) may comprise the configuration information for reporting of user plane congestion information. The user plane congestion information may be associated with the network slice, the DNN, and/or the like. In an example, the PFCP association message may comprise the event (as described in example embodiments), the event ID, the triggering condition, the network slice ID, the DNN, and/or the like. In an example, the configuration message may be employed to instruct or configure the UPF to report RAN congestion or user plane congestion to the AF, to the NEF, and/or the like. In an example, the report of RAN congestion or user plane congestion may be per S-NSSAI, per RAN node, per DNN, and/or the like.

In an example embodiment, the NEF may receive the Nnef_eventExposure_subscribe message from the AF or the AS that may comprise the request to report user plane congestion or RAN congestion per network slice, or DNN, S-NSSAI, DNN, triggering condition, and/or the like. In an example, the NEF may receive from the AF or the AS a request to be notified of the event (e.g., the user plane congestion or RAN congestion, and/or the like). In an example, the request may be the Nnef_eventExposure_subscribe message. In an example, the NEF may send to the PCF the Npcf_eventExposure subscribe message that may comprise the request to report user plane congestion or RAN congestion per access information, per network slice, or per DNN, S-NSSAI, DNN, triggering condition, and/or the like.

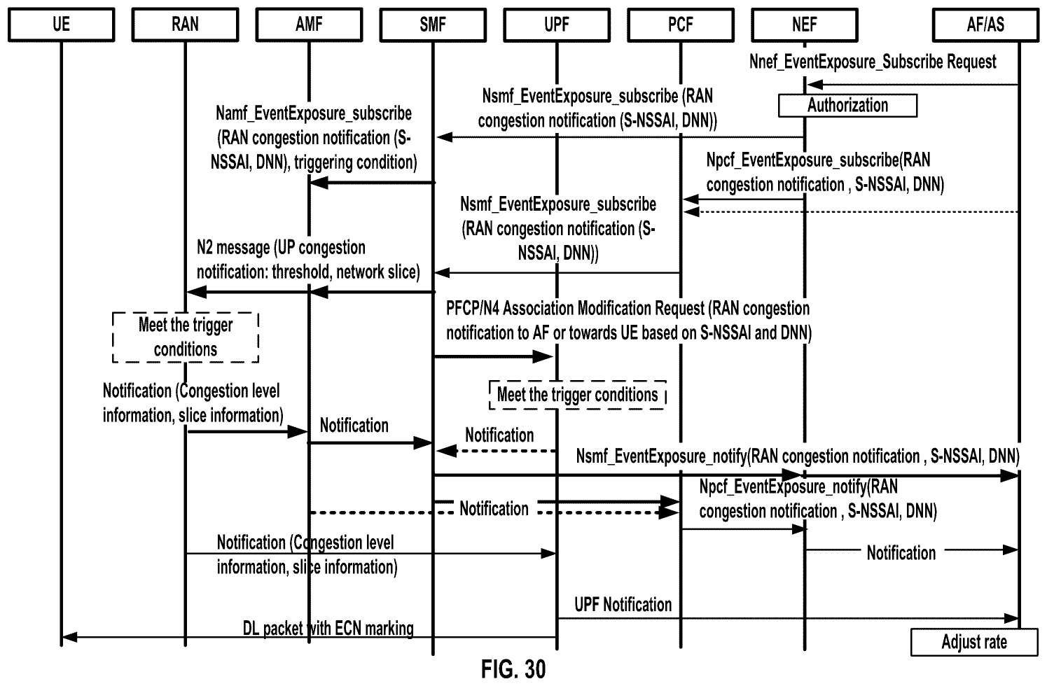

In an example as depicted in FIG. 30, Event exposure services of SMF and/or the AMF may be employed to configure the network for notification of user plane congestion (or notification of the event as in example embodiments). The example embodiment may enhance the signalling performance of the network by configuring the network to report status of user plane resources such as congestion, on a per network slice basis wherein the configuration is performed via event exposure services offered by the AMF, and the SMF. Doing so may reduce the number of signalling messages for the configuration and hence reduce signalling load and delay. In an example, the NEF may send to the SMF an Nsmf_eventExposure_subscribe message that may comprise the request to report user plane congestion or RAN congestion per network slice, or DNN, S-NSSAI, DNN, triggering condition, and/or the like. In an example, the NEF may send to the AMF, an Namf_eventExposure_subscribe message that may comprise at least one of the request to report user plane congestion or RAN congestion per access information, per network slice, or per DNN, S-NSSAI, DNN, triggering condition, and/or the like.

In an example, the AMF in response to receiving the Namf_eventExposure_subscribe message, may configure the RAN node to report user plane congestion as per an example embodiment. In an example, the AMF may receive the notification (e.g., the congestion notification as described in example embodiments) from the RAN node. The AMF may send an Namf_eventExposure_notify message to the NEF or the AF. The NEF may send the notification to the AF or the AS.

In an example as depicted in FIG. 30, the SMF in response to receiving the Nsmf_eventExposure_subscribe message, may configure the UPF node to report user plane congestion as per an example embodiment (e.g., via PFCP association procedures, the PFCP session procedures, and/or the like). In an example, the SMF may receive the notification (e.g., the congestion notification as described in example embodiments) from the UPF node. The SMF may send an Nsmf_eventExposure_notify message to the NEF or the AF. The NEF may send the notification to the AF or the AS.

In an example, the PCF in response to receiving the Npcf_eventExposure_subscribe message, may send a message to the SMF to request notification for the event. In an example, the SMF may configure the UPF node to report user plane congestion as per an example embodiment (e.g., via PFCP association procedures, the PFCP session procedures, and/or the like). In an example, the SMF may receive the notification (e.g., the congestion notification as described in example embodiments) from the UPF node. The SMF may send a message to the PCF to notify of user plane congestion, user plane congestion of resources associated with the network slice, the DNN, and/or the like. The PCF may send the Npcf_eventExposure_notify message to the NEF or the AF. The NEF may send the notification to the AF or the AS.

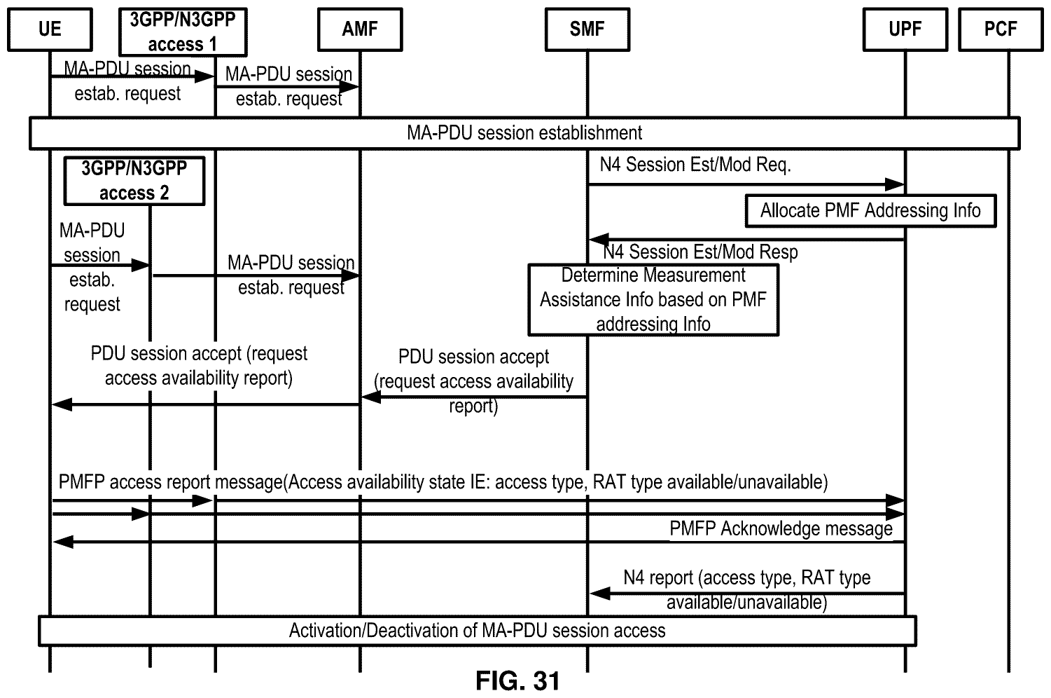

FIG. 31 illustrates an example PDU session establishment request procedure in a network in accordance with embodiments of the present disclosure. The PDU session establishment procedure may be performed as depicted and described in FIG. 12. When a MA-PDU session is to be established, the PDU session establishment request message may be sent over the 3GPP access, underlay access or over the non-3GPP access. In an example, the UE may provide request type as “MA-PDU Request” in UL NAS Transport message and its ATSSS Capabilities in PDU Session Establishment Request message. The “MA-PDUMA-PDU Request” Request Type in the UL NAS Transport message may indicate to the network that this PDU Session Establishment Request is to establish a new MA-PDU Session and to apply the ATSSS-LL functionality, or the MPTCP functionality, or both functionalities, for steering the traffic of this MA-PDU session. In an example, if the UE requests an S-NSSAI and the UE is registered over one or more accesses, it may request an S-NSSAI that is allowed on the one or more accesses.

The UE may send the MA-PDU session establishment request to an AMF via a base station. In an example, if the AMF supports MA-PDU sessions, then the AMF may select an SMF which supports MA-PDU sessions. In an example, the AMF may inform the SMF that the request is for a MA-PDU Session by including “MA-PDU Request” indication and, in addition, it may indicate to SMF whether the UE is registered over one or more accesses. If the AMF determines that the UE is registered via one or more accesses but the requested S-NSSAI is not allowed on the one or more accesses, then the AMF may reject the MA-PDU session establishment. The AMF may reject the PDU Session Establishment request if the request is for a LADN.

In an example, the SMF may retrieve, via session management subscription data, the information whether the MA-PDU session is allowed or not. In an example, if dynamic PCC is to be used for the MA-PDU Session, the SMF may sends an “MA-PDU Request” indication to the PCF in the SM Policy Control Create message and the ATSSS Capabilities of the MA-PDU session. The SMF may provide the currently used Access Type(s) and RAT Type(s) to the PCF. The PCF may determine/decide whether the MA-PDU session is allowed or not based on operator policy and subscription data. In an example, the PCF may provide PCC rules that include MA-PDU session control information. In an example, from the received PCC rules, the SMF may derive/determine (a) ATSSS rules, which may be sent to UE for controlling the traffic steering, switching and splitting in the uplink direction, and (b) N4 rules, which will be sent to UPF for controlling the traffic steering, switching and splitting in the downlink direction. If the UE indicates the support of ATSSS-LL Capability, the SMF may derive the Measurement Assistance Information (MAI).

In an example, the SMF may establish the user-plane resources over the one or more accesses such as 3GPP access, N3GPP access, underlay access, and/or the like, or e.g., over the access where the PDU session establishment request was sent on.

In an example, the N4 rules derived by the SMF for the MA-PDU session may be sent to UPF and one or more N3 UL CN tunnels info are allocated by the UPF. If the ATSSS LL functionality is supported for MA-PDU Session, the SMF may instruct the UPF to initiate performance measurement for this MA-PDU Session. If the MPTCP functionality is supported for the MA-PDU Session, the SMF may instruct the UPF to activate MPTCP functionality for this MA-PDU Session. In an example, the UPF may allocate addressing information for the Performance Measurement Function (PMF) in the UPF. If the UPF receives from the SMF a list of QoS flows over which access performance measurements may be performed, the UPF may allocate different UDP ports or different MAC addresses per QoS flow per access. In an example, the UPF may send the addressing information for the PMF in the UPF to the SMF. If UDP ports or MAC addresses are allocated per QoS flow and per access, the UPF may send the PMF IP address information and UDP ports with the related QFI to the SMF in the case of IP PDU sessions and sends the MAC addresses with the related QFI to the SMF in the case of Ethernet PDU sessions.

In an example, if the message from the SMF instructs the UPF to activate MPTCP functionality, the UPF may allocate the UE link-specific multipath addresses/prefixes. In an example, the UPF may send the link-specific multipath addresses/prefixes and MPTCP proxy information to the SMF. In an example, for the MA-PDU session, the SMF may include an MA-PDU session accepted indication in the Namf_Communication_N1N2MessageTransfer message to the AMF and indicates to AMF that the N2 SM Information included in this message should be sent over 3GPP access. The AMF may mark the PDU session as MA-PDU session based on the received MA-PDU session accepted indication.

In an example, the UE may receive a PDU session establishment accept message, which indicates to UE that the requested MA-PDU session was successfully established. This message may include the ATSSS rules for the MA-PDU session, which were derived by the SMF. If the ATSSS-LL functionality is supported for the PDU Session, the SMF may include the addressing information of PMF in the UPF into the measurement assistance information (MAI). If the MPTCP functionality is supported for the MA-PDU Session, the SMF may include the link-specific multipath addresses/prefixes of the UE and the MPTCP proxy information.

In an example embodiment, the MAI may comprise the addressing information indicating the PMF addressing information. In an example, the MAI may comprise an access availability report indication (AARI). The network may request the UE to report access availability for one or more accesses of the MA-PDU session by providing the AARI in the MAI via the PDU session accept message, a NAS message, PCO, ePCO and/or the like.

In an example embodiment, the SMF may send to the AMF the PDU session accept message that may comprise the MAI. In an example, the MAI may comprise the addressing information, the AARI, and/or the like.

In an example embodiment, the AMF may send to the UE (wireless device) a PDU session accept message (e.g., a NAS message) that may comprise the MAI. In an example, the MAI may comprise the addressing information, AARI, and/or the like.

In an example, if the SMF was informed that the UE is registered over one or more accesses, then the SMF may initiate the establishment of user-plane resources over the one or more accesses too. In an example, the SMF may sends an Namf_Communication_N1N2MessageTransfer to the AMF including N2 SM Information and indicates to AMF that the N2 SM information should be sent over non-3GPP access, 3GPP access or underlay access. After this step, the one or more N3 tunnels between the PSA and RAN/AN are established.

Based on receiving the AARI, the UE may send, to the network, an indication of availability of access (e.g., an access availability state information element (IE), as will be discussed in greater detail below). The availability of access may correspond to a specific component of an MA-PDU session (e.g., leg, access leg, child session, etc.). The availability of access may correspond to a particular RAT type. Accordingly, availability of access may be reported on a per-leg (per-child) and/or per-RAT type basis.

For example, an MA-PDU session may comprise multiple accesses, and at least two of the accesses may correspond to a same access type (e.g., 3GPP access type). As an example, a first access may correspond to a first RAT type of the 3GPP access type (e.g., new radio (NR)), and a second access may correspond to a second RAT type of the 3GPP access type (e.g., LTE). The UE may indicate the availability of the first access (via NR) and/or the availability of the second access (via LTE). Based on the UE's indication of access availability, the network may be able to determine not only whether access is available to the UE via 3GPP, but more particularly whether access is available to the UE via 3GPP NR and/or whether access is available to the UE via 3GPP LTE.

In an example, the purpose of the access availability state information element is to provide information about availability of access. In an example, the access may comprise an access leg, a child session of the MA-PDU session and/or the like. In an example, the access of the MA-PDU session may comprise an access of the MA-PDU session over 3GPP access type with AT type 1, 3GPP access type with RAT type 2, N3GPP access with AN type 1, underlay access with RAT or AN type 1, underlay access with underlay network 1 (e.g., underlay network identifier such as PLMN ID, SNPN ID, NPN ID, and/or the like).

The access availability state information element may be coded as shown below as an example representation:

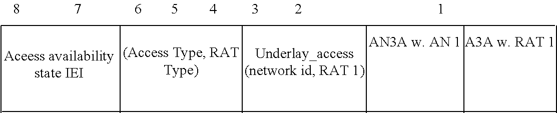

### Access Availability State Information Element

### Access Availability State Information Element

Availability over 3GPP access (A3A w. RAT 1) (octet 1, bit 1)

| Bit | |
|---|---|
| 1 | |
| 0 | 3GPP access w. RAT1 not available |
| 1 | 3GPP access w. RAT1 available |

Availability over non-3GPP access (AN3A w. AN type 1) (octet 1, bit 2)

| Bit | |
|---|---|
| 2 | |
| 0 | non-3GPP w. AN 1 access not available |
| 1 | non-3GPP w. AN 1 access available |

Availability over underlay access (network ID, RAT type)

| | |
|---|---|
| 0 | underlay access (NID, RAT Type) not available |
| 1 | underlay access (NID, RAT type) available |

In an example, when the corresponding bit for (access type, RAT type) is 0, it may indicate that the corresponding access type with RAT type is not available. In an example, when the corresponding bit for (access type, RAT type) is 1, it may indicate that the corresponding access type with RAT type is available.

In an example, in response to receiving the AARI from the network, the UE may perform access availability or unavailability report procedure. In an example embodiment as depicted in FIG. 22 and FIG. 30, access availability or unavailability report procedure may be employed. The purpose of the access availability or unavailability report procedure is to enable the UE to inform the UPF about availability or unavailability of one or more accesses of the MA-PDU session. In an example, the purpose of the access availability or unavailability report procedure is to enable the RAN node to inform the UPF about availability or unavailability of an accesses of the MA-PDU session served by the RAN node or served by a cell of the RAN node.

In an example, access availability or unavailability report procedure initiation may comprise the following. In order to initiate an access availability or unavailability report procedure over the access of an MA-PDU session, the UE or the RAN node may allocate a EPTI value and may create a PMFP ACCESS REPORT message. In an example the PMFP access report message may comprise the access availability state information element as described in an example embodiment.

In the PMFP ACCESS REPORT message, the UE may set the EPTI IE to the allocated EPTI value. The UE or the RAN node may send the PMFP ACCESS REPORT message over the access of the MA-PDU session and may start a timer T102.

In an example, upon reception of the PMFP ACCESS REPORT message, the UPF may create a PMFP ACKNOWLEDGEMENT message. In the PMFP ACKNOWLEDGEMENT message, the UPF may set the EPTI IE to the EPTI value in the PMFP ACCESS REPORT message. The UPF may send the PMFP ACKNOWLEDGEMENT message over the access of the MA-PDU session via which the PMFP ACCESS REPORT message was received. Upon reception of a PMFP ACKNOWLEDGEMENT message with the same EPTI as the allocated EPTI value, the UE or RAN node may stop the timer T102.

In an example, the UPF may receive the PMFP access report message comprising an indication that a first access of the MA-PDU session associated with the first access type and the first RAT type is not available. In an example embodiment, when the UPF receives the PMFP access report message, the UPF may send an N4 message to the SMF. The N4 message may be an N4 report message indicating that the first access of the MA-PDU session associated with the first access type, and the first RAT type is not available. In an example, the PMFP access report procedure may be employed by the network to release or deactivate the resources for accesses that are not available. The SMF may inform the AMF of availability of an access e.g., to deactivate or activate an access of the MA-PDU session. The SMF upon receiving the N4 report message, may determine to deactivate the first access of the MA-PDU session associated with the first access type and the first RAT type. In an example, the SMF may inform the AMF via an N11 message that the first access of the MA-PDU session is not available.

In an example embodiment, when a second access of the MA-PDU session is deactivated, when the UE determines that the first access type and second RAT type associated with the second access becomes available, the UE may send a PMFP access report message to the UPF. In an example, the UPF may receive the PMFP access report message comprising an indication that a second access of the MA-PDU session associated with the first access type and the second RAT type is available. In an example embodiment, when the UPF receives the PMFP access report message, the UPF may send an N4 message to the SMF. The N4 message may be an N4 report message indicating that the second access of the MA-PDU session associated with the first access type, and the second RAT type is available. The SMF upon receiving the N4 report message, may determine to activate the second access of the MA-PDU session associated with the first access type and the second RAT type. In an example, the SMF may inform the AMF via an N11 message that the second access of the MA-PDU session is available.

In an example embodiment, the UE may receive from a network element such as an MME, PGW, SGW, SMF, and/or the like, a measurement assistance information (MAI) parameter comprising an access availability report indication (AARI) for the multi-access packet data unit (MA-PDU) session. In an example, the UE may send to the UPF and based on the AARI, an access report message (e.g., the PMFP access report message comprising an availability state for a first access of the MA-PDU session. In an example, the access report may comprise at least one of: a first access type associated with the first access of the MA-PDU session, and a first RAT type of the first access type. In an example, the UE may receive from the network element a message comprising an activation of the first access of the MA-PDU session. In an example, the UE may receive from the network element, a deactivation of the first access of the MA-PDU session. In an example, the access report message may comprise an availability state of at least one of: a first RAT type of a first access type associated with the MA-PDU session, a second RAT type of the first access type, and/or the like. In an example, the UE may receive from the network element, a message indicating an activation or a deactivation of at least one of: the first RAT type of the first access type, or the second RAT type of the first access type.

In an example embodiment, the MAI may be transmitted to the UE via a downlink NAS transport message (DL NAS transport). In an example, the DL NAS transport message may be sent by the AMF or the MME to the base station. In an example, the base station may transmit the DL NAS transport message via RRC signalling or direct transfer. In an example, the DL NAS transport message may comprise the PCO, ePCO, and/or the like. In an example, the PCO, ePCO, and/or the like may comprise at least one of the MAI, PMF addressing information, and/or the like.

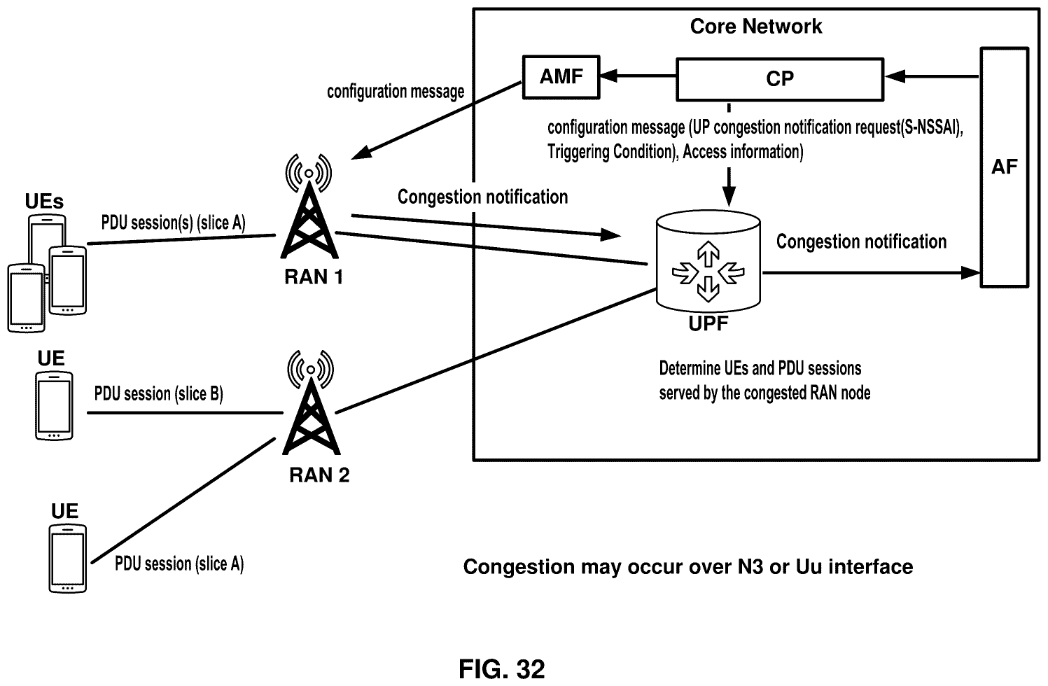

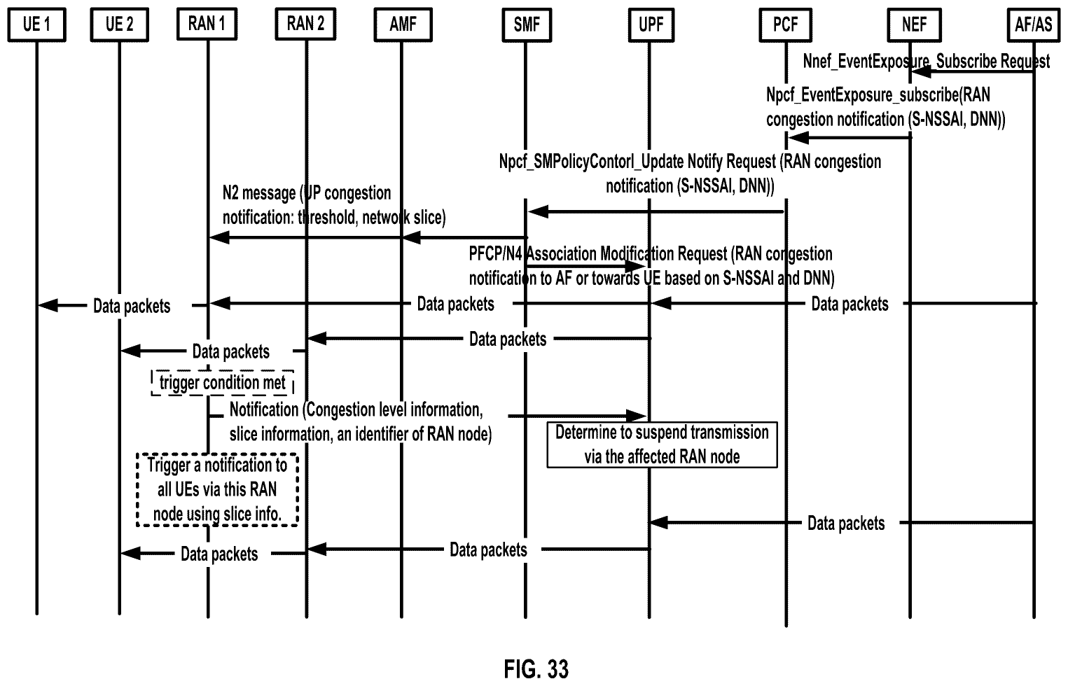

FIG. 32 and FIG. 33 depict an example implementation of an embodiment. In an example embodiment, one or more UEs may register with a network via two RAN nodes: RAN 1, and RAN 2. In an example, the UEs may establish one or more PDU sessions via RAN 1 and RAN 2 that may employ user plane resources of slice A and user plane resources of slice B. In an example, user plane resources of slice A in RAN 1 may experience congestion. In an example, the notification message, or congestion notification message may comprise the network slice ID e.g., slice A and an identifier of the RAN node e.g., RAN 1. In an example, indication of the RAN node that experienced the congestion of slice A user plane resources may be employed by the network such as the UPF to take action on UEs and PDU sessions that employ RAN 1 and may not impact transmissions via RAN 2.

In an example, as depicted in FIG. 33, UEs may receive data packets via RAN 1 and RAN 2. Upon detection and notification of congestion based in the triggering condition being met, the RAN node may send the notification to the UPF. The notification may indicate the RAN node ID or an information element by which the UPF may determine the RAN node that is experiencing congestion for the user plane resources of the network slice (S-NSSAI). The UPF may determine to suspend transmission of data packets and notify the AF. Upon alleviation of the congestion, the RAN node may send the notification indicating the stop of the congestion. The UPF may resume transmission of the data packets via the RAN 1 base station. In an example, the notification may comprise a timer such as a backoff timer indicating a value for a time duration that the data transmission may be suspended. Upon elapse of the time, the UPF may resume transmission of the data packets.

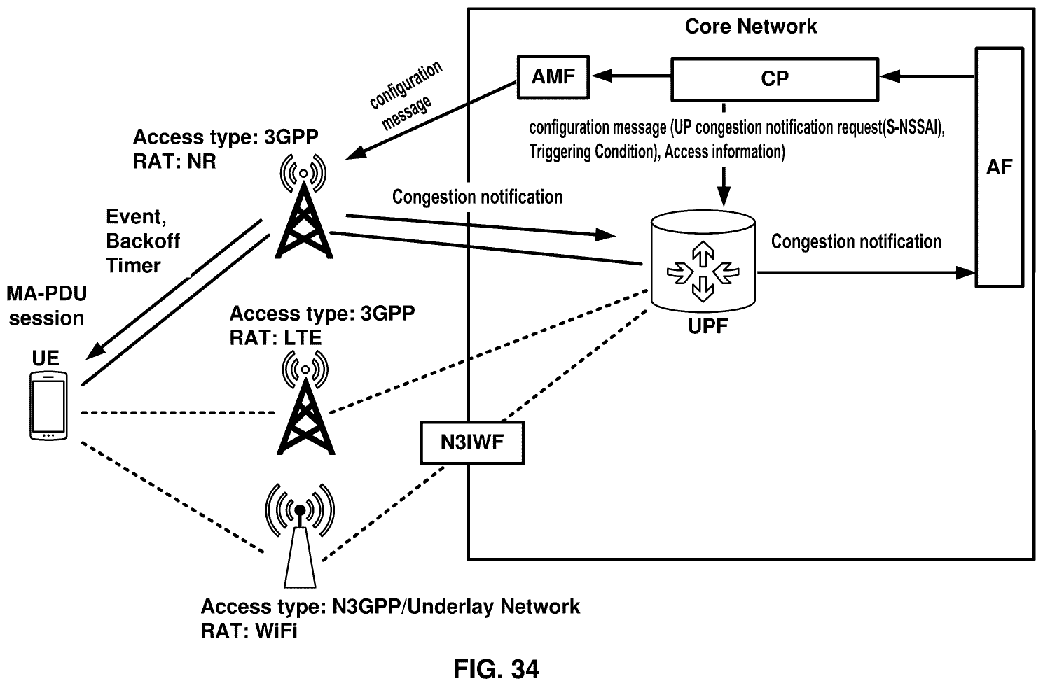

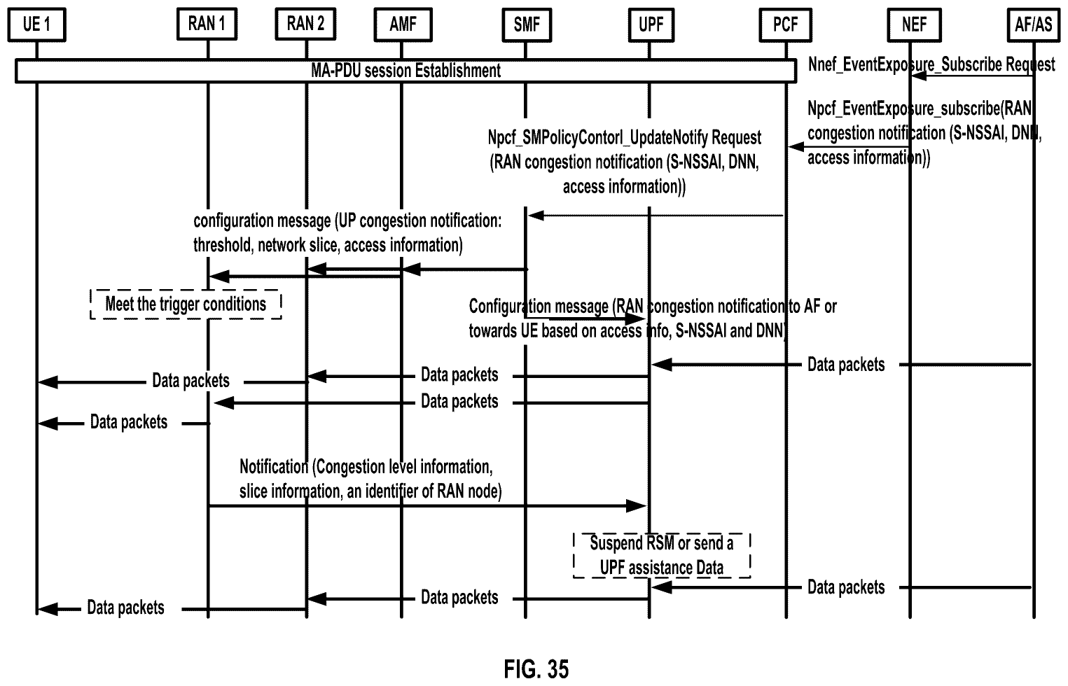

FIG. 34 and FIG. 35 depict an example implementation of an embodiment. A UE may establish a MA-PDU session via one or more accesses. The one or more accesses may be 3GPP or N3GPP with RAT 1, 3GPP or N3GPP with RAT 2, and/or the like. When a RAN node is configured to send a notification of congestion per network slice or access information, the RAN node may send the congestion notification to the UE or to the UPF. In an example, the RAN node may send to the UPF an indication of access unavailability. In an example, the UE or UPF may determine to suspend transmission, change steering policy of traffic, or portion of transmission via one or more accesses of the MA-PDU session based on an element of the event (e.g., congestion level information, slice information, and/or the like).

In an example, as depicted in FIG. 35, the UE may establish the MA-PDU session. In an example, based on a request from the AF or based on a policy decision from the PCF, the network may configure the RAN node and the UPF to report the event (as described in the example embodiments e.g., the user plane congestion of resources associated with the network slice and/or the DNN, the user plane congestion associated resources of an access path of the MA-PDU session, and/or the like). In an example, the configuration message may be sent from the PCF to SMF. The configuration message may be sent from the SMF to the UPF. The configuration message may be sent from the SMF to the RAN node via the AMF. In an example, the configuration message may comprise the event, the triggering conditions, the S-NSSAI, the DNN, the access information. In an example, the access information may comprise the access type and the RAT. In an example, the RAN node may send a notification to the UPF when a triggering condition is met. In an example embodiment, the MA-PDU session may employ a redundant steering mode (RSM). In an example, data packets may be transmitted to the UE via two access paths of the MA-PDU session. In an example, the UPF may receive the notification and determine that an access path (e.g., access via RAN 1 in example FIG. 35) of the MA-PDU session being congested, unavailable, and/or the like. In an example, the UPF may determine to send the assistance data IE to the UE via the access path of RAN 2. In an example, the UPF may determine to suspend transmission of data packets via RAN 1 node. In an example, if the notification comprised the backoff timer, the UPF may resume the RSM mode after a time duration of the backoff timer. For example, the UPF may receive the notification of congestion and the back off timer. The UPF may start a timer based on a value of the backoff timer and suspend the RSM mode. Upon expiry of the timer the UPF may resume the RSM mode and reset the timer. In an example, the UPF may resume the RSM mode based on receiving a second notification indicating stop of user plane congestion that indicates that congestion is alleviated.

In an example, the implementation of an embodiment may be based on PMF procedures and corresponding protocols such as PMFP. In an example embodiment, when redundant steering mode (RSM) is employed for the MA-PDU session, the PCC rules sent from the PCF to the SMF, may indicate that the UE and/or the UPF may be allowed to suspend the RSM. In an example, temporary suspension of the RSM may not require the ATSSS rules to be updated in the UE and/or the UPF. In an example, when RSM mode is activated or deactivated, the ATSSS rules may be updated via the N4 interface in the UPF and may be updated in the UE via NAS messages. In an example, temporary suspension and resume of the RSM may not require updates of the ATSSS rules for the RSM. The RSM may be suspended when there is user plane congestion. In an example, the user plane congestion may be associated with the network slice and/or a RAN node that may employ the network slice resources. The user plane congestion may be over N3 interface, and/or over Uu interface.

In an example embodiment, the SMF may send a message to the AMF based on at least one of: receiving the PCC rules indicating that the UE and/or UPF may suspend the RSM mode, receiving a request from the AF via the NEF to report the event (such as user plane congestion for the network slice, RAN congestion for the network slice, and/or the like. In an example, the message sent from the SMF to the AMF may be the PDU session accept message for the MA-PDU session. In an example, the message may be a NAS message, SM-NAS message, and/or the like. In an example, the message may comprise access information associated with the access of the MA-PDU session for which event report may be requested.

In an example, the message may comprise the MAI. In an example embodiment, the MAI may comprise a notification request for the event e.g., request or indication for reporting of RAN congestion, user plane congestion, access availability or unavailability and/or the like. In an example, the MAI may comprise at least one of a RAN congestion notification request, access availability request, and/or the like. In an example, the MAI may comprise the network slice identifier (network slice ID, S-NSSAI, and/or the like), and the DNN ID associated with the event. In an example embodiment, the AMF or the mobility management entity node (MME) may determine to send the N2 message to the RAN node to configure the RAN node to report the event. In an example, the N2 message may comprise an element of the MAI such as the RAN congestion notification request, access availability request, and/or the like. In an example, the N2 message may comprise the addressing information.

In an example embodiment, the RAN node may determine that the trigger condition is met. In an example, the RAN node may send the notification to the UPF as described in an example embodiment. In an example, the notification may comprise the event, a timer value such as a back-off timer parameter, and/or the like. In an example, when a network node or an entity determines to suspend data transmission or suspend the RSM mode, or update assistance data, the back-off timer parameter may be employed by the network node or entity to determine a resume upon expiry of the timer as set by a value of the back-off timer.

In an example embodiment, the UPF may determine to suspend the RSM. In an example, in response to the determining, the UPF may send a notification message to the UE indicating suspension of the RSM and the back-off timer. In an example, the notification message to the UE may comprise the slice ID, a suspend indication, the back-off timer parameter, access information for the access to be suspended wherein the access information may comprise the access type, RAT, and/or the like.

In an example embodiment, the UPF may determine to send a UPF assistance data information. In an example, the UPF assistance data information may be determined based on the congestion level information. In an example, a PMFP assistance data (AD) provisioning procedure may be employed. The PMFP AD procedure may comprise the following. The PMFP AD PROVISIONING message may sent by the UPF to provide assistance data to the UE.

The PMFP AD PROVISIONING message content may be depicted in the following table.

| IEI | Information Element | Presence | Format | Length |
|---|---|---|---|---|
| | PMFP AD provisioning message | M | V | 1 |
| | identity | | | |
| | EPTI | M | V | 2 |
| | distribution information | M | V | 1 |

In an example, the purpose of the distribution information IE is to provide a traffic distribution that can be applied by the UE for all traffic that applies to the UPF assistance operation. The distribution information may be a type 3 information element with length of 2 octets. The distribution information information element may be coded as shown in following tables. In the following tables, AT means access type wherein the access type may be 3GPP, Non-3GPP, underlay access, and/or the like. RAT may be radio access technology such as NR, LTE, E-UTRA, satellite, and/or the like. In an example as depicted in FIG. 31, access network 1 (AN 1) may be associated with AT 1 and RAT 1, and AN 2 may be associated with AT 2 and RAT 2.

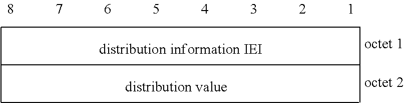

### Distribution Information Information Element

distribution value (octet 2)

| Bits | | | | | | | | | |
|---|---|---|---|---|---|---|---|---|---|
| 8 | 7 | 6 | 5 | 4 | 3 | 2 | 1 | | |
| 0 | 0 | 0 | 0 | 0 | 0 | 0 | 1 | 100% over AT 1 & RAT 1 and 0% over AT2 & RAT 2 | |
| 0 | 0 | 0 | 0 | 0 | 0 | 1 | 0 | 90% over AT 1 & RAT 1 and 10% over AT2 & RAT 2 | |
| 0 | 0 | 0 | 0 | 0 | 0 | 1 | 1 | 80% over AT 1 & RAT 1 and 20% over AT2 & RAT 2 | |
| 0 | 0 | 0 | 0 | 0 | 1 | 0 | 0 | 70% over AT 1 & RAT 1 and 30% over AT2 & RAT 2 | distribution |
| 0 | 0 | 0 | 0 | 0 | 1 | 0 | 1 | 60% over AT 1 & RAT 1 and 40% over AT2 & RAT 2 | information |
| 0 | 0 | 0 | 0 | 0 | 1 | 1 | 0 | 50% over AT 1 & RAT 1 and 50% over AT2 & RAT 2 | information |
| 0 | 0 | 0 | 0 | 0 | 1 | 1 | 1 | 40% over AT 1 & RAT 1 and 60% over AT2 & RAT 2 | element |
| 0 | 0 | 0 | 0 | 1 | 0 | 0 | 0 | 30% over AT 1 & RAT 1 and 70% over AT2 & RAT 2 | |
| 0 | 0 | 0 | 0 | 1 | 0 | 0 | 1 | 20% over AT 1 & RAT 1 and 80% over AT2 & RAT 2 | |
| 0 | 0 | 0 | 0 | 1 | 0 | 1 | 0 | 10% over AT 1 & RAT 1 and 90% over AT2 & RAT 2 | |
| 0 | 0 | 0 | 0 | 1 | 0 | 1 | 1 | 0% over AT 1 & RAT 1 and 100% over AT2 & RAT 2 | |

All other values are spare.

In an example embodiment, the vent may comprise RAN congestion, user plane congestion, congestion of N3 tunnel, congestion of N3 interface, congestion of Uu interface, congestion level information, network slice ID of congested user plane resources, DNN ID of congested user plane resources, and/or the like.

////// C2E

In an example embodiment, a user plane function (UPF) node may receive from a network node, a first message to configure reporting of congestion associated with a network slice. In an example, the first message may comprise an identifier of the network slice. In an example, the UPF may determine that user plane resources associated with the network slice are congested. In an example, the UPF may send to a target node, information of congestion associated with the network slice.

In an example embodiment, a user plane function (UPF) node may receive from a network exposure function (NEF), a first message to configure reporting of user plane congestion associated with a network slice. The first message may comprise an identifier of the network slice, a triggering condition, an identifier of a target node, and/or the like. The UPF may determine and based on the triggering condition being met, that user plane resources of the network slice are congested. The UPF may send to the target node, information of user plane congestion associated with the network slice.

In an example, the triggering condition (parameter) may comprise an event, a threshold parameter for reporting the user plane resource congestion, and/or the like. In an example, the event may comprise: congestion of a radio link between a wireless device and the base station, congestion of a link (tunnel) between the UPF and a base station, access via the base station being unavailable, and/or the like. In an example, the threshold may be associated with a level of congestion based on the congestion level information. In an example, the congestion level information may comprise a range of integer values indicating a level of congestion. In an example, the UPF may send to a wireless device, a request to suspend a redundancy steering mode (RSM) for a MA-PDU session. The UPF may send to a wireless device, a UPF assistance data comprising a set of rules indicating: a first portion of traffic to be transmitted via a first access of a MA-PDU session via a first radio access technology (RAT); and a second portion of traffic to be transmitted via a second access of the MA-PDU session via a second RAT. In an example, the first message may be employed to configure the UPF to report load information associated with allocated resources of a network slice. The load information may comprise at least one of: number of wireless devices, number of PDU sessions, and/or the like. In an example, the network node may comprise at least one of: an application function; an application server; a SMF, and/or the like. In an example, the UPF may receive a node level configuration message from a control plane function (CPF) node. The CPF node may be at least one of: the SMF; the NEF; the AF; the PCF, and/or the like. In an example, the node level configuration message may be a PFCP association update/setup message. The first message may comprise access information of a MA-PDU session. In an example, the UPF may receive from a RAN node, a notification message comprising: the congestion level information; the slice ID associated with the congested user plane resources, the DNN associated with the congested user plane resources; the RAN ID associated with a congested RAN node, and/or the like.

In an example embodiment, a user plane function (UPF) node may receive from a session management function (SMF) node, a first message to configure reporting of user plane resource congestion of a network slice. In an example, the first message may comprise: an identifier of the network slice; a triggering condition parameter; an identifier of an application, and/or the like. In an example, the UPF may determine, based on the triggering condition parameter, that user plane resources of the network slice is congested. In an example, the UPF may send to a network node (e.g., the NEF, SMF, PCF, or the application function), a notification of congestion.

In an example, the first message may be an N4 association update/modification message.

In an example embodiment, a network exposure function (NEF) node may receive from an application function, an event notification request for user plane congestion associated with resources of a network slice. In an example, the NEF may send to a policy and charging control function (PCF), an event exposure request message (Npcf_EventExposure_Subscribe) to receive notification of user plane congestion associated with a network slice. In an example, the event exposure request message may comprise a triggering condition parameter. In an example, the NEF may receive from a user plane function (UPF), a notification. The notification may comprise congestion level information, an identifier of the network slice associated with congested user plane resources, and/or the like.

1. A method comprising:
receiving, by a first network node from a second network node, a first message comprising a configuration parameter for reporting of user plane congestion associated with a network slice to a target node, wherein the configuration parameter comprises an identifier of the network slice; and
sending, by the first network node to a user plane function (UPF) a second message comprising the configuration parameter.

2. The method of claim 1, wherein the first network node comprises at least one of:
a session management function (SMF); or
a network exposure function (NEF).

3. The method of claim 1, wherein the configuration parameter comprises:
a triggering condition for the reporting; and
an identifier of the target node.

4. The method of claim 3, wherein the triggering condition comprises:
an event; and
a threshold parameter for reporting the user plane resource congestion.

5. The method of claim 4, wherein the event comprises at least one of:
congestion of a radio link between a wireless device and a base station;
congestion of a link between the UPF and the base station; or
access via the base station being unavailable.

6. The method of claim 4, wherein the threshold parameter is associated with a level of congestion.

7. The method of claim 6, wherein the level of congestion comprises a range of integer values.

8. A first network node comprising one or more processors and memory storing instructions that, when executed by the one or more processors, cause the first network node to:
receive, from a second network node, a first message comprising a configuration parameter for reporting of user plane congestion associated with a network slice to a target node, wherein the configuration parameter comprises an identifier of the network slice; and
send, to a user plane function (UPF) a second message comprising the configuration parameter.

9. The first network node of claim 8, wherein the first network node comprises at least one of:
a session management function (SMF); or
a network exposure function (NEF).

10. The first network node of claim 8, wherein the configuration parameter comprises:
a triggering condition for the reporting; and
an identifier of the target node.

11. The first network node of claim 10, wherein the triggering condition comprises:
an event; and
a threshold parameter for reporting the user plane resource congestion.

12. The first network node of claim 11, wherein the event comprises at least one of:
congestion of a radio link between a wireless device and a base station;
congestion of a link between the UPF and the base station; or
access via the base station being unavailable.

13. The first network node of claim 11, wherein the threshold parameter is associated with a level of congestion.

14. The first network node of claim 13, wherein the level of congestion comprises a range of integer values.

15. A non-transitory computer-readable medium comprising instructions that, when executed by one or more processors of a first network node, cause the first network node to:
receive, from a second network node, a first message comprising a configuration parameter for reporting of user plane congestion associated with a network slice to a target node, wherein the configuration parameter comprises an identifier of the network slice; and
send, to a user plane function (UPF) a second message comprising the configuration parameter.

16. The non-transitory computer-readable medium of claim 15, wherein the first network node comprises at least one of:
a session management function (SMF); or
a network exposure function (NEF).

17. The non-transitory computer-readable medium of claim 15, wherein the configuration parameter comprises:
a triggering condition for the reporting; and
an identifier of the target node.

18. The non-transitory computer-readable medium of claim 17, wherein the triggering condition comprises:
an event; and
a threshold parameter for reporting the user plane resource congestion.

19. The non-transitory computer-readable medium of claim 18, wherein the event comprises at least one of:
congestion of a radio link between a wireless device and a base station;
congestion of a link between the UPF and the base station; or
access via the base station being unavailable.

20. The non-transitory computer-readable medium of claim 18, wherein the threshold parameter is associated with a level of congestion.
